(19) United States
(12) Patent Application Publication
(10) Pub. No.: US 2013/0124980 A1
(43) Pub. Date: May 16, 2013

(54) FRAMEWORK FOR CREATING INTERACTIVE DIGITAL CONTENT

(71) Applicant: Future IP Limited, Bath (GB)

(72) Inventors: Paul Hudson, Bath (GB); Christopher Hedley, Bath (GB); Scott Ewart, Bath (GB); Stefan Kruger, Bristol (GB); Karl Jaques, Bath (GB); Elizabeth Wilson, Bath (GB); Matthew Hunkin, Bath (GB); Graham Dalzell, Bath (GB); Christopher Phin, Bath (GB)

(73) Assignee: Future IP Limited, Bath (GB)

(21) Appl. No.: 13/665,602

(22) Filed: Oct. 31, 2012

Related U.S. Application Data
(60) Provisional application No. 61/560,771, filed on Nov. 16, 2011.
(60) Provisional application No. 61/665,235, filed on Jun. 27, 2012.

(51) Int. Cl. G06F 17/00; G06F 3/048

(52) U.S. Cl. 715/243; 715/779

(57) ABSTRACT

A digital content creation platform can include a variety of features for creating an interactive digital publication. The functionality can include adding one or more sections, one or more pages to a section, and one or more layers to a page, such as box, story, image, video, table, map, and annotation layer types. Additionally, the digital content creation platform can include functionality to add multimedia content to a layer, link layers, and/or add some other action, such as an interactivity feature or behavior. The digital content creation platform can also include functionality to generate a template from the current layout or convert the current layout to a different template layout. At any point during the design, the digital content creation platform can be used to preview or run the digital publication. Finally, after adding content, the digital content creation platform can compile the digital publication for distribution.

### CROSS REFERENCE TO RELATED APPLICATION

This application claims the benefit of U.S. Provisional Patent Application No. 61/560,771, entitled “SYSTEMS AND METHODS FOR INTERACTIVE MEDIA DEVELOPMENT”, filed Nov. 16, 2011, and U.S. Provisional Patent Application No. 61/665,235, entitled “FRAMEWORK FOR CREATING INTERACTIVE DIGITAL CONTENT”, filed Jun. 27, 2012, which are hereby expressly incorporated herein by reference in their entirety.

### BACKGROUND

1. Technical Field

The present disclosure relates to a digital content authoring tool and more specifically to a digital content authoring tool configured to produce interactive digital content.

2. Introduction

Digital publications, such as articles, newspapers, magazines, and books, have been widely available for many years. However, until the recent explosion of tablet computing devices, digital publications had been rather simplistic. For example, many digital publications were simply electronic versions of their print counterparts. That is, the digital version was a mostly flat publication that permitted little or no end user interaction with the digital content. The end user could scroll through the content and maybe click on a link, but otherwise the end user could not interact with the content.

Both content creators and end users have begun to see the potential advantages of digital publications, and thus the level of complexity of these publications has increased. For example, ebook readers make it possible to change font size, highlight, annotate, and even look up definitions of words without leaving the page. Additionally, many content creators now include links to additional content, embedded videos, animations, picture slideshows, and the ability to zoom in on various pictures. The highly interactive nature of tablets and other touch screen computing devices has made it possible for content creators and end users alike to envision highly innovative digital publications. The envisioned digital publications are more akin to an application that is executed on a computing device than an electronic version of a print publication.

Unfortunately, many content creators lack the skill to make their visions a reality. Furthermore, those content creators with the proper skills still face many barriers, such as time, cost, and inadequate tools. For example, design tools exist for the creation of flat digital publications and some of those tools have been retrofitted to include features for designing interactive digital publications. However, the design of interactive digital publications was an afterthought; therefore the tools can be difficult to use and in many cases cannot produce content with the level of interaction desired. Additionally, many of these tools have high entry barriers in that they are time-consuming to use, expensive, and require extensive training in order to use. This can make it difficult for individuals or small entities to enter the interactive digital publication space, which is counter to what is occurring with the development of applications for tablets and smartphones.

Another challenge in the creation of interactive digital content is that the interactive digital publications are designed on one computing device, such as a desktop computer, but viewed on a completely different kind of computing device, such as a tablet computer. The disconnect between design and execution environments leads to the need for additional testing. For example, the fact that the interactive digital publication performs properly while it is being designed does not mean that it will execute properly on the actual device for which it was designed. Furthermore, the testing process can be cumbersome because it requires transferring the interactive digital publication from one computing device to another. This process can be even more burdensome if the interactive digital publication must first be uploaded to a third-party server before it can be installed on the target device. In some cases, the process of uploading to a third-party server and downloading to the target device can take several hours. This is highly problematic when the design of the interactive digital publication requires iterative modifications.

A reason for creating the interactive digital content on a different computing device type than the type used to view the content can be directly linked to the design tools. That is, the design tools for creating interactive digital publications are retrofitted tools that were originally developed for use on desktop computing devices. In some cases, limiting the availability of design tools to certain computing platforms is the result of the evolution of the design tools. In particular, platform availability is often dictated by ease of development and cost, as well as custom within the content development field.

A larger barrier to creating design tools for use on mobile devices, such as tablets, and another reason for the disconnect between the computing device types used for development and viewing, is that mobile devices are generally designed for consuming content, not for developing and producing content. In particular, mobile devices generally lack the features that expose the full file system to user applications. This can limit an end user's ability to directly access, manage, and manipulate files and file storage. For example, a content developer is unable to easily browse the file system to identify content to include in a digital publication.

Accordingly, the existing solutions are not adequate to eliminate the barriers between content creators and the presentation of highly interactive digital publications.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology provides a framework for creating interactive digital content, and in particular highly interactive digital publications. A digital publication can be any electronic multimedia content. Examples of interactive digital publications can include books, magazines, articles, newspapers, newsletters, presentations, marketing or sales tools, order forms, product catalogs, training programs, instructional materials, portfolios, scrapbooks, and/or photo albums. Development of a digital publication can occur in a digital content creation platform residing on a development device. An advantage of the presently disclosed digital content creation platform is that the digital content creation platform can be used on the same type of device for which the digital publication is being created. For example, if the digital publication is to be run on a particular type of tablet computing device, the digital publication can be created using the digital content creation platform on that type of tablet computing device.

The digital content creation platform can include a variety of features that a content creator can use to create an interactive digital publication. The digital content creation platform can include functionality to add one or more sections, one or more pages to a section, and one or more layers to a page, such as box, story, image, video, table, map, and annotation layer types. Each layer can include multimedia content. In some embodiments, the digital content creation platform can analyze a layer and perform a predetermined action based on the analysis. The predetermined action can include adding multimedia content to a layer, linking layers, and/or adding some other action, such as an interactivity feature or behavior.

In some embodiments, the analyzing can occur in response to a selection of a digital asset to import into a first layer. In this case, the analyzing can determine that an attribute associated with the digital asset selected for import and other unselected assets conform to a naming scheme. In response to detecting the other unselected assets, the digital content creation platform can import at least one of the other unselected assets into the first layer. Additionally, in some cases, the digital content creation platform can assign a common behavior to the first layer that can define a mechanism for displaying the selected asset and the imported at least one other unselected asset. For example, a content creator can select an image to import into a slideshow layer. Then the digital content creator platform can identify other similarly named images to import into the slideshow.

One way to create the interactivity of a digital publication is through the linking of the various digital publication elements. Digital publication element linking can enable an end user to jump from one location in a digital publication to another, without having to flip through intermediate content. In some embodiments, the digital content creation platform can perform linking in response to determining that a first layer and a second layer share a common naming scheme.

In some embodiments, a first layer can include multiple assets. The digital content creation platform can link the multiple assets to multiple layers in response to determining that the multiple assets in the first layer share a common naming scheme with the multiple layers. For example, the result of the linking can be expressed as an end user scrolls through a slideshow of images, different text can be displayed corresponding to the currently displayed image.

In some embodiments, a first layer can include multiple attributes. The digital content creation platform can link layers in response to determining that a first attribute in the first layer and a second attribute in a second layer share a common naming scheme. For example, the result of the linking can be expressed as an end user scrolls through a story, different images can be displayed.

In some embodiments, the digital content creation platform can associate an information box with an attribute of a first layer. The association can cause a display of the information box in response to an activation of the attribute in the first layer. Additionally, the digital content creation platform can associate a behavior, such as a zoom, with the attribute of the first layer. The association can cause the application of the behavior to the first layer in response to an activation of the attribute in the first layer.

In some embodiments, the digital content creation platform can stack separate digital pages in response to determining that a stacking action has occurred. The stacking of a first page and a second page can cause the display of the first and second digital pages to appear as a single continuous digital page.

The digital content creation platform can also enable the content creator to generate a template from the current layout of the digital publication for later use or convert the digital publication from the current layout to a different, previously saved template layout. In some embodiments, the digital content creation platform can convert a first rendition of a first digital page to a second rendition of the first digital page. The converting can include arranging multiple digital assets from the first rendition of the first digital page on the second rendition of the second digital page based on one or more templates associated with the second rendition of the first digital page.

In some embodiments, the digital content creation platform can create a template from a first rendition of a first digital page. Creating the template can include generating an abstraction of the first rendition of the first digital page. The abstraction can include the properties of the first rendition of the first digital page.

In some embodiments, as part of the template-based conversion process, the digital content creation platform can replace the first rendition of the first digital page with the second rendition of the second. However, in some embodiments, the digital content creation platform can add the second rendition of the first page to the digital publication as an additional rendition of the first digital page.

At any point during the design, the content creator can use the digital content creation platform to preview or run the digital publication. This can enable the content creator to experience the behavior of the digital publication as it would exhibit on a client device.

After adding content, the content creator can use the digital content creation platform to compile the digital publication for distribution. As part of the compilation process, the digital content creation platform can generate a digital publication package. A digital publication package can include an instruction file and one or more digital assets for the interactive digital publication. The instruction file can specify one or more functions to enable the display of one or more actions. The one or more functions can correspond to one or more interactive features in the interactive digital publication. In some embodiments, the instruction file can include a set of instructions specifying a transformation to a digital asset. In some cases, the transformation can be used to modify the digital asset for display on a particular mobile device type.

In some embodiments, as part of the compilation process, the digital content creation platform can produce scaled copies of the original digital assets that were used in designing the digital publication. The digital content creation platform can produce scaled copies from the original digital assets based on a specified quality setting during the compilation process. The scaled copies can be included in the digital publication package.

In some embodiments, the digital content creation platform can generate a digital publication package that can be displayed on multiple different types of mobile devices, such as a phone and a tablet.

The present invention provides a system for creating an interactive digital publication in a mobile device framework. The system will typically comprise a computer processor, typically loaded with software to perform the function of one or more modules of the system.

The system may comprise an element creation module. The element creation module may be configured to control the processor to create one or more layers on a first rendition of a first digital page in the interactive digital publication. A layer may be configured to import and present a digital asset on the digital page. The element creation module may be configured to import and present a digital asset on the digital page.

The system may comprise an interactivity adder module. The interactivity adder module may be configured to control the processor to associate an action with the layer. The action may comprise an interactivity. The action may comprise a behavior.

The system may comprise a layout management module configured to control the processor to analyze a first layer created by the element creation module and to perform a predetermined action based on the analysis.

The system is preferably configured or configurable to create an interactive digital publication that is adapted for display on a particular type of mobile device. In such a case, the system is preferably either provided as a part of a mobile device of that same particular type or is configured or configurable to emulate, or simulate the behavior of, such a mobile device.

The system may comprise a preview module that is configured to display the interactive digital publication in a preview mode. The preview module is preferably configured to allow a user to execute interactive content of the interactive digital publication. The interactivity provided by the interactive digital publication, when viewed on a client device, may be facilitated by means of the calling of (for example by the interactive digital publication, or a part thereof) one or more API (application programming interface) functions in the client device's operating system. The preview module of the system may be configured to call the same API functions, as would be called within the client device's operating system. The preview module is preferably configured so that the interactive digital publication is displayed/executed within the system, in substantially the same way as the interactive digital publication would be displayed/executed on an actual mobile device of a type for which the interactive digital publication is intended. There may therefore be no need for compilation/testing of the interactive digital publication separate from the system. The system may however comprise a compiler module. Such a compiler module may be arranged to produce a digital publication package, such as for example a software application for execution on a mobile device. The system may be configured to produce a digital publication package, for example, at least data from which the interactive digital publication may be reproduced. The preview module may be able to allow a preview of the interactive digital publication without requiring any compilation by the compiler module.

Whilst the system may be provided by means of multiple computing devices, it is preferred that the system is installed on a single computing device, preferably a tablet computer. The system may comprise a template module. The template module may be configured to control the processor to create a template from the first rendition of the first digital page, wherein creating a template comprises generating an abstraction of the first rendition of the first digital page, the abstraction including properties of the first rendition of the first digital page. The template module may be configured to control the processor to convert the first rendition of the first digital page, for example suitable for a first type of mobile device, to a second rendition of the first digital page, for example suitable for a second type (different from the first type) of mobile device. One or more templates may be provided to facilitate conversion of a rendition of a page for a first type of mobile device into a rendition of such a page for a second, different, type of mobile device.

The present invention also provides a method for presenting a graphical user interface for navigating an interactive digital publication having a plurality of content sections on a mobile device. The method may comprise a step of displaying the interactive digital publication in a graphical user interface on the mobile device. The step of displaying may comprise a step of presenting a control panel having a plurality of content section buttons. Each of the plurality of content section buttons may be linked to a different content section in the plurality of content sections in the interactive digital publication. Each content section button may be associated with a different color corresponding to a color associated with the linked content section. A content section button may be presented in the associated color when the linked content section is currently displayed. The step of displaying may comprise a step of presenting a control panel retrieval icon. The control panel retrieval icon may be effective to receive a user input. The control panel retrieval icon may be configured to cause the mobile device to reveal a hidden control panel. The control panel retrieval icon may be presented in a color associated with a content section of the interactive digital publication currently displayed.

The present invention also provides a method of creating an interactive digital publication. The method may comprise a step of a computer processor creating, for example within a mobile device framework, one or more layers on a first rendition of a first digital page of an interactive digital publication. The method may comprise a step of importing and presenting a digital asset on the digital page. A layer may be configured to import and present such a digital asset on the digital page. The method may comprise a step of causing a computer processor to associate an action with the layer. The action may be at least one of an interactivity and a behavior. The method may comprise a step of causing a computer processor to analyze a first layer, for example one previously created by a step of the method, and to perform a predetermined action based on the analysis.

The present invention also provides a mobile device arranged to display a interactive digital publication created by means of any aspect of the present invention. The mobile device may comprise a display module. The display module may be configured to display any of a plurality of different interactive digital publications. The display module may share one or more software components with the preview module as described herein. The display module is preferably configured to allow a user to execute interactive content of the interactive digital publication. The interactivity provided by the interactive digital publication on the mobile device may be facilitated by means of the calling of one or more API functions in the mobile device's operating system.

The mobile device, for example the display module of the device, may be arranged to display a graphical user interface for navigating the interactive digital publication on the mobile device. The interactive digital publication may for example have a plurality of content sections which may be navigated between. The display module may comprise a control panel module. The control panel module may be configured to present a control panel having a plurality of content section buttons, each of the plurality of content section buttons for example being linked to a different content section in the plurality of content sections in the interactive digital publication, each content section button associated with a different color corresponding to a color associated with the linked content section, a content section button for example being presented in the associated color when the linked content section is currently displayed. The control panel module may be configured to present a control panel retrieval icon, the control panel retrieval icon for example being effective to receive a user input, and to cause the mobile device to reveal a hidden control panel, the control panel retrieval icon for example being presented in a color associated with a content section of the interactive digital publication currently displayed.

The present invention also provides one or more computer software products, for example a computer program product, arranged, when executed on a computing device, to form a system according to any aspect of the invention as described or claimed herein or to perform the steps of any of the aspects of the method of the invention as described or claimed herein. For example, the computer software product may be configured to be able to be installed within a mobile device framework to form a system for creating an interactive digital publication, the system being in accordance with any aspect of the invention as described or claimed herein. Such a computer software product may be provided on computer readable media. Such a computer software product may be stored on a computer system, such as a server. The computer software product may include an element creation module, for example as described or claimed herein. The computer software product may include an interactivity adder module, for example as described or claimed herein. The computer software product may include a layout management module, for example as described or claimed herein. The invention may provide a computer software product for loading onto a mobile device, wherein the software product is configured to provide an interactive digital publication according to, or created in accordance with, the invention. The computer software product may include a graphical user interface module, for example as described or claimed herein.

The present invention also provides a mobile device loaded with the computer software product according to any aspect of the invention as described or claimed herein.

There is also provided an interactive digital publication, as the product of the system or method of any aspect of the invention as described or claimed herein. Such an interactive digital publication product may be delivered in the form of executable computer software product.

The present invention also provides a mobile device configured to display an interactive digital publication created by the system or method of any aspect of the invention as described or claimed herein.

The present invention also provides a mobile device configured to present a graphical user interface for navigating an interactive digital publication in accordance with any aspect of the invention as described or claimed herein.

It will of course be appreciated that features described in relation to one aspect of the present invention may be incorporated into other aspects of the present invention. For example, a software product according to the present invention may be configured to perform the steps of a method according to the present invention. Also, for example, the method of the invention may include performing steps that are equivalent to the function provided by parts of the system of the invention described or claimed herein; and/or the system of the invention may be configured to perform one or more steps of the method of the invention described or claimed herein. Also, any of the features set out in any one of the claims may be combined with the system of the invention described herein, whether or not separately also claimed herein (therefore resulting in, for example. a system or embodiment not necessarily including all of the features required by such a claim). For example, it is within the scope of the present invention to provide a system for creating an interactive digital publication comprising a template module (configured to control a processor to create a template from a first rendition of a first digital page, wherein creating a template comprises generating an abstraction of the first rendition of the first digital page, the abstraction including properties of the first rendition of the first digital page), but not necessarily having a layout management module for analyzing a layer and performing a predetermined action based on such analysis.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings, by way of example only. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary digital publication running on a client device;

FIG. 2 illustrates an exemplary display of content information;

FIG. 3 illustrates an exemplary result of tapping on an icon to display content information;

FIG. 4 illustrates an exemplary page swipe in a digital publication;

FIG. 5 illustrates a first exemplary revealing of additional content;

FIG. 6 illustrates a second exemplary revealing of additional content;

FIG. 7 illustrates an exemplary ecosystem configuration;

FIG. 8 illustrates an exemplary overview of a subset of functionality provided by a digital content creation platform;

FIG. 9 illustrates an exemplary digital content creation platform;

FIG. 10 illustrates an exemplary digital content creation platform user interface with user interface elements for switching between modes;

FIG. 11 illustrates an exemplary design mode user interface;

FIG. 12 illustrates an exemplary preview mode user interface;

FIG. 13 illustrates an exemplary collection of sections, pages, and layers in a digital publication;

FIG. 14 illustrates an exemplary UI for adding a section to a digital publication;

FIG. 15 illustrates an exemplary digital content creation platform user interface that includes a single section with two pages;

FIG. 16 illustrates an exemplary digital content creation platform UI for adding layers to a page;

FIG. 17 illustrates an exemplary digital content creation platform user interface in which a new layer has been created;

FIG. 18 illustrates an exemplary properties window in which a content creator can enter values for a custom size property;

FIG. 19 illustrates an exemplary digital content creation platform UI depicting a page stack feature;

FIG. 20 illustrates an exemplary digital content creation platform UI for editing a layer element;

FIG. 21 illustrates an exemplary digital content creation platform UI for enabling grid mode;

FIG. 22 illustrates an exemplary digital content creation platform UI with grid mode enabled;

FIG. 23 illustrates an exemplary digital content creation platform UI with a background configuration window that includes a file selector;

FIG. 24 illustrates an exemplary digital content creation platform UI with a zoom feature;

FIG. 25 illustrates an exemplary digital content creation platform UI for adding layers to a page rendition;

FIG. 26 illustrates an exemplary digital content creation platform UI that is focused in on user interface elements specific to layer editing;

FIG. 27 illustrates an exemplary user interface for assigning a color to a layer information;

FIG. 28 illustrates an exemplary image layer configuration panel;

FIG. 29 illustrates an exemplary image layer file selector window;

FIG. 30 illustrates an exemplary dialog box displayed in response to detecting a sequence of image files;

FIG. 31 illustrates an exemplary user interface window for editing the sequence of files included in an image layer;

FIG. 32 illustrates an exemplary image layer configuration panel with settings specific to an animation behavior;

FIG. 33 illustrates an exemplary image layer configuration panel with settings specific to a 360 behavior;

FIG. 34 illustrates an exemplary page rendition depicting the scratch feature;

FIG. 35 illustrates an exemplary image layer configuration panel with setting specific to a scratch behavior;

FIG. 36 illustrates the scratch feature with feather edges turned on and off;

FIG. 37 illustrates an exemplary page rendition depicting a wipe feature;

FIG. 38 illustrates an exemplary image layer configuration panel with settings specific to a wipe behavior;

FIG. 39 illustrates an exemplary text layer configuration panel with a simple text editor;

FIG. 40 illustrates an exemplary text layer configuration panel with an advanced text editor;

FIG. 41 illustrates an exemplary video layer configuration panel;

FIG. 42 illustrates an exemplary table layer configuration panel;

FIG. 43 illustrates an exemplary header properties configuration panel;

FIG. 44 illustrates an exemplary color picker;

FIG. 45 illustrates an exemplary column properties configuration panel;

FIG. 46 illustrates an exemplary row properties configuration panel;

FIG. 47 illustrates an exemplary page rendition with an active table;

FIG. 48 illustrates an exemplary map layer configuration panel;

FIG. 49 illustrates an exemplary map layer configuration panel in which a content creator has added a route;

FIG. 50 illustrates an exemplary annotation layer configuration panel;

FIG. 51 illustrates an exemplary annotation layer configuration panel in which the content creator has set the background image and added a pin;

FIG. 52 illustrates an exemplary box layer configuration panel;

FIG. 53 illustrates an exemplary technique for linking text and images;

FIG. 54 illustrates an exemplary layer naming;

FIG. 55 illustrates an exemplary linking of story layers to slideshow images through layer naming;

FIG. 56 illustrates an exemplary behavior tab in an image layer configuration panel;

FIG. 57 illustrates an exemplary user interface for creating a page from a template;

FIG. 58 illustrates an exemplary digital content creation platform UI for creating a template from a page;

FIG. 59 illustrates an exemplary digital content creation platform UI with a window listing the templates from which a content creator can select;

FIG. 60 illustrates an exemplary UI in which a compilation mode has been activated and a settings window is displayed; and

FIG. 61 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for technology that eliminates the barriers between content creators and the presentation of highly interactive digital content, such as digital publications. In some embodiments, the present technology relates to a computer-implemented application for aiding in the creation of interactive digital content. The exemplary digital content authoring tool is described with a focus on digital publications. It should be understood to one skilled in the art that such a restriction is not necessary. The digital content authoring tool can be used to create a variety of interactive digital content, such as digital content that includes a combination of text, images (photos and/or illustrations), images with added effects or overlays, slideshows, tables, audio, video, links, and/or computer executable code.

### 1. Interactive Digital Publication

A digital publication can be any electronic multimedia content. Examples of interactive digital publications can include books, magazines, articles, newspapers, newsletters, presentations, marketing or sales tools, order forms, product catalogs, training programs, instructional materials, portfolios, scrapbooks, and/or photo albums. While the presently disclosed technology can be used to create any digital publication, it is particularly useful for creating highly interactive digital publications that make use of the unique computing and end user interface features of tablet and other touch-based computing devices. For example, a digital publication can include features that create interactivity through multi-touch gestures, such as standardized motions used to interact with multi-touch devices. Examples of multi-touch gestures can include tap, double tap, long press, scroll, pan, flick, multi-finger tap, multi-finger scroll, pinch, spread, rotate, swipe, and/or multi-finger swipe, etc. A digital publication can be created for commercial and/or personal use. Furthermore, a professional, such as a designer, or an amateur can create a digital publication.

A digital publication can include a variety of multimedia content or digital assets. For example, a single digital publication can include text, images, slideshows, tables, audio, video, links, and/or computer executable code. In some cases, a digital publication can be a computer executable program that is displayed to an end user in a format that has the appearance of a publication, such as a magazine, but whose presentation is controlled by computer executable instructions. For example, a digital publication can include one or more digital assets and instructions which when executed by the computing device instruct the computing device on how to display the assets to the end user. In some cases, the instructions rely on functionality of the operating system running on the client devices, such as API functions. Furthermore, a digital publication can include instructions that are interpreted by a virtual machine or interpreter. The virtual machine or interpreter can translate the instructions into instructions understood by the client device. For example, a client device can include a digital publication reader application. The digital publication can run inside of the digital publication reader application, which translates the digital publication instructions into instructions for the client device so that the content can be rendered on the client device.

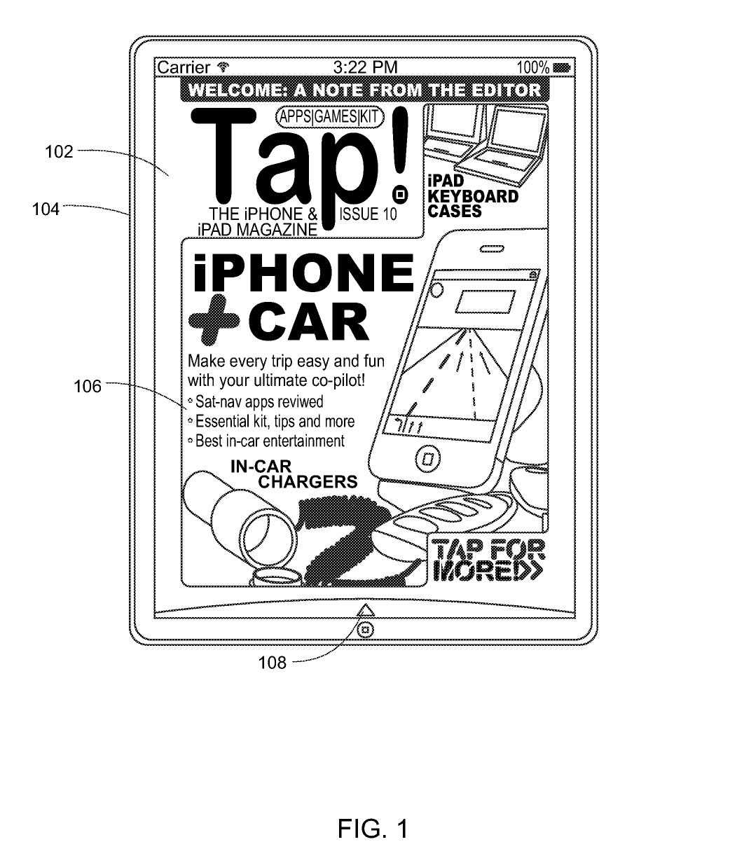

FIG. 1 illustrates an exemplary cover 102 of an interactive digital publication running on a tablet computing device 104. An end user can interact with the digital publication in a variety of ways to access additional content. For example, an end user can tap on a story description, such as description 106, to be taken directly to the story. The story description can occur at any place in the digital publication, such as the title page, a contents page, within another story, attached to an image or video, etc. Furthermore, this feature can be used to create internal cross-reference functionality. Additionally, other techniques to create a cross reference are also possible.

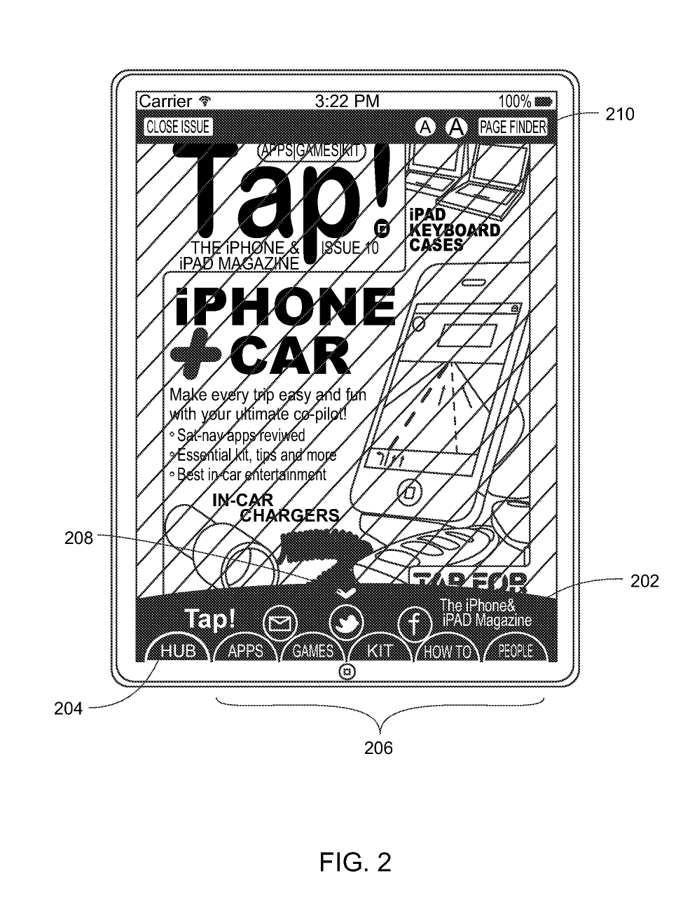

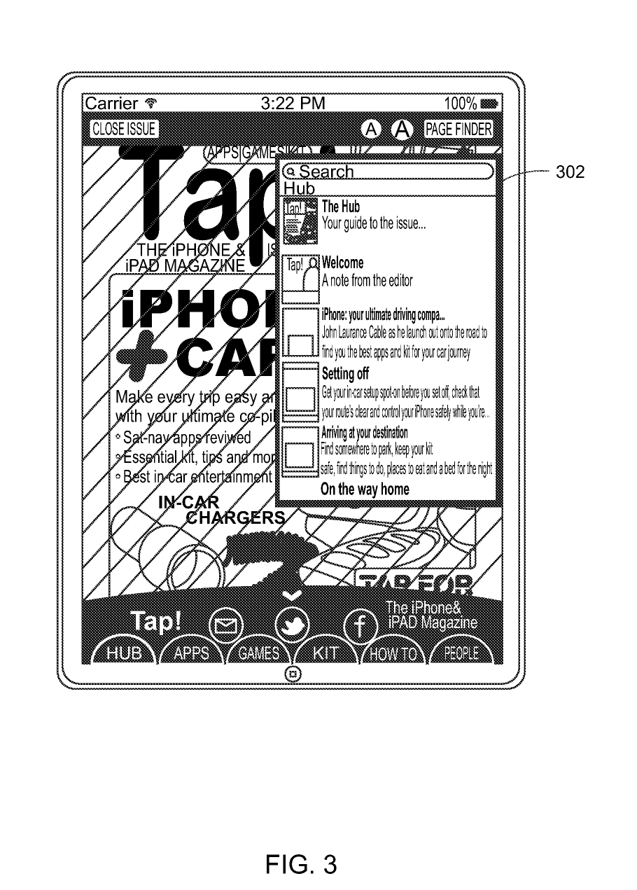

In another example, an end user can interact with the digital publication by accessing a contents feature, such as by tapping on icon 108. This action can reveal content information for the digital publication, such as by revealing a control panel. The control panel can display a full table of contents, content sections, or any other division of the content in the digital publication. FIG. 2 illustrates an exemplary display of content information 202 in which an end user can tap on an icon to be taken directly to a particular section of the digital publication. In some cases, the different sections in a digital publication can be color-coded. That is, each content section can be associated with a different color. When the content sections are color-coded, any content section icons in the control panel can also be color-coded. For example, the content section icon corresponding to the currently displayed section can be displayed in the color associated with that content section, such as icon 204, while the other content section icons can all be displayed a common color, such as icons 206. Additionally, a control panel retrieval icon, such as icon 208 can be displayed in the color corresponding to the currently displayed section. When an end user selects a section, or navigates to a content section using some other navigation technique, the control panel retrieval icon 208 can change colors to reflect the color associated with the currently displayed section. Additional techniques for displaying content information are also possible. For example, a digital publication can include a page finder feature, which can be revealed when the end user taps on a page finder icon 210. FIG. 3 illustrates a possible result of tapping on the page finder icon. In this example, a scrolling window 302 is revealed that displays the various articles in the digital publication. An end user can tap on an item in the list to be taken directly to the article.

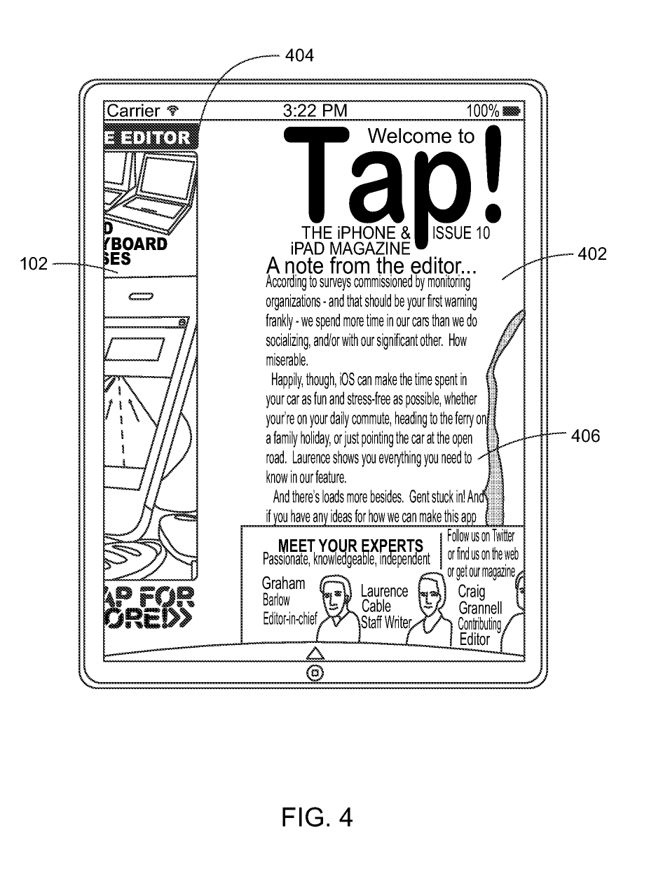

An end user can also interact with the digital publication by swiping and/or scrolling. For example, FIG. 4 illustrates that an end user can swipe left or right to reveal another page. In this example, the end user is in the middle of swiping from the cover 102 to the first page 402, as indicated by the page border 404. Depending on the configuration of the digital publication, an end user can swipe left, right, up, and/or down. Furthermore, an end user can scroll and/or swipe on a portion of a page to reveal additional content. For example, an end user can swipe up and/or down on text box 406 to reveal the remainder of the text. In another example, an end user can swipe to reveal additional images, such as images in a slideshow.

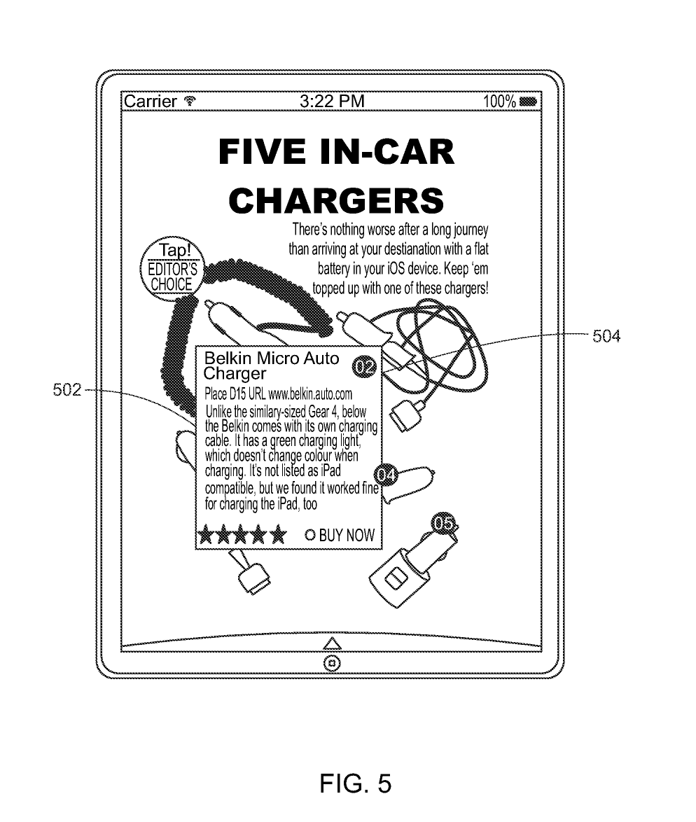

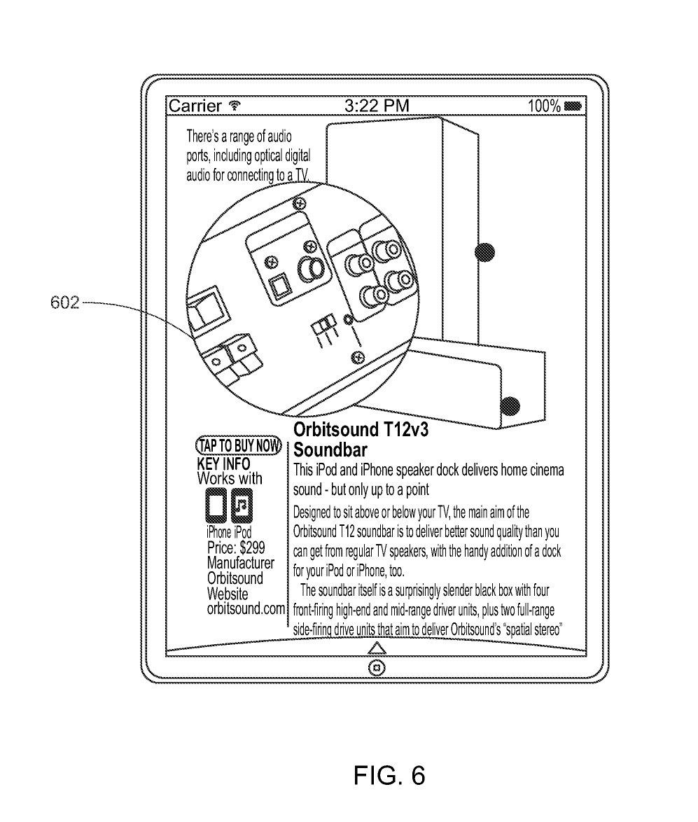

An end user can also tap on content or icons to reveal additional content. For example, FIG. 5 illustrates exemplary content 502 that can be revealed or hidden by tapping on icon 504. In another example, FIG. 6 illustrates exemplary content 602 that can be revealed or hidden by tapping on an icon. The content revealed and/or hidden can be any multimedia content, such as text, images, slideshows, tables, audio, videos, links, and/or computer executable code. Tapping on content can also increase the size of the content. For example, tapping on an image can zoom in on the image. Furthermore, in some cases, tapping on content can direct an end user to content external to the digital publication. For example, tapping on a product image or description could direct the end user to the product's website or some other site where the end user can buy the product. In another example, instead of including a video in the digital publication, a video image can actually be a link to the video. When the end user clicks to play the video, the digital publication can connect to the external source of the video and play the video inside the digital publication.

Additionally, in some cases, a digital publication can include multiple orientations, such as portrait and landscape. A digital publication can be configured so that an orientation can include more or less information than another orientation in the digital publication. In such a case an end user can change the orientation, for example by rotating the client device to reveal or hide information.

As previously mentioned, a digital publication can include text. In some digital publications, text is actually an image of text. For example, the text can be a JPEG image. To improve interactivity, a digital publication can include “live” text. Live text is actual text that can be searched, highlighted, copied, etc., instead of an image of text. The inclusion of live text can differentiate a digital publication created with the disclosed technology from a digital publication created with other digital publishing tools. The use of live text can make it possible to include a variety of additional features. For example, a digital publication with live text can include a search feature so that an end user can search for a keyword or topic. In another example, a digital publication with live text can include a dictionary feature so that an end user can highlight a word and obtain a definition of the word. In yet another example, a digital publication with live text can include a copy feature so that an end user can select a sequence of text and copy it to another application such as an email application, a word processing application, or social media application. Additionally, instead of having to copy and paste the text, the digital publication can include a social media sharing feature so that an end user can select a sequence of text and send it directly to the end user's social media account. In a further example, a digital publication with live text can include accessibility features, such as the ability to change font sizes or have the text read to the end user. In still another example, a digital publication with live text can include a translate feature so that an end user can select a sequence of text or the entire text box and have it translated to another language. Furthermore, using live text instead of an image of the text can decrease the size of the digital publication. This is because in most cases an image of the text is larger than the text itself. The use of live text can also make it easier to include multiple live links to internal and/or external content, such as live URL links, within a single body of text. For example, if the text is an image of text, the text may have to be split into multiple images when multiple links are desired.

In some digital publications, one piece of content can be linked to another. For example, as an end user scrolls through the text of an article, different images can be displayed. The images displayed can pertain to the particular text the end user is currently reading. Alternatively, as the end user flips through a slideshow of images different text can be revealed. Additional techniques for linking and revealing content are also possible. For example, content can be linked via internal and/or external links, such as URL links. In another example, content can be revealed through a timed reveal.

The above description of a digital publication illustrates a sampling of the variety of features that can be included in an interactive digital publication. Additional features are also possible, such as 360-degree images and tables with interactive features. The sections that follow will illustrate and/or explain some of the possible additional features that can be designed using the presently disclosed technology.

### 2. Ecosystem Overview

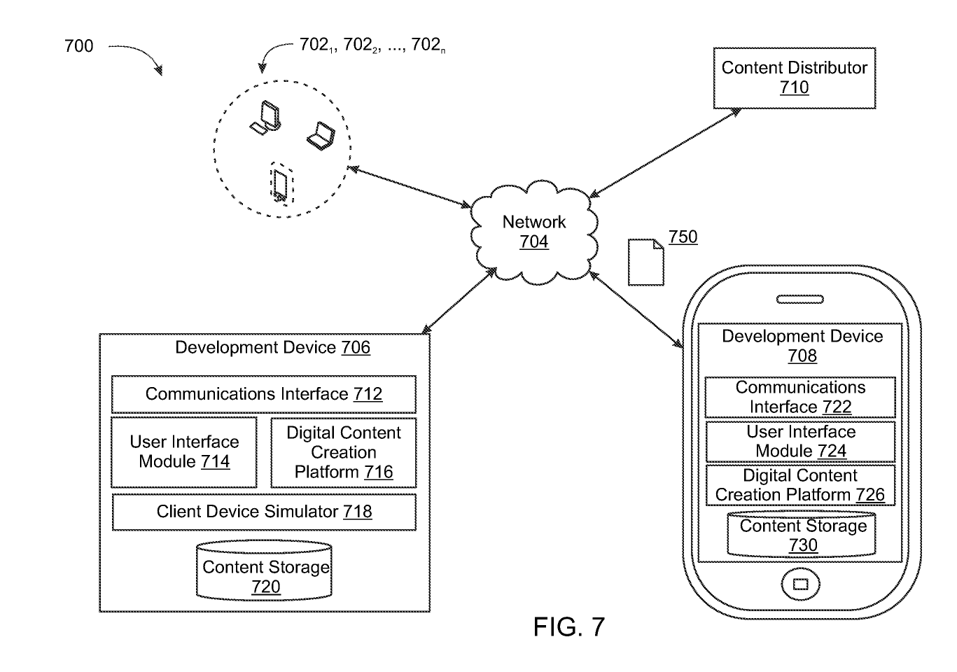

The presently disclosed system and method is particularly useful for designing and distributing digital publications in a manner that eliminates barriers between content creators and the presentation of highly interactive digital publications. A content creator can be any user creating digital content, such as a professional and/or amateur publisher, designer, editor, writer, author, reporter, and/or producer of a digital publication. An exemplary ecosystem configuration 700 is illustrated in FIG. 7. In ecosystem 700, interactive digital publications, such as those described above, can be developed on development devices 706 and/or 708 for distribution to client devices 702₁, 702₂, . . . , 702ₙ (collectively “702”). Distribution of a digital publication 750 can occur via a network 704. The ecosystem 700 can be configured for use on a local area network such as that illustrated in FIG. 7. However, the present principles are applicable to a wide variety of network configurations that facilitate the intercommunication of electronic devices. For example, each of the components of ecosystem 700 in FIG. 7 can be implemented in a localized or distributed fashion in a network.

Development of a digital publication can occur in a digital content creation platform residing on a development device, such as development devices 706 and 708. The digital content creation platform can be a computer-implemented application. An advantage of the presently disclosed digital content creation platform is that the digital content creation platform can be used on the same type of device for which the digital publication is being created. For example, if the digital publication is to be run on a particular type of tablet computing device, the digital publication can be created using the digital content creation platform on that type of tablet computing device.

Development device 708 can be any computing device for which the digital publication is being created. In some embodiments, development device 708 can be a tablet computing device with a multi-touch interface. However, other client device types with different functionality are also possible. Development device 708 can include a digital content creation platform 726 for development of a digital publication. As previously mentioned, the digital content creation platform 726 can be a computer-implemented application. In some cases, the digital content creation platform 726 can be a stand-alone application. That is, an application that is not part of some other software bundle. However, the digital content creation platform 726 can also be an application plug-in or be part of a software bundle, such as the operating system. Furthermore, even though the digital content creation platform 726 is depicted as a single module, the digital content creation platform 726 can be multiple modules. In some cases, the different modules can be part of different software bundles. For example, a module of the digital content creation platform 726 can be part of the operating system, while the remaining modules are client applications.

In some cases, development of a digital publication can require assets external to the digital content creation platform 726. Such assets can include multimedia content, e.g. text, tables, images, slideshows, audio, video, links, computer executable code, etc. The assets can be stored on the client device 708 in a content storage 730. Additionally, the development device 708 and/or the digital content creation platform 726 can be configured to access storage external to the development device 708, such as an external hard drive, a local area network, and/or cloud-based storage. The ability to access storage external to the development device 708 can be particularly important when the development device 708 is a mobile device where a user-space application, such as the digital content creation platform, does not have access to the full file system on the development device 708.

To facilitate interaction by a content creator with the digital content creation platform 726, the development device 708 can include a user interface. A user interface module 724 can facilitate communication between the user interface and the digital content creation platform 726. Development device 708 can also include a communications interface 722 for facilitating communication between the development device 708 and other development devices, client devices 702, and/or a content distributor 710. Furthermore, in some configurations, the communications interface 722 can facilitate communication between the different components of the development device 708, such as the digital content creation platform 726 and the content storage 730.

Development of the digital publication on the target device can provide an advantage in that it decreases the amount of testing required. When a digital publication is designed on a different type of device, such as a desktop computer, it can be previewed on the desktop, but this provides little guarantee that the digital publication will perform properly once installed on the actual device. This is particularly true when the preview feature does not exercise the actual functionality of the target client device. For example, if the digital publication makes calls to API functions in the client device's operating system, these calls will not actually be made during the preview. Therefore, when the digital publication is installed on the target client device and the actual function calls are made, the digital publication may perform differently than expected. To account for the potential differences, the digital publication must be compiled, installed on the target client device, and tested. Any changes that need to be made then require returning to the development device, making the change, recompiling, re-installing, and re-testing. This process can occur many times before a digital publication is ready for release. Furthermore, in some configurations, installing on a client device can be very time consuming because the digital publication must first be uploaded to a third-party server. However, when the digital publication is developed on the target device, the preview functionality does exercise the actual functionality of the target device. Therefore, when the digital publication is installed on the target device it will perform as it did during the preview testing. This eliminates the sometimes costly step of having to compile, install, and test on the target device.

Development on the target device has the additional advantage that tablet and other similar computing devices are often less expensive than desktop and laptop computers. This can not only decrease development costs, but also make development of interactive digital publications more accessible. For example, an individual who wants to develop a digital publication for personal use or who wants to enter the digital publishing market can do so with a much lower overhead cost.

In some embodiments, the digital content creation platform can be run in a simulator on a different type of computing device than the target client device. For example, if the digital publication is to be run on a particular tablet computing device, the digital publication can be created on a desktop computer in a tablet simulator. To do this, the digital content creation platform can be run inside a simulator that simulates the tablet computing device including the software installed on the tablet device, such as the operating system. As with development on the target device, when previewing in the simulator the functionality, such as API calls, of the target devices can be exercised.

Development device 706 can be any general purpose computing device. In some embodiments, development device 706 can be a desktop or laptop computer. However, other device types are also possible. Development device 706 can include a client device simulator 718. The client device simulator 718 can simulate all of the functionality of one or more target client devices. A simulator can be a model of a client device that captures the functional connections between the inputs and outputs of the client device. That is, a simulator can model the environment of the client device. In some cases, a simulator can include the operating system software of the simulated client device.

Development device 706 can also include a digital content creation platform 716 for development of a digital publication for a target client device type. Digital content creation platforms 706 and 716 can include the same functionality. The digital content creation platform 716 can run inside the client device simulator 718. As previously mentioned, the digital content creation platform 716 can be a computer-implemented application. In some cases, the digital content creation platform 716 can be a stand-alone application. However, the digital content creation platform 716 can also be an application plug-in or be part of a software bundle, such as the client device simulator 718. Furthermore, even though the digital content creation platform 716 is depicted as a single module, the digital content creation platform 716 can be multiple modules. In some cases, the different modules can be part of different software bundles. For example, a module of the digital content creation platform 716 can be part of the client device operating system included in the client device simulator 718.

In some cases, development of a digital publication can require assets external to the digital content creation platform 716. Such assets can include multimedia content, e.g. text, tables, images, slideshows, audio, video, links, computer executable code, etc. The assets can be stored on the client device 706 in a content storage 720. Additionally, development device 706, client device simulator 720, and/or the digital content creation platform 716 can be configured to access storage external to the development device 706, such as an external hard drive, a local area network, and/or cloud-based storage.

To facilitate interaction by a content creator with the digital content creation platform 716 and/or the client device simulator 718, the development device 706 can include a user interface. A user interface module 714 can facilitate communication between the user interface and the digital content creation platform 716 and/or the client device simulator 718. Development device 706 can also include a communications interface 712 for facilitating communication between the development device 706 and other development devices, client devices 702, and/or a content distributor 710. Furthermore, in some configurations, the communications interface 712 can facilitate communication between the different components of the development device 706, such as the digital content creation platform 716, the client device simulator 718, and the content storage 720.

In some embodiments, development device 706 can be a server and one or more client development devices can connect to development device 706 to develop a digital publication. Client development devices connected to a network 104 can connect to development device 706 by direct and/or indirect communication. In this embodiment, development device 706 can support connections from a variety of different client development devices, such as desktop computers; mobile computers; handheld communications devices, e.g., mobile phones, smart phones, tablets; and/or any other network-enabled computing devices. Furthermore, development device 706 can concurrently accept connections from and interact with multiple client development devices.

In some cases, a content creator can interact with the digital content creation platform 716 on a server development device 706 via a client-side application installed on the client development device. In some embodiments, the client-side application can be a stand-alone application, one or more application plug-ins, and/or a browser extension. However, the content creator can also interact with the digital content creation platform 716 on server development device 706 via a third-party application, such as a web browser, that resides on the client development device and is configured to communicate with the server development device 706. In either case, the client-side application can display a user interface for the content creator to interact with the digital content creation platform 716.

In some cases, after development of a digital publication, development devices 706 and/or 708 can upload the digital publication to a content distributor 710, such as an online or cloud-based digital publication store. Client devices 702 can then obtain a copy of the digital publication through the content distributor 710. Ecosystem 700 can also be configured so that client devices 702 can obtain a copy of the digital publication directly from a development device.

### 2. Digital Content Creation Platform

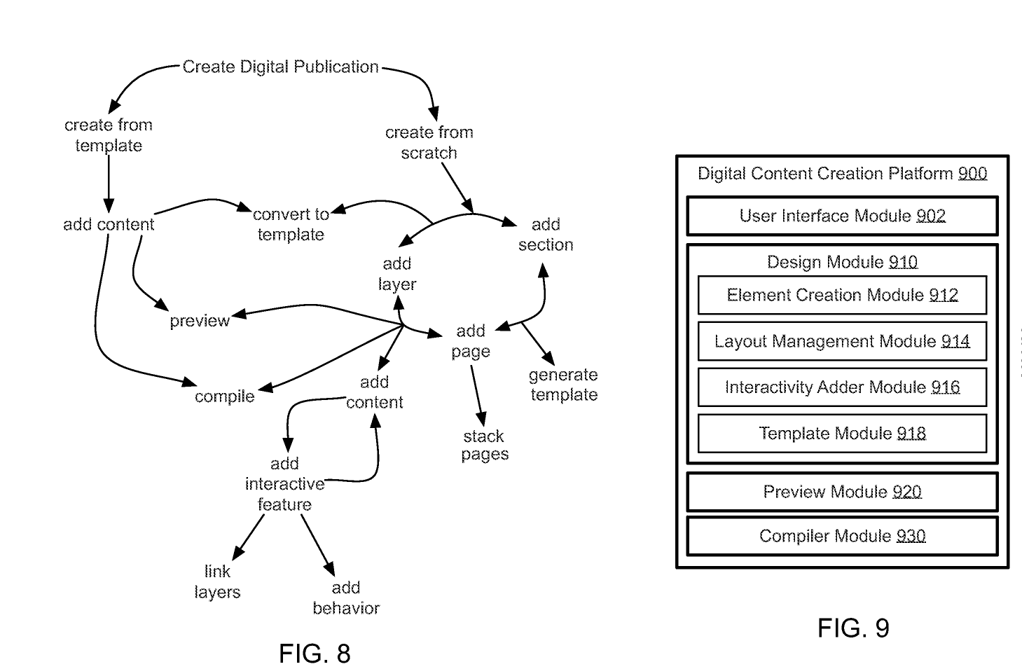

The digital content creation platform can make it possible for a content creator to create an interactive digital publication, such as described above. The features of the digital content creation platform will be discussed in greater detail in the subsections below; however, FIG. 8 provides a general overview of a subset of the functionality provided by the digital content creation platform.

As illustrated in FIG. 8, the digital content creation platform can include a variety of features that a content creator can use to create an interactive digital publication. For example, using the digital content creation platform, a content creator can create a digital publication from an existing template or from scratch. When creating the digital publication without the aid of a template, the digital content creation platform can include functionality to add one or more sections, one or more pages to a section, and one or more layers to a page. Additionally, the digital content creation platform enables the content creator to add multimedia content to a layer, link layers, and/or add some other action, such as an interactivity feature or behavior. At any point during the design, the content creator can use the digital content creation platform to preview or run the digital publication. This can enable the content creator to experience the behavior of the digital publication as it would exhibit on a client device 702. The digital content creation platform can also enable the content creator to generate a template from the current layout of the digital publication for later use or convert the digital publication from the current layout to a different, previously saved template layout. When creating the digital publication from a template, the digital content creation platform includes functionality to add multimedia content to the various layers in the layout. Finally, after adding content, the content creator can use the digital content creation platform to compile the digital publication for distribution. The digital content creation platform features and usage scenarios are discussed in more detail in the following sections.

The exemplary digital content creation platform is described with a focus on digital magazine publications. It should be understood to one skilled in the art that such a restriction is not necessary. The digital content creation platform can be used to create a variety of interactive digital publications, such as books, articles, newspapers, newsletters, presentations, marketing or sales tools, order forms, product catalogs, training programs, instructional materials, portfolios, scrapbooks, and/or photo albums. Furthermore, professionals and/or amateurs can use the digital content creation platform to create commercial and/or personal publications.

### 2.1 Architecture

As illustrated in FIG. 9, the architecture of the digital content creation platform 900 can contain a number of components. The components can include one or more modules for controlling the features provided by the digital content creation platform, e.g. a user interface module 902, a design module 910, a preview module 920, and a compiler module 930. Furthermore, each module can include one or more sub-modules, such as an element creation module 912, a layout management module 914, an interactivity adder module 916, and a template module 918. Each of the components in FIG. 9 is discussed in more detail below; however, it should be understood to one skilled in the art, that the architectural configuration in FIG. 9 is simply one possible configuration and that other configurations with more or less components are also possible. Furthermore, the digital content creation platform 900 can be used on development devices 706 and/or 708.

### 2.1.1 Modes

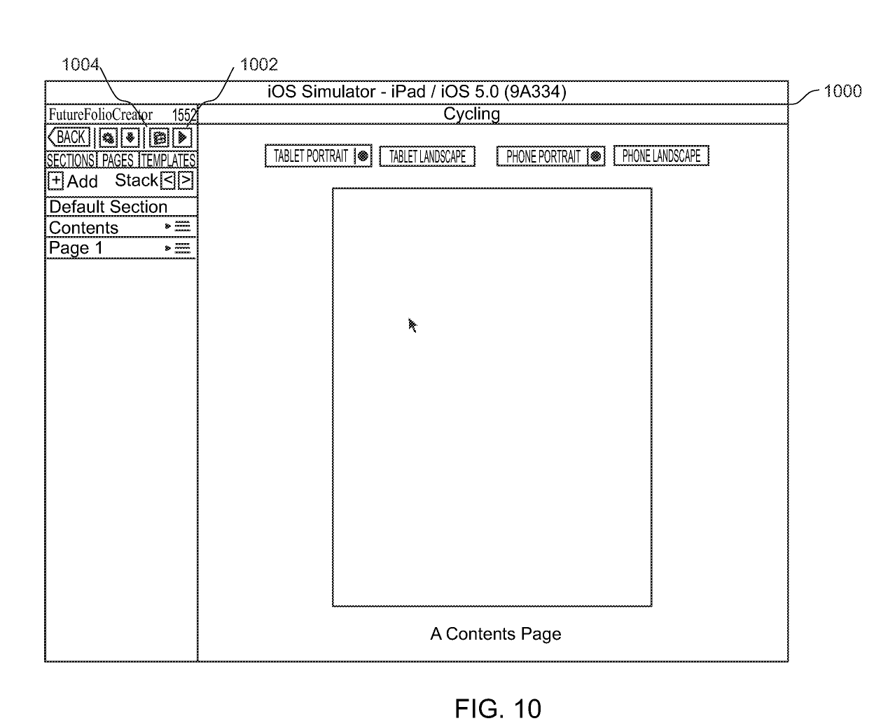

The digital content creation platform 900 can include at least three modes: design, preview, and compilation. The digital publishing module 900 can include a design module 910, a preview module 920, and a compiler module 930 to provide the features of the three different modes. FIG. 10 illustrates an exemplary user interface 1000 for the digital content creation platform 900. In user interface 1000, the digital content creation platform 900 is currently in design mode. The user interface 1000 includes user interface elements 1002 and 1004 to switch to either preview or compilation modes, respectively.

The design mode can enable a content creator to lay out a digital publication including adding a variety of interactive features to the publication. The design mode can include all aspects of digital publication design including adding and/or positioning sections, pages, and/or layers; adding multimedia content to a layer; adding relationships between sections, pages, and/or layers; adding interactive features; creating layout templates; etc. In some configurations, the design module 910 can provide the greatest variety of functionality within the digital content creation platform 900. Therefore, the design module 910 can include one or more additional components, e.g. an element creation module 912, a layout management module 914, an interactivity adder module 916, and a template module 918.

The preview or run mode can enable a content creator to experience the publication as if it was installed on a client device 702. That is, the preview mode can be used to run the digital publication so that the content creator can interact with the digital publication. An advantage to preview mode is that the content creator can interact with the digital publication as if it was installed on a client device 702 without having to actually install the digital publication. Therefore, the content creator can test the behavior and performance of the digital publication without the added overhead associated with packaging and installing the digital publication. Finally, the compilation mode can enable the content creator to package the digital publication for distribution to end users.

### 2.1.2 User Interface

The digital content creation platform 900 can provide a variety of functionality that requires user interaction, e.g. digital publication layout, digital publication preview, and digital publication compilation. Accordingly, a user interface (UI) can be provided for communicating with a user interface module 902 for performing such tasks. In some cases, the UI can be a multi-touch or gesture-based UI. Therefore, when the digital content creation platform 900 is running in a simulator on a device that does not support multi-touch or gesture based input, the multi-touch and/or gesture inputs can be simulated. That is, a user can interact with the UI using the various input methods of the development device, such as mouse, trackpad, and/or keyboard, and the inputs can be mapped to multi-touch and/or gesture inputs. For example, instead of swiping up and down to scroll a text box, the user can scroll using up and down arrow keys on the keyboard or a scroll feature on a mouse.

The UI can include different features depending on the current mode, e.g. design, preview, and/or build. Furthermore, the UI can include different features and/or structural elements for different sub-modes, e.g. basic element creation, layout, adding interactions, adding behavior, etc. However, when the digital content creation platform 900 is in design mode, the UI can include some general structural elements that can be available during much of the design process.

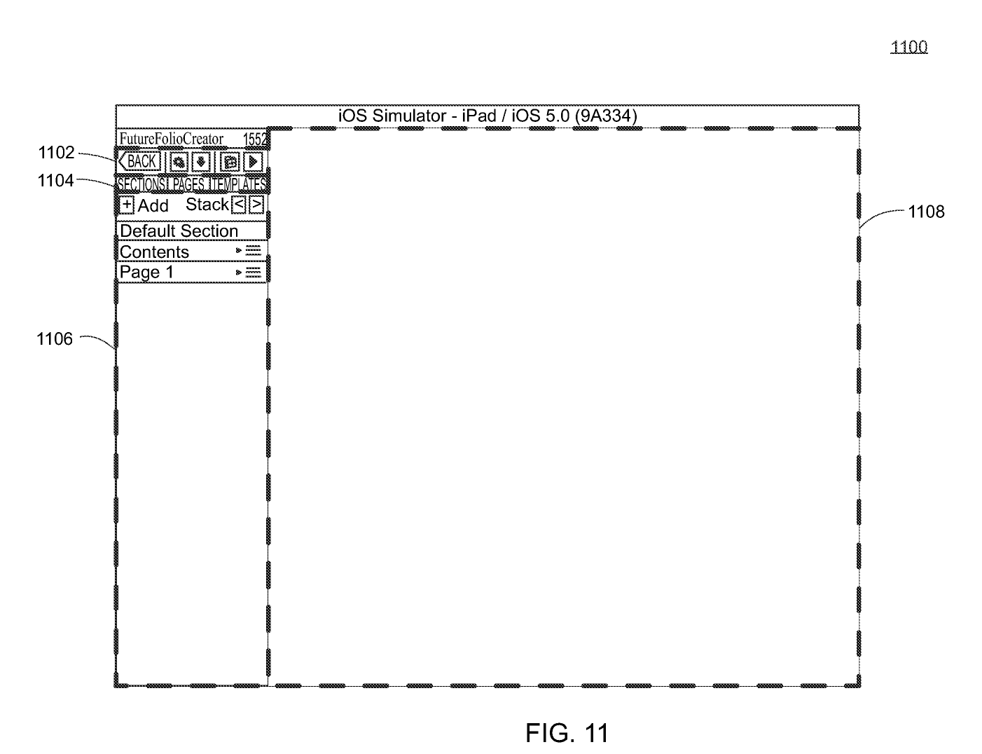

FIG. 11 illustrates an exemplary design mode user interface 1100 depicting a few of the general design mode UI structural elements. A structural element can be a general tool panel 1102. The general tool panel 1102 can include various buttons and/or other UI elements, which can correspond to generally available digital content creation platform features, e.g. buttons to activate build and preview modes. Additionally, the general tool panel 1102 can include UI elements that change depending on the current basic element type, e.g. section, page, layer, template, etc. Another general design mode UI structural element can be a current digital publication element type indicator panel 1104. The digital publication element type indicator panel 1104 can indicate the type of publication element that is currently active. For example, in panel 1104, the “PAGES” type is highlighted indicating that the digital content creation platform 900 is currently configured for activities related to pages, such as adding and/or editing. The current digital publication element type panel 1104 can also be used to select the type of element that the content creator would like to work with. For example, the content creator can select the “SECTIONS” tab to activate features related to sections, e.g. adding and/or editing. Yet another general design mode UI structural element can be a digital publication element type specific panel 1106. The digital publication element type specific panel 1106 can include various buttons and/or other UI elements, which can correspond to features specific to the current digital publication element type, e.g. new digital element buttons, listing of current sections, listing of current pages, etc. The contents of the digital publication element type specific panel 1106 can change depending on the digital publication element type and/or active sub-mode. A further general design mode UI structure element can be a workspace 1108. The use of the workspace 1108 can vary with the digital publication element type and/or active sub-mode. For example, during page editing the workspace 1108 can become a page canvas. Additional design mode UI features are also possible, many of which are discussed and/or illustrated during the discussion of the various digital content creation platform's features throughout the disclosure.

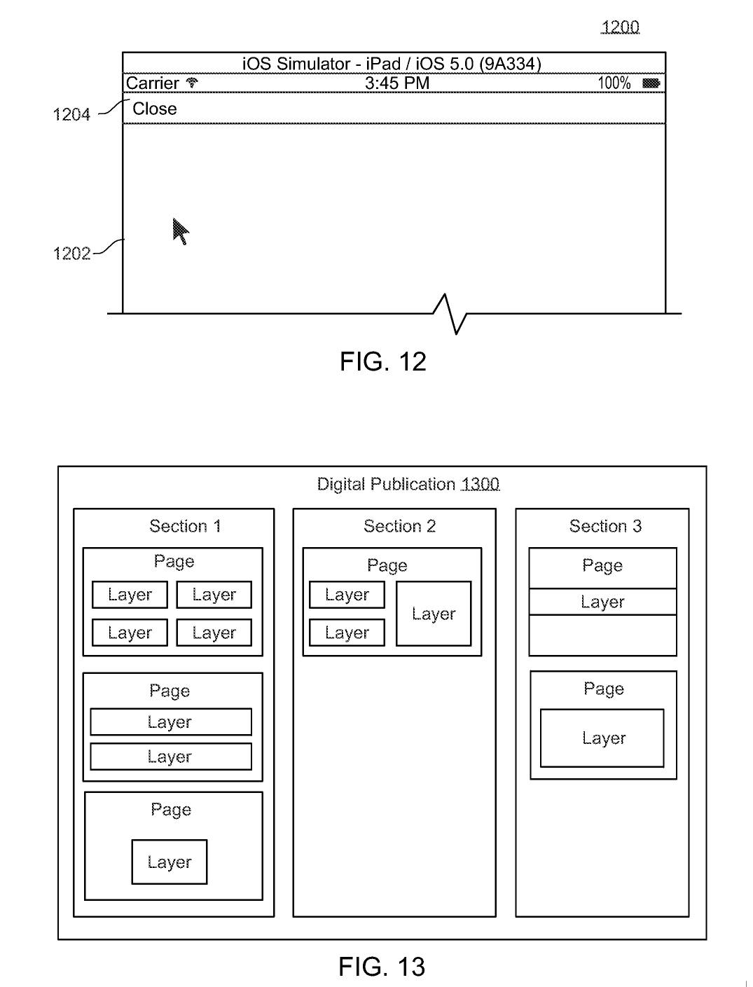

FIG. 12 illustrates an exemplary preview mode user interface 1200. The preview mode UI 1200 depicts the digital publication as if it were running on a target client device. Therefore, the preview mode UI 1200 can include at least two general UI structural elements. A preview mode UI structural element can be display panel 1202. The display panel 1202 can be sized according to the display size of the target client device. The digital publication can be rendered in the display panel 1202. Another preview mode UI structural element can include a close or exit button 1204. The close or exit button can be used to exit preview mode and return to design mode. Additional preview mode UI features are also possible, many of which are discussed and/or illustrated during the discussion of the digital content creation platform's features throughout the disclosure.

In some embodiments, a content creator can customize the configuration of the UI. The UI customizations can be saved and applied to the UI each time the content creator interacts with the digital content creation platform 900. For example, a content creator can rearrange the UI so that features the content creator uses frequently are in more accessible positions. In another example, a content creator can assign customized keyboard commands to simulate multi-touch gestures when the digital content creation platform 900 is running a simulator.

### 2.2 Features

The digital content creation platform 900 provides a content creator with a number of features to facilitate the creation of highly interactive digital publications. The primary feature categories offered by the digital content creation platform 900 include design, preview, and compilation. The features specific to each of the digital content creation platform modes are discussed in more detail below.

### 2.2.1 Design Mode

As described above, the design mode can include a variety of features to enable a content creator to lay out an interactive digital publication. The design mode can include all aspects of digital publication design including adding and/or positioning sections, pages, and/or layers; adding multimedia content to a layer; adding relationships between sections, pages, and/or layers; adding interactive features; creating layout templates; etc. Each of the design mode features is discussed in more detail below.

### 2.2.1.1 Basic Digital Publication Elements

A basic feature of a digital content creation platform 900 can include the creation and addition of section, page, and layer digital publication elements. A digital publication can include one or more sections. In some cases, a section can conceptually be viewed as a chapter in a book or some other unit that contains related content. For example, some magazines are divided into different categories of content, such as News, Reviews, and Tutorials; each category can be designed using a section. In some cases, the sections can be used to split up a table of contents for a digital publication. Furthermore, the sections can be used to provide navigation.

Within a section, the digital publication can include one or more pages. The number of pages within a section can vary based on the section and/or digital publication. In some cases, each page can include one or more renditions. A rendition can define the way a page looks in a particular orientation and/or on a particular client device type. For example, a page can include a rendition for a tablet device in both portrait and landscape orientations. Additionally, within a rendition, the digital publication can include one or more layers. Each layer can include multimedia content. FIG. 13 illustrates an exemplary collection of sections, pages, and layers in a digital publication 1300. As FIG. 13 illustrates, the number of pages within a section can vary based on the section. Furthermore, the number, size, and arrangement of layers within a page can vary.

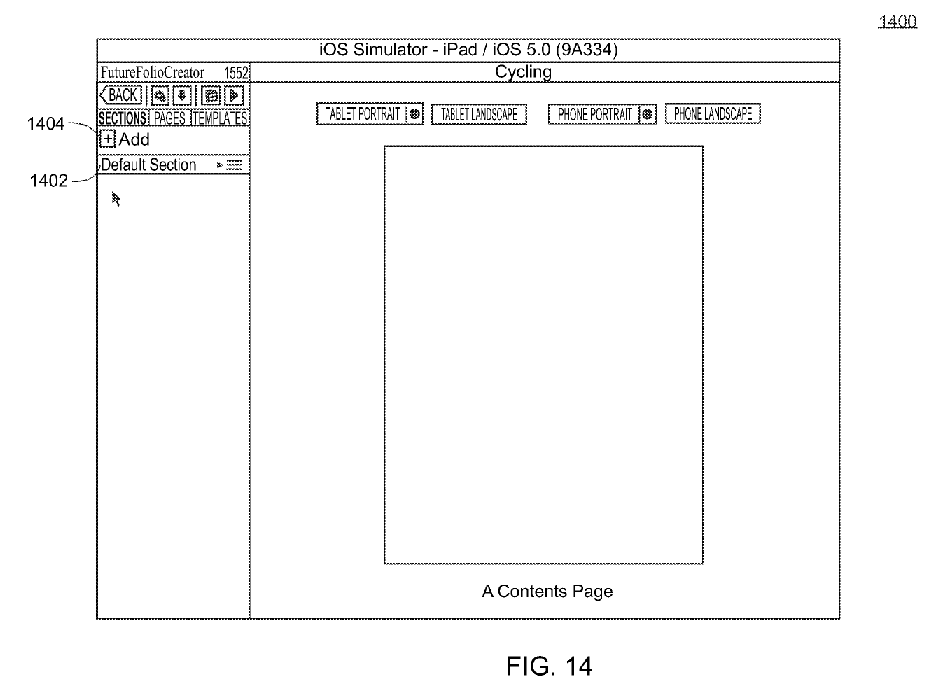

The digital content creation platform 900 can include an element creation module 912 that can facilitate the creation and addition of the various sections within a digital publication. FIG. 14 illustrates an exemplary digital content creation platform UI 1400 that includes a single section 1402. Each section in the digital publication can be assigned a name or identifier. For example, section 1402 has been given the name “Default Section.” In some cases, the name “Default Section” can be the default name assigned to the section upon creation. Alternative default names are also possible. A content creator can change the name of a section at any time. Furthermore, the content creator can change the name of a section as frequently as the content creator wishes. In some configurations, the content creator can change the name of a section by double tapping on the name and then entering a new name. Additional techniques for activating the ability to change a section name are also possible, such as a keyboard command when the digital content creation platform 900 is running in a simulator.

In some configurations, a new digital publication can include a single section by default. Regardless of whether the digital publication already includes a section, a content creator can add a new section to the digital publication. In some configurations, the content creator can add a new section by tapping on a button, such as the “Add” button 1404. Additional techniques for adding a new section are also possible, such as a keyboard command when the digital content creation platform 900 is running in a simulator, or the content creator tapping and holding until a menu appears that include an option to add a new section. These can have the effect of inserting a new section in the digital publication. In some cases, one or more configuration settings can be set when a new section is added, such as a section name and/or order. The configuration settings can have default values and/or a configuration window can be presented to the content creator to specify values.

Additionally, a content creator can remove a section from a digital publication. In some configurations, the content creator can remove a section by tapping on a button, such as a delete button. The content creator can also remove a section by tapping and holding until a menu appears. The menu can include a delete option. Additional techniques for removing a section are also possible, such as keyboard command when the digital content creation platform 900 is running in a simulator. For example, the content creator can select the section and hit the delete keyboard button.

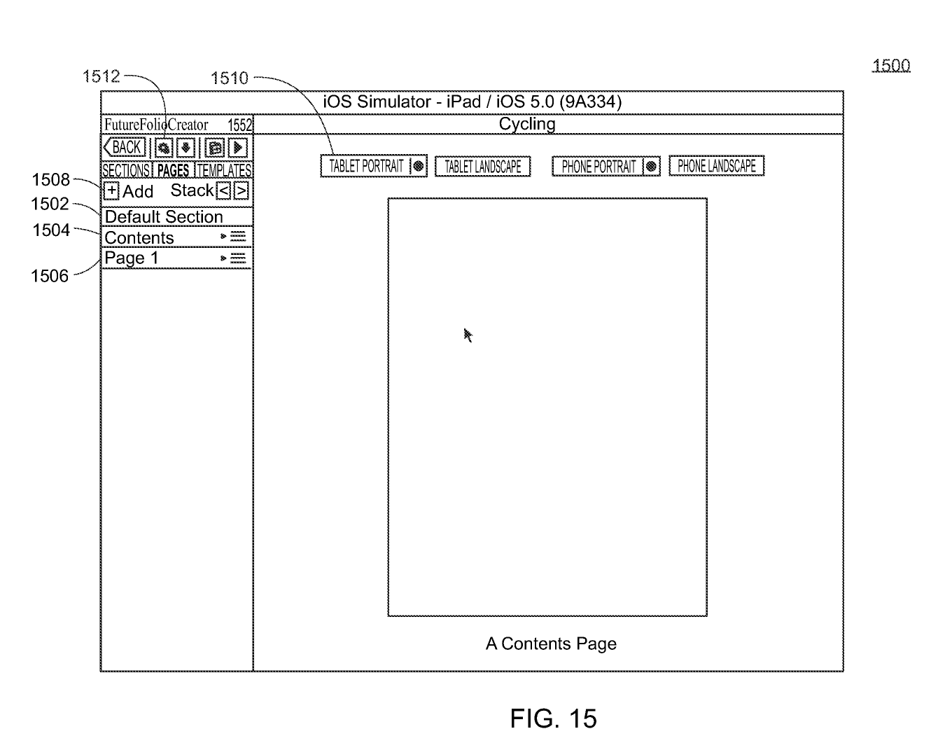

The element creation module 912 can also facilitate the creation and addition of new pages within a section and/or within the digital publication. FIG. 15 illustrates an exemplary digital content creation platform UI 1500 that includes a single section 1502 with two pages 1504 and 1506. Each page in a digital publication can be assigned a name or identifier. For example, page 1504 has been given the name “Contents” and page 1506 has been given the name “Page 1.” In some cases, a page can be assigned a default name upon creation. For example, “Page 1,” “Page 2,” etc. Alternative default names are also possible. A content creator can change the name of a page at any time. Furthermore, the content creator can change the name of a page as frequently as the content creator wishes. In some configurations, the content creator can change the name of a page by double tapping on the name and then entering a new name. Additional techniques for activating the ability to change a page name are also possible, such as a keyboard command when the digital content creation platform 900 is running in a simulator.

In some configurations, a new section can include a single page by default. Regardless of whether a section already includes a page, a content creator can add a new page to the digital publication. In some configurations, the content creator can add a new page by tapping on a button, such as the “Add” button 1508. Additional techniques for adding a new page are also possible, such as a keyboard command when the digital content creation platform 900 is running in a simulator, or the content creator tapping and holding until a menu appears that includes an option to add a new page. These can have the effect of inserting a new page in the currently active section. Alternatively, a new page can be added to the digital publication, without adding it to a particular section. The content creator can then assign the page to a section.

In some cases, one or more configuration settings can be set when a new page is added, such as a page name, order, number of renditions, and/or the size, orientation, and/or background color of a rendition. The configuration settings can have default values and/or a configuration window can be presented to the content creator to specify values. For example, the element creation module 912 can by default create a page with a single rendition that is tablet-sized with a portrait orientation. In some cases, a content creator can change the orientation of the page rendition by selecting a button for the desired orientation. For example, a content creator can select button 1510 to select a page rendition with a tablet portrait orientation. Alternative ways of setting the page rendition orientation are also possible, such as by adjusting a properties setting associated with a page rendition. In some cases, a content creator can change the page rendition size by selecting a button for desired device type size. For example, a content creator can select button 1510 to select a page rendition sized for a tablet device. Alternative ways of setting the page rendition size specific to a device type are also possible, such as by adjusting a properties settings associated with a page rendition. In some cases, a default page rendition size can be set such that an end user can view all content on the page without having to scroll.

Furthermore, in some cases, when a content creator attempts to make a change, such as a change in page rendition size and/or page rendition orientation, the digital content creation platform 900 can generate an alert or notification. The alert or notification can notify the content creator of the occurrence of a predefined event, such as an unsupported and/or undesirable transformation. For example, if the content creator changes the page rendition size from a tablet size to a phone size and the page contains content not supported on a phone or that performs sub-optimally on a phone, then the digital content creator platform 900 can generate a notification to alert the content creator of the detected problem. In some cases, the digital content creator platform 900 can include default predefined events, such as platform-specific unsupported features. However, the digital content creation platform 900 can also be configured so that a content creator can define an event such that if the event occurs, the content creator should be notified, such as the use of a feature that the content creator believes performs sub-optimally on a particular device type.

Additionally, instead of creating a blank page with one or more blank page renditions, the element creation module 912 can support creating a new page and/or page rendition from an existing template. In some cases, when a page is created from a template the new page can be assigned a name based on the name of the template. A template can specify a layout for a page and/or a page rendition. A content creator can then edit the page to add content. In some cases, a content creator can also edit the layout of the page. Additional details regarding the use and creation of templates will be discussed below.

A content creator can also remove a page and/or page rendition. In some configurations, the content creator can remove a page and/or page rendition by tapping on a button, such as a delete button. The content creator can also remove a page by tapping and holding until a menu appears. The menu can include a delete option. Additional techniques for removing a page and/or page rendition are also possible, such as a keyboard command when the digital content creation platform 900 is running in a simulator. For example, the content creator can select the page and hit the delete keyboard button.

The element creation module 912 can also facilitate the creation and addition of new layers within a page rendition. Layers can be used to add the various multimedia content items to a page rendition. Layers can also be used to establish relationships between the content items. To add a new layer to a page rendition, a content creator can enter page editing mode. The manner in which a content creator can enter page editing mode can vary. In some cases, a content creator can enter page editing mode by double tapping the page in the digital publication element type specific panel. A content creator can also enter page editing mode by selecting the page in the digital publication element type specific panel and selecting an edit button. Additional techniques for entering page editing mode can also be used, such as a keyboard command when the digital content creation platform 900 is running in a simulator.

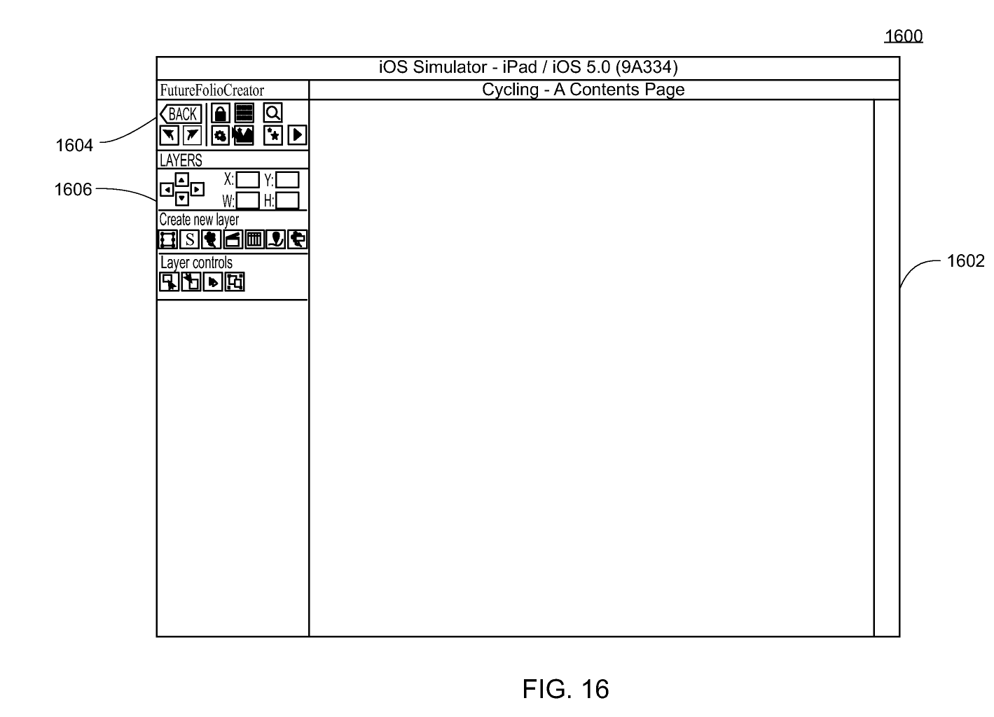

FIG. 16 illustrates an exemplary digital content creation platform UI 1600 for adding layers to a page rendition. As illustrated in UI 1600, the workspace panel 1602 now reflects a page canvas so that the layers can be positioned on the page. Additionally, both the general tool panel 1604 and the digital publication element type specific panel 1606 reflect UI structural elements specific to the creation, addition, and placement of layers.

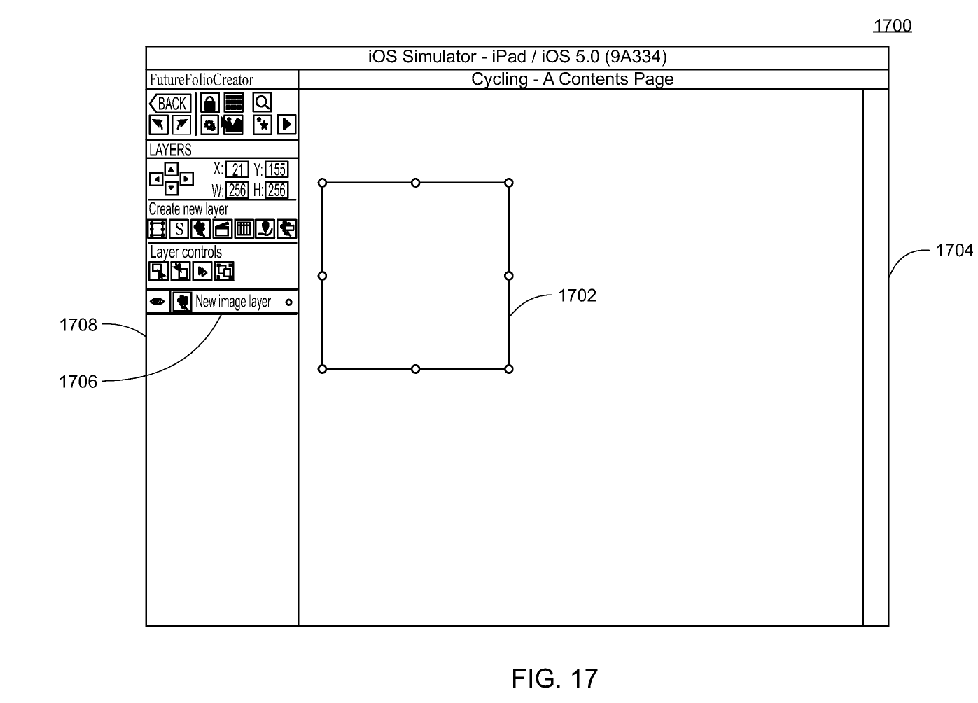

Instead of having a single button for the creation of a layer, the digital content creation platform 900 can include multiple buttons where each button is used to create a specific layer type. For example, UI 1600 illustrates seven create new layer buttons. The seven new layer buttons correspond to box, story, image, video, table, map, and annotation layer types, respectively. Additional types of layers are also possible. When a content creator selects one of the new layer buttons, the element creation module 912 creates a re-sizeable, repositionable layer representation on the page canvas. FIG. 17 illustrates an exemplary digital content creation platform user interface 1700 in which a new layer has been created. The new layer 1702 can be positioned at a default position on page canvas 1704. In addition to creating the new layer 1702 on the page canvas 1704, the element creation module 912 adds new layer information 1706 to the layer area 1708. The layer information 1706 can include a variety of information including a name, a layer type, and/or a layer visibility. In some cases, a layer can be assigned a default name upon creation, for example, “new image layer,” “new story layer,” etc. Alternative default names are also possible. A content creator can change the name of a layer at any time. Furthermore, the content creator can change the name of a layer as frequently as the content creator wishes. In some configurations, the content creator can change the name of a layer by double tapping on the name and then entering a new name. Additional techniques for activating the ability to change a layer name are also possible, such as a keyboard command when the digital content creation platform 900 is running in a simulator. While new layer 1702 is illustrated as square, a layer element can be of any shape including square, rectangle, circle, oval, triangle, polygon, etc.

In some cases, one or more configuration settings can be set when a new layer is added, such as a layer name, order, size, and/or position on the page canvas. The configuration settings can have default values and/or a configuration window can be presented to the content creator to specify values. Additional details regarding the features of the various layers will be discussed in the sections that follow.

### 2.2.1.2 Digital Publication Layout

Another basic feature of a digital content creation platform 900 can include the layout of the digital publication. The digital content creation platform 900 can include a layout management module 914 to facilitate the layout of the various digital publication elements. Digital publication layout can include the order of the sections within the digital publication, the inclusion and order of pages within a section, and/or the positioning of the layers within a page. Additional aspects of the design of a digital publication can also be categorized under design layout, such as creating relationships between different digital publication elements. However, some of these additional aspects are discussed in sections below, which are specific to digital publication element linking and interactivity.

Once a digital publication contains multiple sections, the sections can be rearranged. That is, the order of the various sections in a digital publication can be altered. The order of the sections can represent the order that an end user would encounter the sections if the end user were to simply flip through the digital publication. For example, if a digital publication includes two sections, Section A and Section B, and the sections are arranged in that order, then when the end user flips through the digital publication, the end user will experience Section A prior to Section B. In some configurations, a content creator can rearrange the sections by selecting the section and moving the section before or after a different section. That is, the digital content creation platform 900 can support dragging and dropping of sections to lay out the section order within the digital publication.

Likewise, once a section contains multiple pages, the pages can be rearranged. That is, the order of the various pages in a section can be altered. The order of the pages can represent the order that an end user would encounter the pages if the end user were to simply flip through the pages of a section. For example, if a section includes two pages, Page A and Page B, and the pages are arranged in that order, then when the end user flips through the section, the end user will experience Page A prior to Page B. In some configurations, a content creator can rearrange the pages by selecting the page and moving it before or after a different page. That is, the digital content creation platform 900 can support dragging and dropping of pages to layout the page order within the section. Furthermore, the digital content creation platform 900 can support moving a page from one section to another section. For example, if a digital publication contains two sections, Section A and Section B, and section B contains Page A, the content creator can move Page A from Section to B to Section A.

The digital content creation platform 900 can support multiple page orientations. For example, a content creator can create a rendition of a page with a portrait orientation and a rendition of the page with a landscape orientation. This can make it possible for a content creator to specify different page layouts for different device orientations so that when an end user changes the orientation of the end user's client device, the layout of the page will be optimized for the particular orientation.

The digital content creation platform 900 can also support multiple page sizes, such as for different client device types. For example, a content creator can create a rendition of a page with a tablet size page and another rendition of the page with a phone size page. This can make it possible for a content creator to specify different page layouts for different device types. Thus, when the end user views the digital publication on a tablet device versus a phone device, the page can be optimized for the different screen sizes.

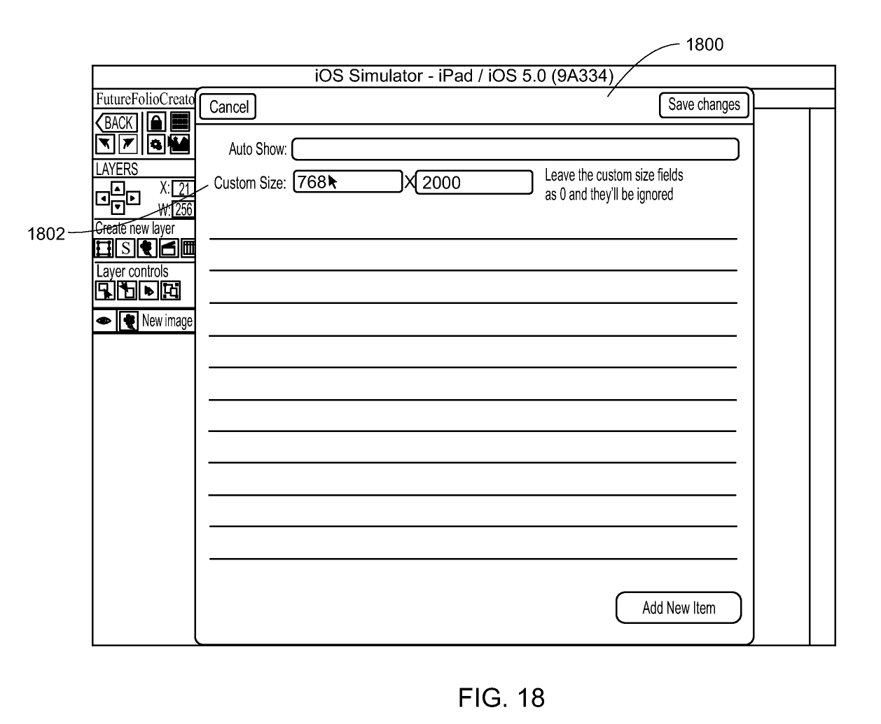

The digital content creation platform 900 can also support custom sized pages. In some cases, the element creation module 912 can create a new page with a default size, such as phone size, but include functionality that can allow the content creator to adjust the size. For example, the content creator could increase the length and/or width of the page. For example, referring back to FIG. 15, a content creator can select button 1512 to display and/or edit properties associated with the page. FIG. 18 illustrates an exemplary properties window 1800 in which a content creator can enter values for the custom size property 1802.

The default layout for the relationship between pages in a section can be that the pages are ordered in a right, left fashion, such as in a traditional print magazine or book. For example, if a section contains pages Page 1 and Page 2, when the end user interacts with the digital publication Page 1 will be displayed, and when the end user swipes from right to left, Page 2 will be displayed. However, the digital content creation platform 900 can also support an up, down layout for the pages. To create an up, down layout for the relationship between two pages, a content creator can use the stack feature. For example, if a section contains stacked pages Page 1 and Page 2, when the end user interacts with the digital publication Page 1 will be displayed. To view the content on Page 2, the end user can swipe up and down instead of right and left. Conceptually this can have the effect of creating a custom sized page that has the length of multiple pages. An advantage to creating a custom sized page through the stack feature is that the stacked page is treated by the digital content creation platform 900 as two separate pages while in design mode. Therefore, two different content creators can work on the pages simultaneously. It is only once the digital publication is in preview or compile mode that the stacked pages are treated as a single long page.

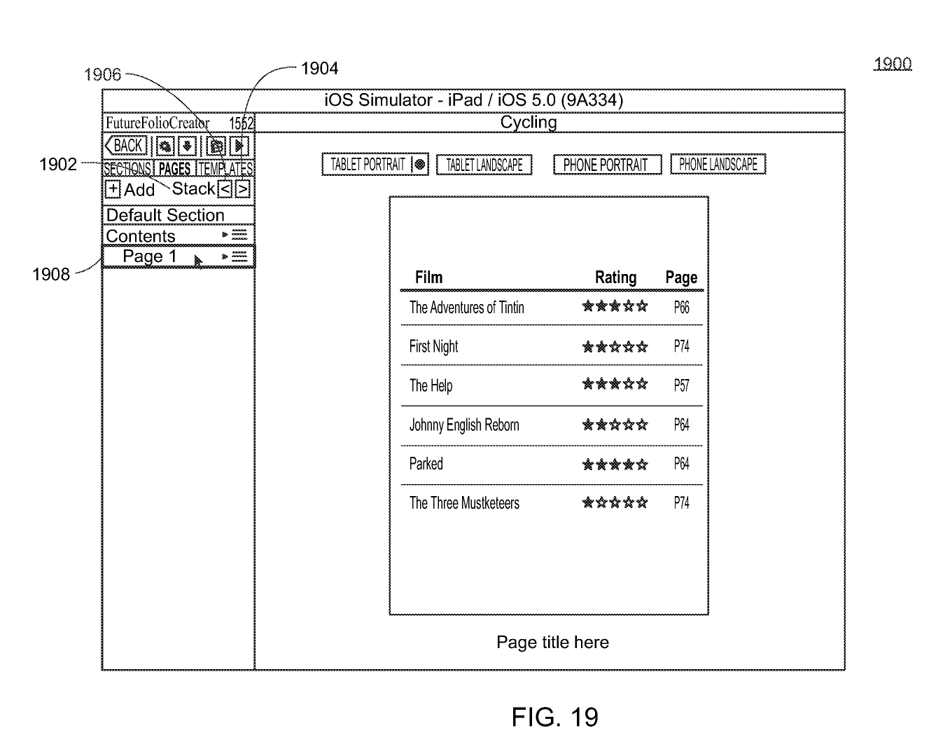

FIG. 19 illustrates an exemplary digital content creation platform UI 1900 depicting the page stack feature 1902. A content creator can select a page and then select an indent button 1904 or un-indent button 1906. Selecting the indent button can have the effect of stacking the page under the previous page. Selecting the un-indent button can have the effect of un-stacking a stacked page. A stacked page can be graphically presented to the content creator by indenting the page information. For example, Page 1 1908 has been stacked, which can be seen in UI 1900 because it is indented. The digital content creation platform 900 can be configured to support additional techniques for stacking and un-stacking pages, such as a keyboard command when the digital content creation platform 900 is running in a simulator.

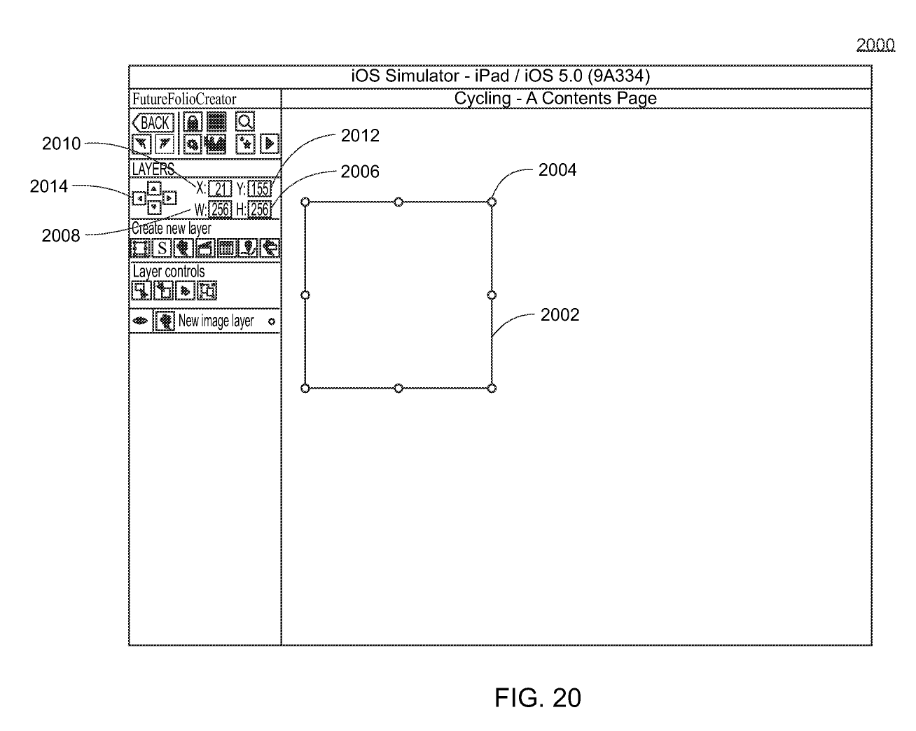

As previously mentioned, a layer element can be re-sizable and repositionable. The digital content creation platform 900 can include a variety of techniques for resizing a layer. A resizing technique can include grabbing predefined points on the layer representation to move one or more edges of the layer. For example, FIG. 20 illustrates a digital content creation platform UI 2000 for editing a layer element 2002. The layer element 2002 can include multiple handles, such as handle 2004. The number and placement of the handles can vary with the configuration of the digital content creation platform 900, the shape of the layer, and/or the size of the layer. The digital content creation platform 900 can also be configured to support layer re-sizing by explicitly specifying height and width values, or other values applicable to the layer shape. For example, a content creator can specify the size of layer 2002 by entering values in height text box 2006 and width text box 2008. Additional re-sizing techniques are also possible, such as pinch and spread multi-touch gestures.

A layer element can also be repositionable. The digital content creation platform 900 can include a variety of techniques for repositioning a layer. A repositioning technique can include grabbing the layer and moving it to another location on the page canvas. The digital content creation platform 900 can also be configured to support layer repositioning by explicitly specifying x and y coordinates for a predefined point in the layer, such as a corner or the center. For example, a content creator can specify the x and y coordinates of layer 2002 by entering values in x-coordinate text box 2010 and y-coordinate text box 2012. Another reposition technique that the digital content creation platform 900 can be configured to support is a nudge feature. The nudge feature can be used to move a layer a small amount. In some cases, a content creator can nudge a layer using the arrow buttons 2014. Additionally, the digital content creation platform 900 can be configured to support additional techniques for nudging layers, such as a keyboard command when the digital content creation platform 900 is running in a simulator. For example, the arrow keys can be used to nudge a layer.

The digital content creation platform 900 can also be configured to support a grid mode. When grid mode is activated the page canvas can be displayed with a grid. Grid mode can be used to facilitate more precise placement of layers on the page canvas. For example, a content creator can line up the edges of a layer on the grid lines. Additionally, the digital content creation platform 900 can support a snap-to-grid feature. When a content creator selects snap to grid, the digital content creation platform 900 can position the layer on the closest grid lines.

A number of different grid sizes can be supported including 4×4, 8×8, 16×16, 32×32, and/or 64×64. Additional grid sizes are also possible. In some cases, instead of specifying a number of squares in the grid, the digital content creation platform can be configured so that a content creator can specify the square size, such as 1 inch or 1 centimeter. Furthermore, in some cases, a grid can be based on other shapes, such as polygons. Other grid mode configuration settings are also possible, such as major and minor grid lines. For example, a grid can be enabled with major grid lines every 1-centimeter and then minor grid lines at even intervals. The major and minor grid lines can be distinguish using color, intensity, line type, etc.

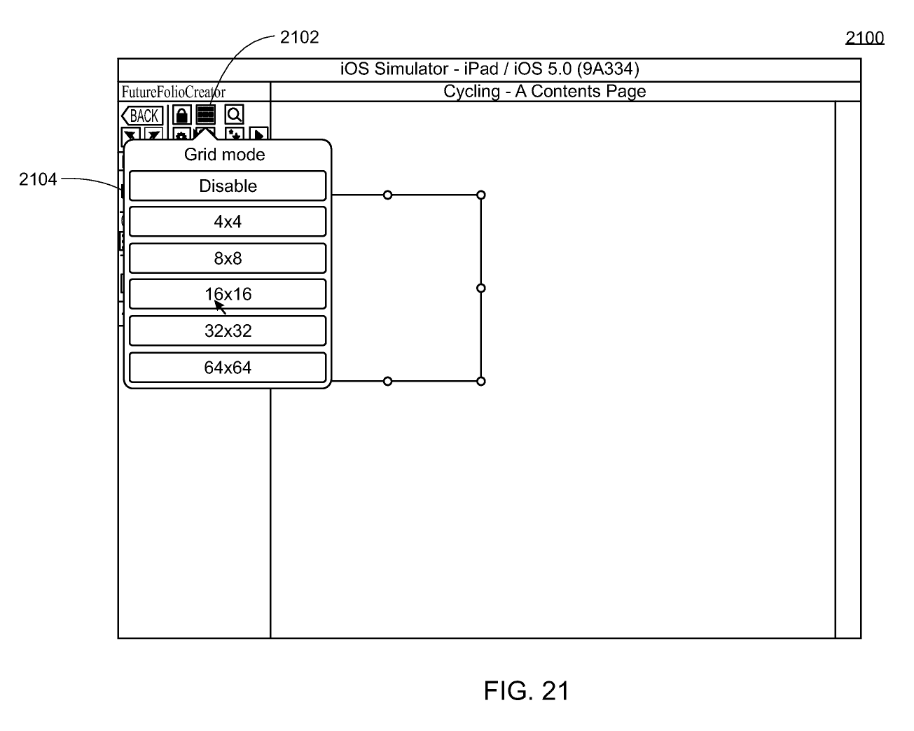

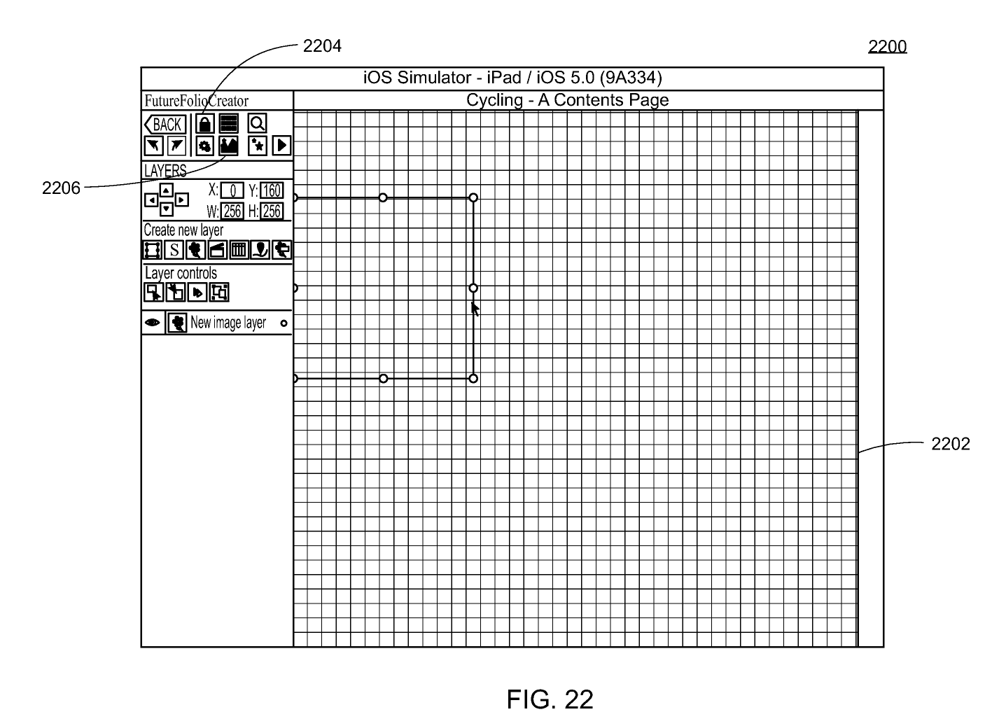

FIG. 21 illustrates an exemplary digital content creation platform UI 2100 for enabling grid mode. To enable grid mode a content creator can select the grid mode button 2102. In response to selecting the grid mode button, the digital content creation platform 900 can display the grid mode options, such as in window 2104. The digital content creation platform 900 can support additional techniques for enabling grid mode, such as a multi-touch gesture on the page canvas or a keyboard command when the digital content creation platform 900 is running in a simulator. Additionally, the digital content creation platform 900 can support additional techniques for displaying the grid mode options. FIG. 22 illustrates an exemplary digital content creation platform UI 2200 with grid mode enabled. Now instead of a blank page canvas, the page canvas 2202 displays a grid.

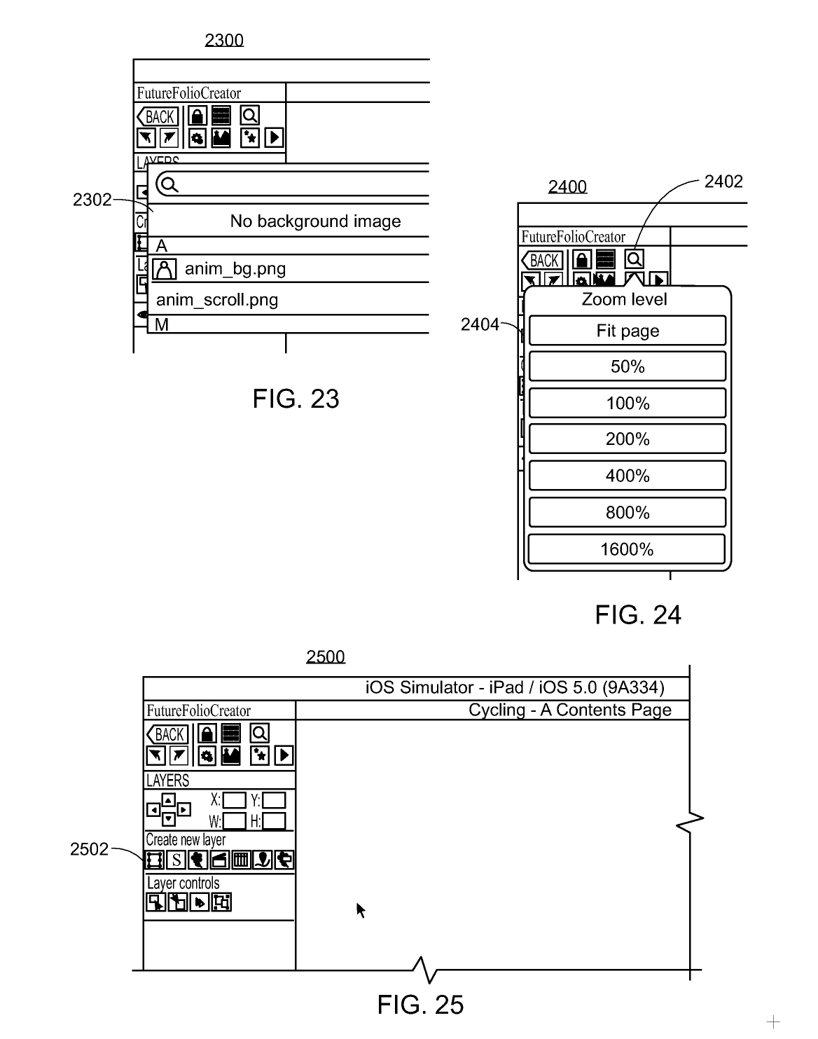

In some cases, a content creator may want to set a single color or image as the background of a page. A way a content creator can do this is to create a single layer the size of the page and then add content to the layer, such as an image or color. Alternatively, the digital content creation platform 900 can include a set background feature. For example, a content creator can select the set background button 2206. In response to selecting the set background button, the digital content creation platform 900 can display a configuration window. In some cases, the configuration window can be a file explorer window. The configuration window can also include configuration settings, such a color, hue, and/or intensity selector. FIG. 23 illustrates an exemplary digital content creation platform UI 2300 with a background configuration window 2302 that includes a file selector. In some cases, it can be more efficient to use a background image than to place a full-page image layer containing the background image. Additionally, the digital content creation platform 900 can be configured to support additional techniques for activating the set background feature, such as a keyboard command when the digital content creation platform 900 is running in a simulator.

Some design work can require finer grained editing and/or inspection. To support fine grained editing, the digital content creation platform 900 can include a zoom feature. A content creator can use the zoom feature to adjust the zoom level of a page while editing the page. For example, the content creator can zoom in for fine-detail work and then zoom back out to see the entire page. FIG. 24 illustrates an exemplary digital content creation platform UI 2400 with the zoom feature. To activate the zoom feature, a content creator can tap the zoom button 2402. In response, the digital content creation platform 900 can display zoom options, such as the options displayed in window 2404. In some cases, instead of a single button and then zoom options, the digital content creation platform 900 can include two buttons, a zoom-in button and a zoom-out button. Additionally, the digital content creation platform 900 can be configured to support additional techniques for activating the zoom feature, such as a keyboard command when the digital content creation platform 900 is running in a simulator.

The digital content creation platform 900 can also support a variety of common editing features, such as undo, redo, copy, and/or paste. Additional editing features are also possible. In some cases, these editing features can be controlled through graphical user interface elements, such as buttons. Additionally, the digital content creation platform 900 can be configured to support additional techniques for controlling these editing features, such as a keyboard command when the digital content creation platform 900 is running in a simulator.

In some cases, once the content creator is satisfied with the design of a digital publication element, the content creator can lock the digital publication element. For example, a content creator can lock a page by clicking on a lock button, such as lock button 2204 in FIG. 22. Locking a digital publication element can prevent inadvertent changes to the layout and/or interactivity features once a content creator is satisfied with the design. A lock feature can be useful when the tasks associated with creating a digital publication are divided between multiple people. For example, a first individual may be responsible for designing the layout and interactivity features and a second individual may be responsible for adding the content to the layers. Once the first individual has completed the design, the first individual can lock the design and pass it along to the second individual to add the content. The lock can give the first individual the peace of mind that the second individual cannot alter the design while adding the content. To further prevent alterations to a locked design, the lock can be password protected and/or associated with user permissions. For example, if the first individual would like to make layout changes after the element has been locked, the first individual would have to enter the password set for the lock. This can prevent unauthorized and/or inadvertent layout and/or interactivity changes.

### 2.2.1.3 Layers

As mentioned above, the digital content creation platform 900 can include support for creating at least seven layer types: box, story, image, video, table, map, and annotation. Additional layer types are also possible. To add a new layer, a content creator can tap on the button corresponding to a desired layer type. For example, FIG. 25 illustrates an exemplary digital content creation platform UI 2500 for adding layers to a page rendition. To add a new layer a content creator can use the create new layer buttons 2502. The buttons from left to right can be used to create layers of type box, story, image, video, table, map, and annotation.

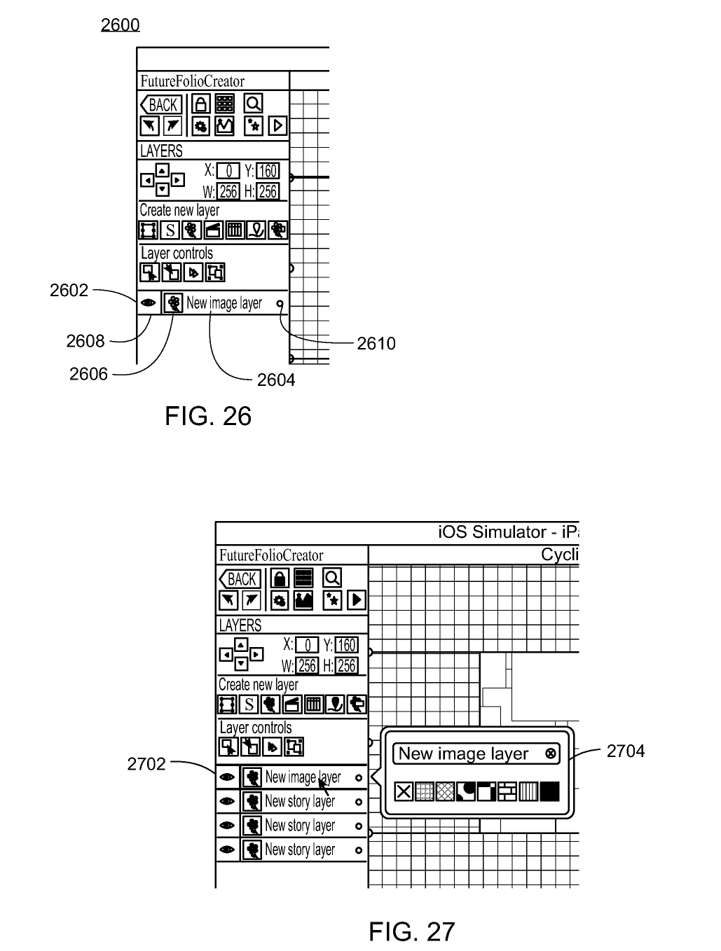

Upon the creation of a new layer, the digital content creation platform 900 can add new layer information to the layer area. The layer information can include a variety of information including a name, a layer type, and/or a layer visibility. Furthermore, the layer information can be used to configure the layer. For example, FIG. 26 illustrates an exemplary digital content creation platform UI 2600 that is focused in on the user interface elements specific to layer editing. The layer information 2602 can include a name 2604, a layer type 2606, a layer visibility 2608, and a cog 2610. A content creator can change the layer's visibility by tapping on the layer visibility button 2608. The visibility setting can be used to show and hide layers. To further configure the layer, the content creator can tap on the cog icon 2610. By clicking on the cog icon 2610, the content creator can activate a configuration panel that can be specific to the layer type. The various configuration settings for the different layer types will be discussed in more detail below. In some configurations, additional information can be included in the layer information 2602. Furthermore, other techniques for configuring and/or activating the configuration of a layer are also possible, such as a keyboard command when the digital content creation platform 900 is running in a simulator.

A page rendition layout can become complex and can include many different layers. In some cases, there can be subsets of layers where the layers within a subset all relate to a specific feature in the layout. The digital content creation platform 900 can support a variety of features that can be used by a content creator to help group and/or quickly identify the layers that make up a subset. For example, a content creator can assign a same color to the layer information in a subset. FIG. 27 illustrates an exemplary user interface 2700 for assigning a color to a layer information. In user interface 2700 an end user can double tap on layer information 2702 to reveal a window 2704. In the window 2704, the content creator can assign a name and/or a color to the layer.

An image layer can be used to add an image type content item, such as JPEG, to a page rendition. In some cases, an image content item can be a single image. However, a single image layer can also support multiple images. Furthermore, in some cases, an image can be a video. The addition of multiple images in a single image layer can be used to create a variety of image behaviors. The image behaviors can include slideshow, animation, 360-degree image, scratch, zoom, and wipe. To add content to an image layer, a content creator can tap on the cog icon, or perform some other action that activates a configuration panel.

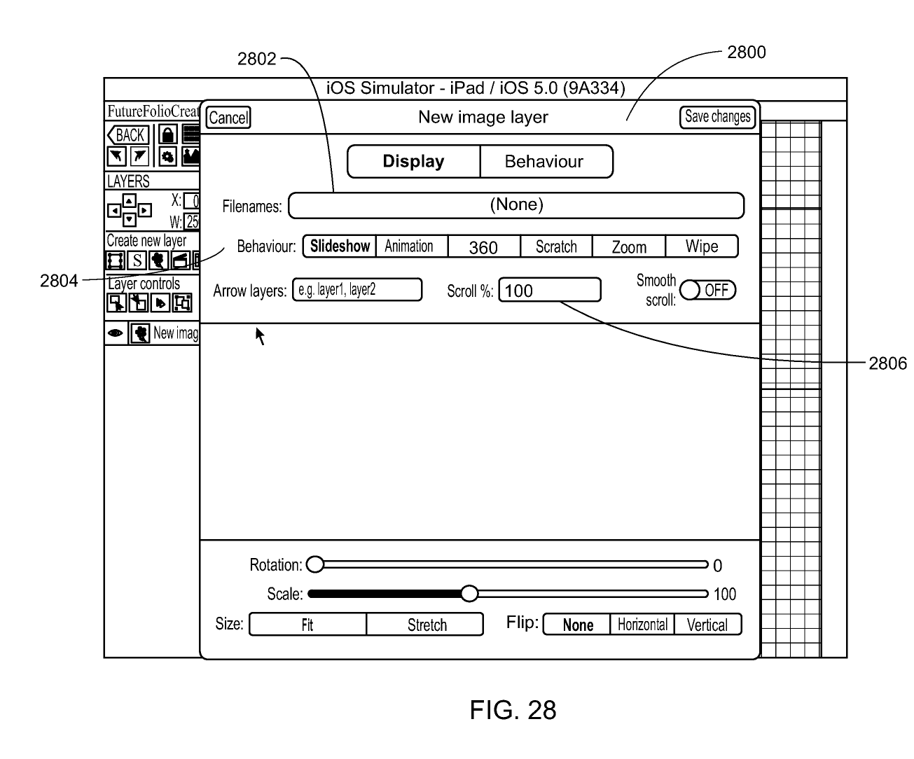

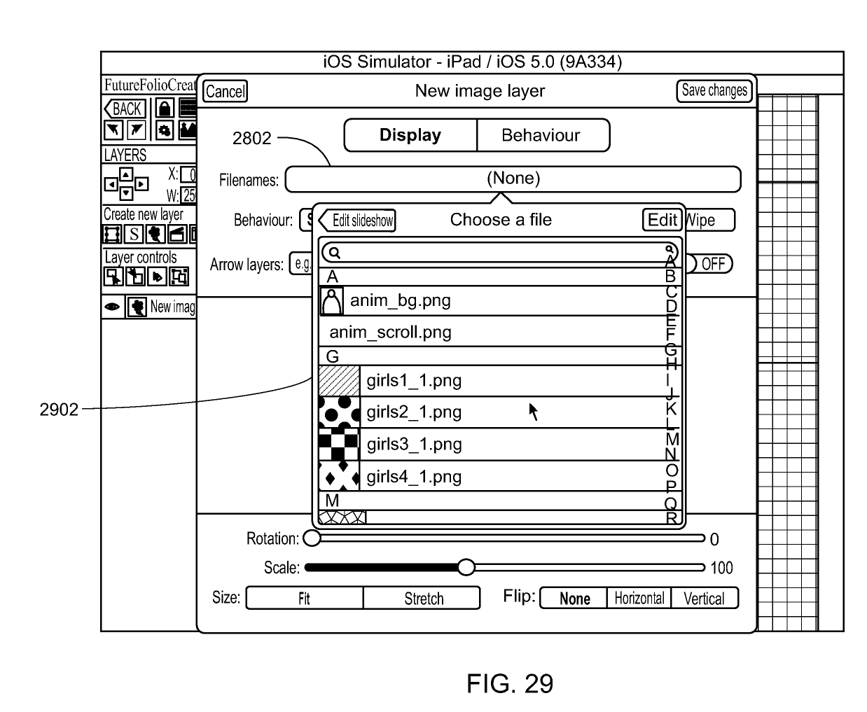

FIG. 28 illustrates an exemplary image layer configuration panel 2800. A content creator can use the configuration panel to add one or more image files. To specify one or more image files for the layer, a content creator can use the filenames setting 2802. In some configurations, upon tapping on the filenames setting 2802 a file selector window can appear. For example, FIG. 29 illustrates an exemplary image layer file selector window 2902. In some configurations, the list of files can be filtered to only include files of a type compatible with the image layer. The determination of which file types are compatible with a layer can be based on one or more attributes associated with the layer. For example, the file selector window for an image layer can include files of type JPEG and PNG, but not TXT.

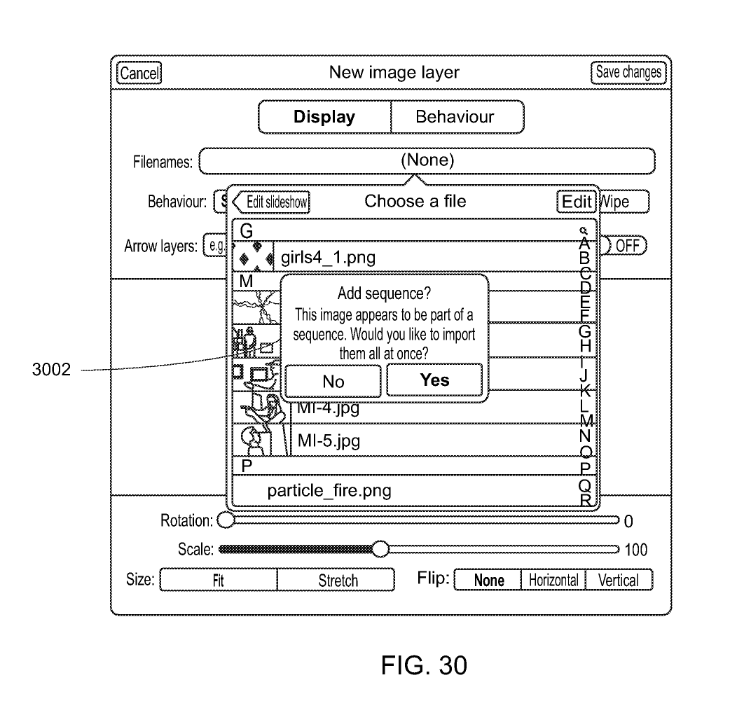

Like many platforms that support file selection, the digital content creation platform 900 can support selecting multiple image files at once. However, the digital content creation platform 900 can also be configured to detect a sequence of image files based on the selection of a single image file. In some cases, the detection can be based on a file naming scheme. One possible naming scheme can be that all image files in a sequence can be named with a common prefix plus a “-” and the number of the image in the sequence. For example, Image-1.jpg, Image-2.jpg, Image-3.jpg. When a content creator selects “Image-1.jpg,” the digital content creation platform 900 can identify that there are other images named using the same naming pattern. The digital content creation platform 900 can then ask the content creator if all images in the sequence should be added to the image layer. For example, FIG. 30 illustrates an exemplary dialog box 3002 displayed in response to detecting a sequence of image files. The digital content creation platform can automatically import all files in the sequence without the need for the content creator to select the other images in the sequence.

In some cases, the sequence detection feature can be enabled only for a subset of the image layer behaviors. For example, the sequence detection can be enabled for the slideshow, animation, and 360 behaviors, but not the scratch, zoom, and wipe behaviors. Additionally, the sequence detection can be configured to only detect a sequence if the content creator selects a file that, based on a predefined sequence naming scheme, can be a first item in the sequence. For example, suppose that the predefined naming scheme was a common prefix plus “-” and a number in the sequence. If the content creator selects “Image-1.jpg” the sequence detection can be invoked, but if the content creator selects “Image-2.jpg” the sequence detection will not check for other images that could be part of a sequence.

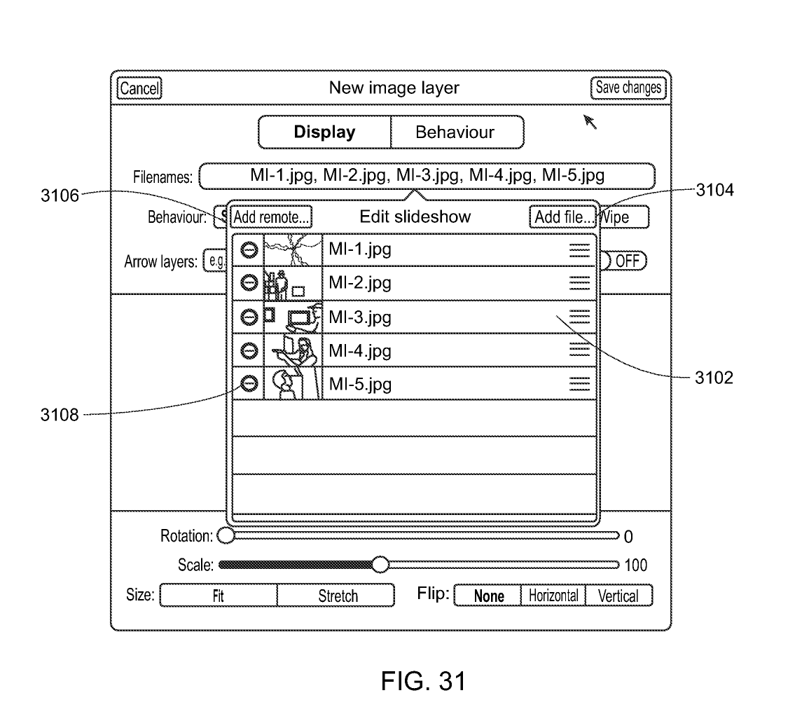

In some cases, prior to completing the import, the digital content creation platform 900 can display the list of image files that the digital content creation platform 900 has detected to be part of a sequence. This can give the content creator the ability to ensure that the sequence includes the correct files and/or to edit the sequence. In some cases, editing can involve adding to, deleting from, and/or re-arranging the file sequence. Furthermore, the content creator can access the sequence of files by tapping on the filenames setting at any time. FIG. 31 illustrates an exemplary user interface window 2102 for editing the sequence of files included in an image layer. A content creator can add new files by selecting either the “Add file . . . ” button 3104 or the “Add remote . . . ” button 3106. Furthermore, a content creator can delete a file by selecting button 3108 or re-arrange the order by selecting a file and moving it to a different position.

The digital content creation platform 900 can include a default predefined sequence-naming scheme. However, in some cases, a content creator can define a custom sequence-naming scheme. For example, a custom naming scheme can be a sequence number plus a common filename. The ability to define a custom naming scheme can be useful if the content creator has already named a sequence of image files or if the content creator would like to use different naming schemes for different digital publications.

Referring back to FIG. 28, a content creator can also assign a behavior to an image layer by selecting one of the available behaviors from the behavior setting 2804. In some cases, after selecting a behavior, one or more of the available configuration settings can change. For example, the scroll percentage setting 2806 can be specific to the slideshow behavior. Therefore, if the content creator selects an animation behavior, the scroll percentage setting 2806 can be removed and/or replaced with a different configuration setting. The configuration panel can also include image transformation settings, such as rotation, scale, size, and flip. Additional configuration settings are also possible.

The slideshow behavior can be used to display a series of images where moving from one image to another requires end user interaction, such as a swipe. In some cases, it may desirable to specify a scroll percentage, such as through the scroll percentage setting 2806. This setting can be used to specify how much an image should move with each swipe. For example, with a scroll percentage of 100%, with each swipe a new image will appear and the old image will completely disappear. However, with a scroll percentage of 70%, a portion of the previous image and a portion of the next image will show on the edges of the page. When an end user swipes, the next image is centered in the image layer box, but a portion of the old image is still visible. This can be used to give an end user an indication that additional content exists.

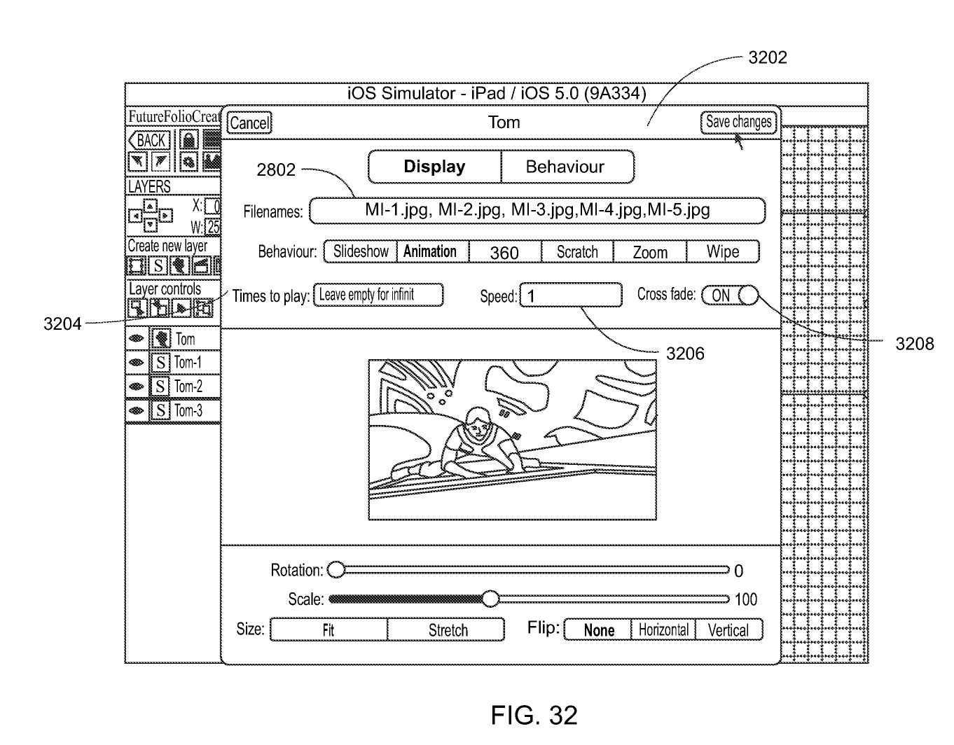

An animation behavior can be used to display a series of images that automatically rotate in a sequence without the need for end user interaction. For example, the layer can be set to rotate to the next image every 2 seconds. FIG. 32 illustrates an exemplary image layer configuration panel 3202 with settings specific to the animation behavior. Configuration settings specific to the animation behavior can include number of times to play, speed, and/or cross-fade.

The times to play setting 3204 can be used to specify the number of times to loop playback of an image sequence. For example, a setting of 1 will cause the images to cycle through the sequence once and play will end on the file image. In another example, a setting of 2 will cause the images to cycle through the sequence twice before ending on the file image. In some cases, the end image can vary with the configuration of the digital content creation platform 900 and/or can be customizable. For example, the sequence can loop through once and instead of displaying the final image in the sequence upon completion, the first image can be displayed.

The speed setting 3206 can be used to control how long an image is displayed before the image is replaced with the next image. For example, a speed of 1 can result in an image change every one second. In some cases, the speed can be specified in seconds. Additional, units can also be used.

The cross-fade setting 3208 can be used to set the transition between images. When the cross-fade setting 3208 is set to on, the images can fade from one to another. When the cross-fade setting 3208 is set to off, the images can do a clean cut from one image to another. In some configurations, additional transitions are also possible.

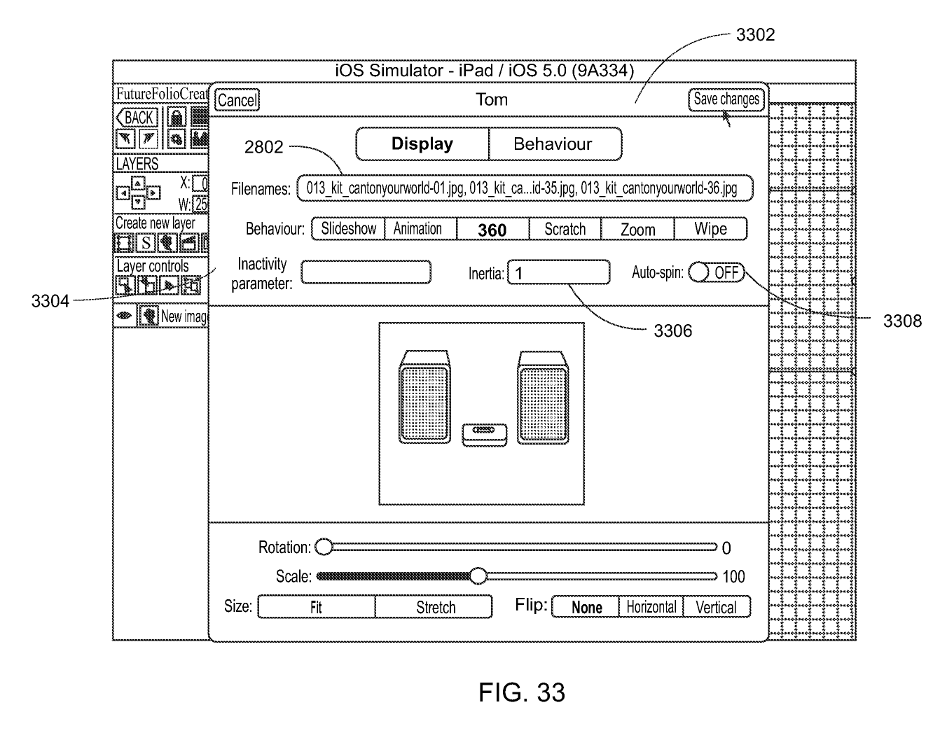

A 360 behavior can be used to display a collection of images that form a 360-degree view of an object. The 360 behavior can give the appearance of a three-dimensional model that an end user can rotate. In some cases, a single swipe by the end user can cause multiple image changes. Furthermore, in some cases, the images changes can have an associated speed, such that after the end user releases the image, the image change can decelerate until it comes to a rest. FIG. 33 illustrates an exemplary image layer configuration panel 3302 with settings specific to the 360 behavior. Configuration settings specific to the 360 behavior can include an interactivity parameter 3304, inertia 3306, and auto-spin 3308. Additional configuration settings are also possible.

A scratch behavior can be used to display an image that an end user can scratch away to reveal a bottom layer image. For example, a content creator can stack two images and the end user can scratch across the top layer to reveal the image below. Such a behavior can be useful for scratch off games or to reveal prizes. Any number of scratch layers can be stacked. Once the layer below is reached, the behavior of that layer can become active. For example, if the lower layer is a text layer with scrollable text, then once at least a portion of the text layer is revealed the end user will be able to scroll the text. In another example, if the lower layer is a slideshow, then once at least a portion of the slideshow is revealed, the end user will be able to flip through the images.

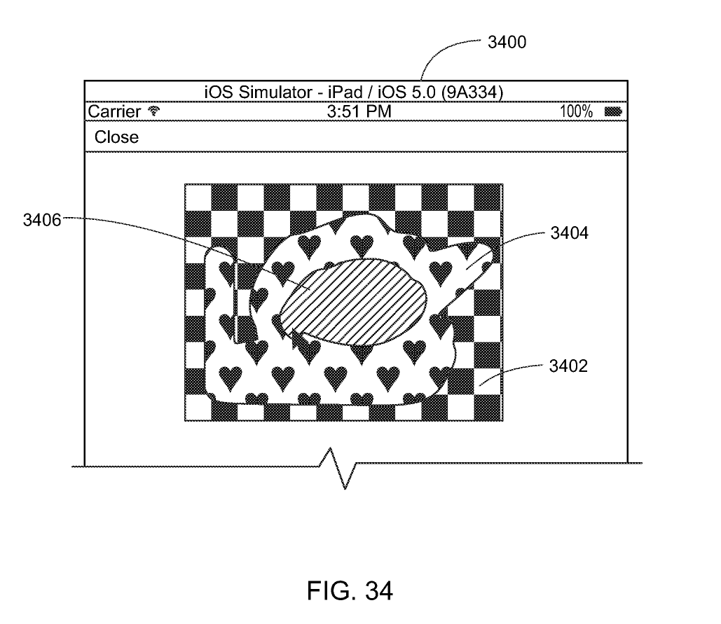

FIG. 34 illustrates an exemplary page rendition 3400 depicting the scratch feature. Page rendition 3400 includes three stacked layers: outer layer 3402, middle layer 3404, and lower layer 3406. In this example, outer layer 3402 and middle layer 3404 are both scratch layers. Once the end user reveals middle layer 3404, the scratch behavior of middle layer 3404 can become active. As the end user continues to scratch, lower layer 3406 can be revealed.

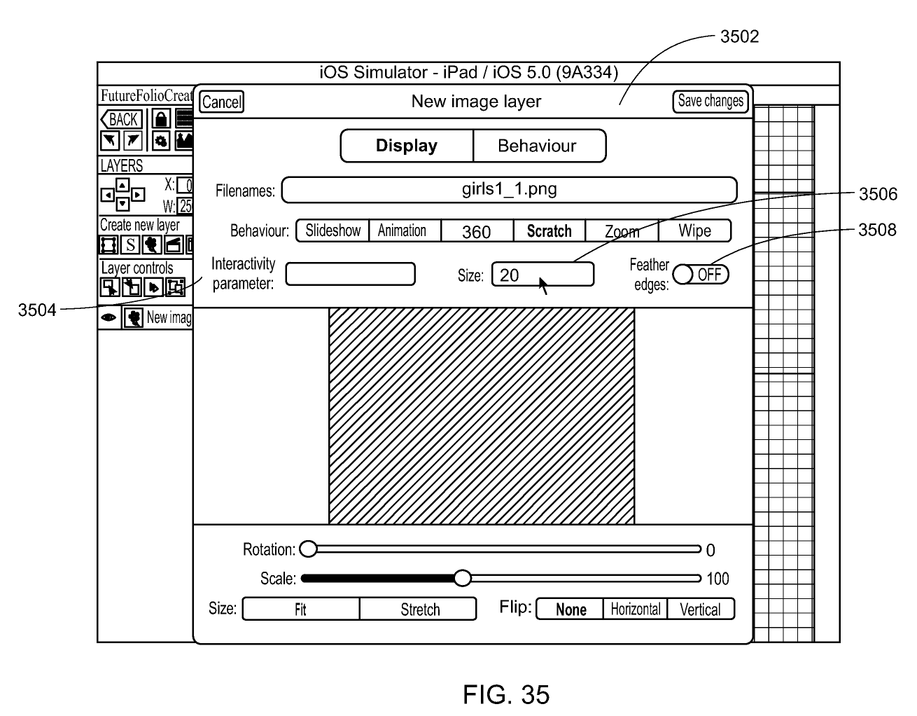

FIG. 35 illustrates an exemplary image layer configuration panel 3402 with settings specific to the scratch behavior. Configuration settings specific to the scratch behavior can include an interactivity parameter 3504, size 3506, and feather edges 3508. Additional configuration settings are also possible.

The size setting 3506 can be used to set a scratch size. That is, the size of area that is revealed by the end user with each scratch. For example, setting a larger value for size setting 3406 can result is a greater amount of the lower layer being revealed with each scratch.

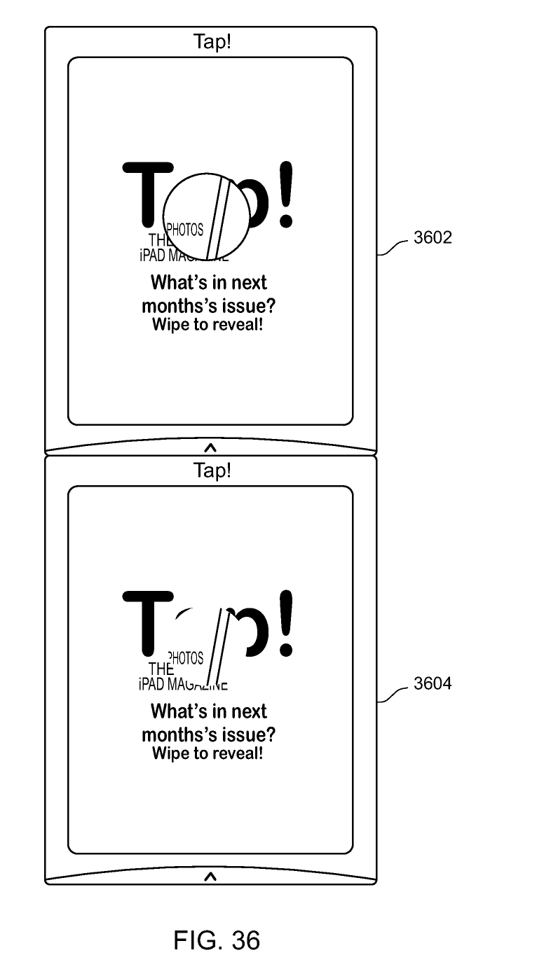

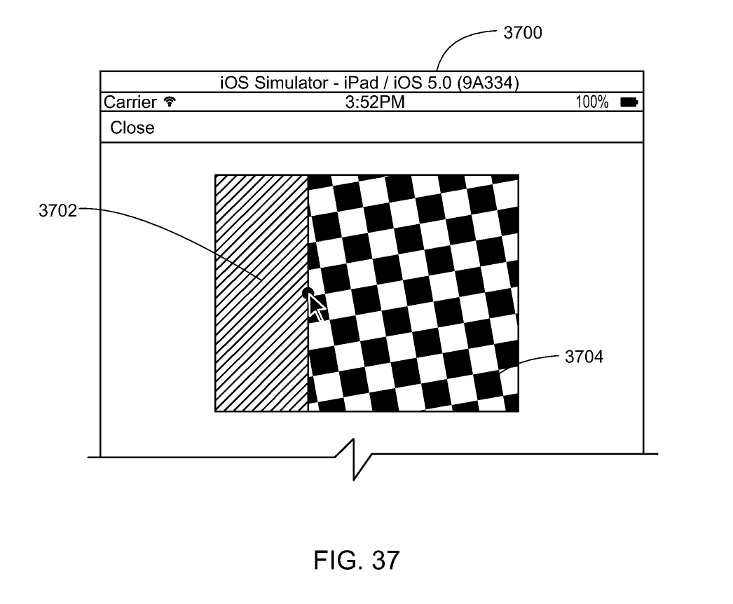

The feathered-edges setting 3508 can be used to set a scratch edge rigidity. When the feathered-edges setting is set to off, the edge between the scratched and unscratched layers can be hard. When the feathered-edges setting is set to on, the edge between the scratched and unscratched layers can be less precise. For example, FIG. 36 illustrates the scratch feature with feathered-edges turned on and off. The scratch layer in 3602 has feathered-edges turned off, while the scratch layer in 3604 has feathered-edges turned on. Additional scratch edge settings are also possible.

A wipe behavior can be used to display an image that an end user can move left, right and/or top, bottom to reveal a bottom layer image. For example, a wipe behavior can be used to illustrate before and after photos. The top layer can be the before image and the bottom layer can be the after. An end user can then peel back the before image to reveal part of the after image. For example, FIG. 37 illustrates an exemplary page rendition 3700 depicting the wipe feature. Page rendition 3700 includes two layers: upper layer 3702 and lower layer 3704. The upper layer 3702 is a wipe layer. The end user can move the edge of the layer back and forth or up and down to reveal lower layer 3704.

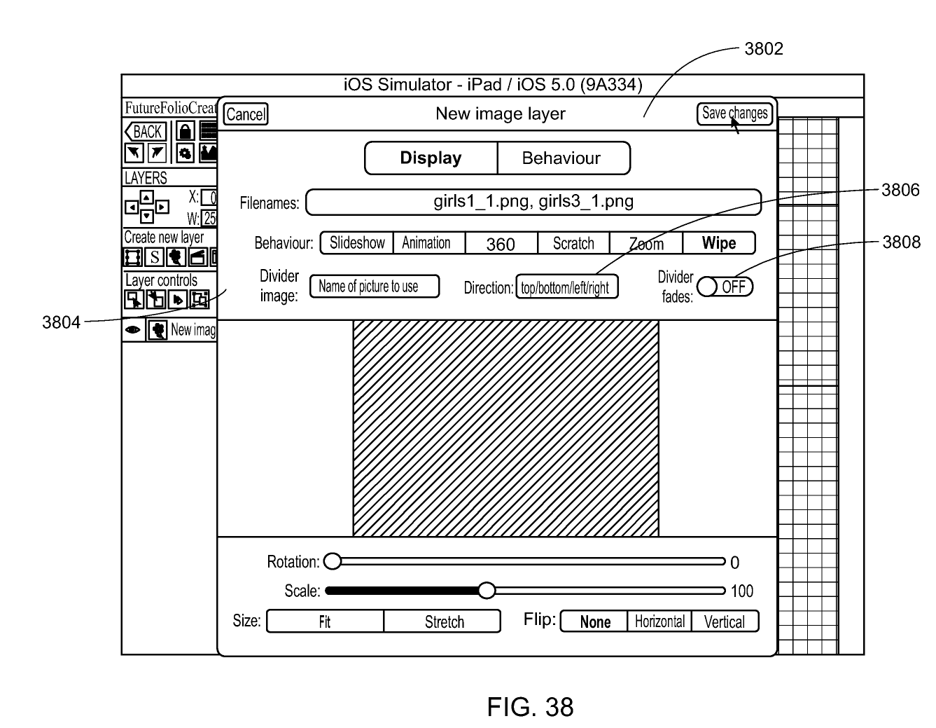

FIG. 38 illustrates an exemplary image layer configuration panel 3802 with settings specific to the wipe behavior. Configuration settings specific to the wipe behavior can include divider image 3804, direction 3806, and divider fades 3808. Additional configuration settings are also possible.

The divider-edge setting 3804 can be used to set a divider image. The divider image can mark the edge of the top image. The direction setting 3806 can be used to specify the direction that the image wipes, e.g. right, left, top, bottom. The divider-fades setting 3808 can be used in conjunction with the divider-image setting 3804. If a divider image is used then it may be desirable for the divider image to fade away when the end user is not actively wiping the image. When the divider-fades setting 3808 is on, the divider image will fade if the end user is not actively wiping the image. When the divider-fades setting 3808 is off, the divider image will remain visible regardless of whether the end user is engaged with the image or not.

Additional image layer behaviors are also possible, such as a zoom behavior. A zoom behavior can be used to display an image that an end user can tap to enlarge. For example, a page rendition can include a thumbnail or small version of an image. If the zoom behavior is set, the image can enlarge so that an end user can see a more detailed version of the image.

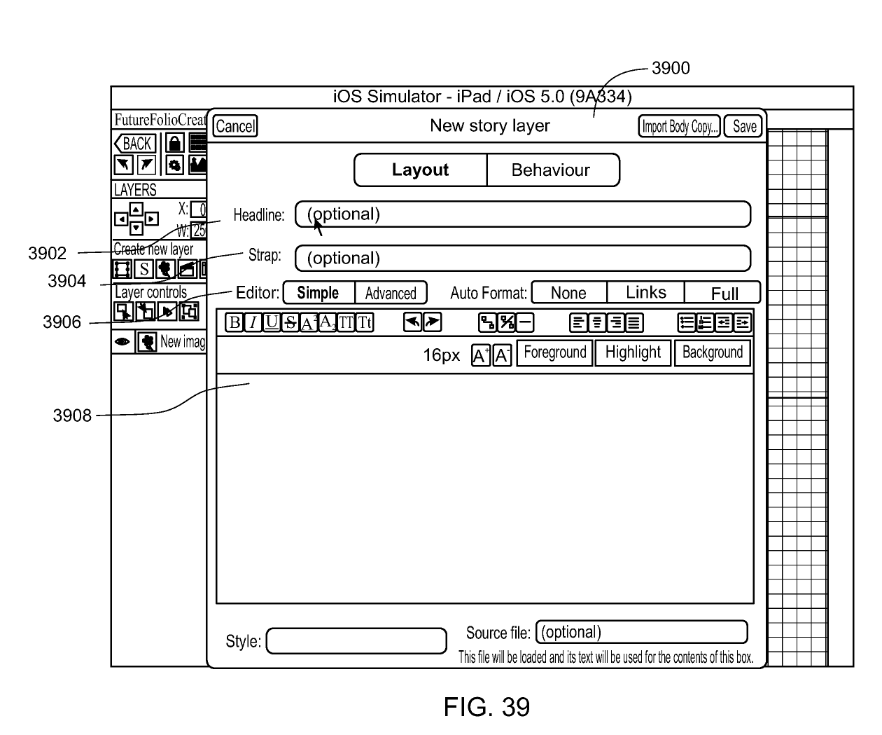

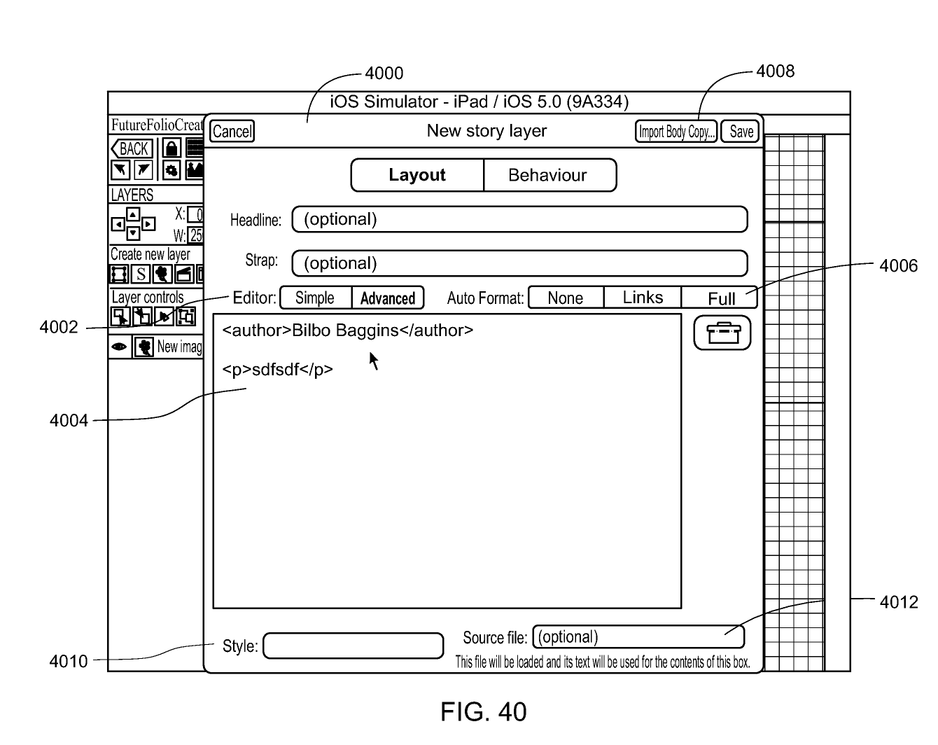

A story layer can be used to add text content to a page rendition. Text can be added to a text layer in a number of ways. Some of the ways that text can be entered will be illustrated through the discussion of FIGS. 39 and 40. Additional techniques for adding text are also possible. Regardless of the manner in which the text is added to the text layer, a text layer can automatically include formatting through the use of markup languages, such as HTML5, style sheets, such as CSS3, and scripting languages, such as JavaScript.

FIG. 39 illustrates an exemplary text layer configuration panel 3900. In text layer configuration panel 3900 a content creator can specify an optional headline and strap, or sub-heading, through the headline setting 3902 and strap setting 3904. To add the body of the text, a content creator can use a built-in editor. The editor 3906 can include simple and advanced settings. If the content creator chooses to use the simple editor, the content creator can enter text in box 3908 and use the various formatting tools associated with box 3908. Alternatively, a content creator can use the advanced editor 4002 as illustrated in FIG. 40. With the advanced editor 4002, the content creator can use all of the available features of a markup language such as HTML, as illustrated in box 4004.

Additionally, a content creator can enter text by importing body copy, using button 4008. When using the import-body-copy feature the text can appear in the editor box 4004. The content creator can further edit the text in the editor. Additionally, the content creator can select full auto format 4006 to have the digital content creation platform 900 automatically detect formatting such as line breaks. Another way of adding text can be through the source file setting 4012. The source file will not import the text into the editor, but the text in the file will appear in the text layer. This technique for adding text has the advantage that another content creator can be working on the content while the digital publication is laid out. Thus, any changes to the source file will be reflected in the digital publication without having to make actual changes to the text layer.

In addition to formatting the text within the built-in editor, a content creator can specify a style file. The style file can specify information such as font type, font size, spacing, etc. The text will be then be formatted according to the parameters specified in the style file. This makes it possible to create a style that can be used across issues of a digital publication, thus easily creating consistency. Furthermore, if a style is used in many text layers, a content creator can specify it once and it will be reflected across all of the text layers. This decreases the amount of time required for formatting. Additionally, if a content creator wishes to make a change to the style, the change can be made in one place and reflected throughout the digital publication.

In some cases, a text layer can automatically be made scrollable if the text does not fit within the text layer boundaries. Additionally, the text can be live text. The inclusion of live text can enable features such as search, translation, definition look-up, copy and paste, sharing, user accessibility, linking to internal and/or external content, etc.

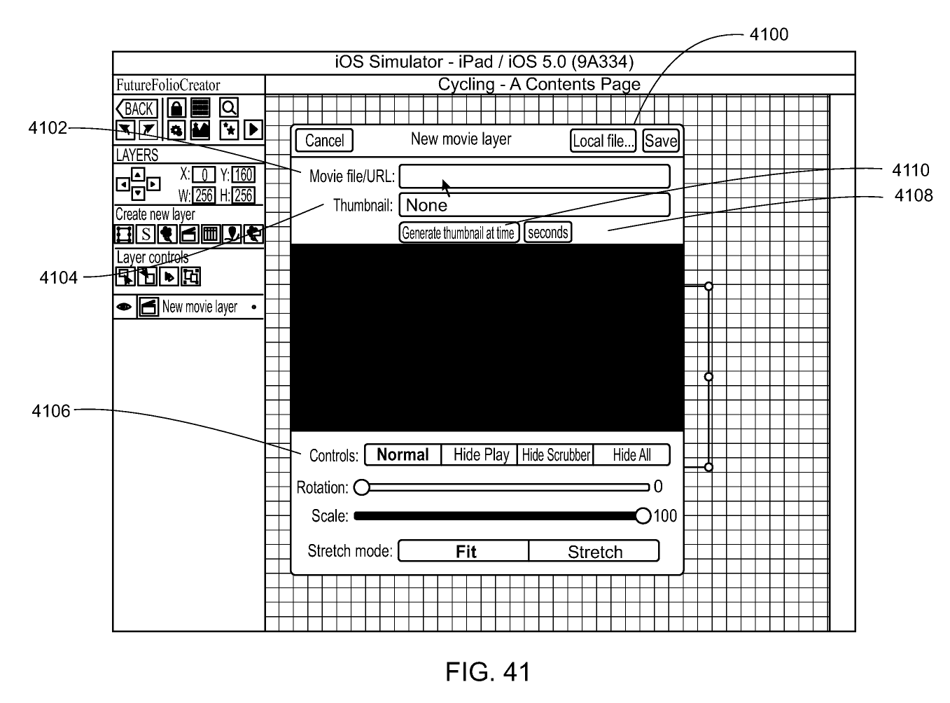

A video layer can be used to add a video type content item to a page rendition. Video content can be added in several ways. A video can be streamed from a remote server or it can be bundled in the digital publication. FIG. 41 illustrates an exemplary video layer configuration panel 4100. Configuration settings specific to the video layer can include movie file/URL, thumbnail, controls, rotation, scale, and stretch mode. Additional configuration settings are also possible. The movie file/URL setting 4102 allows a content creator to select a movie file to be included in the digital publication or specify the URL of a remote server from which the video can be streamed.

The thumbnail setting 4104 allows the content creator to specify an image to display when the video is not playing. The image can be a frame from the video or another image. To select an image from the video, the content creator can specify a particular point in the video using box 4108 and select the generate thumbnail button 4110. The controls setting 4106 can be used to specify what video controls are displayed.

A table layer can be used to add a table type content item to a page rendition. Individual table entries can support both text and data. A feature of a table created using a table layer is that the table can be end user sortable. That is, an end user can select a column heading to sort the data in the table based on that column.

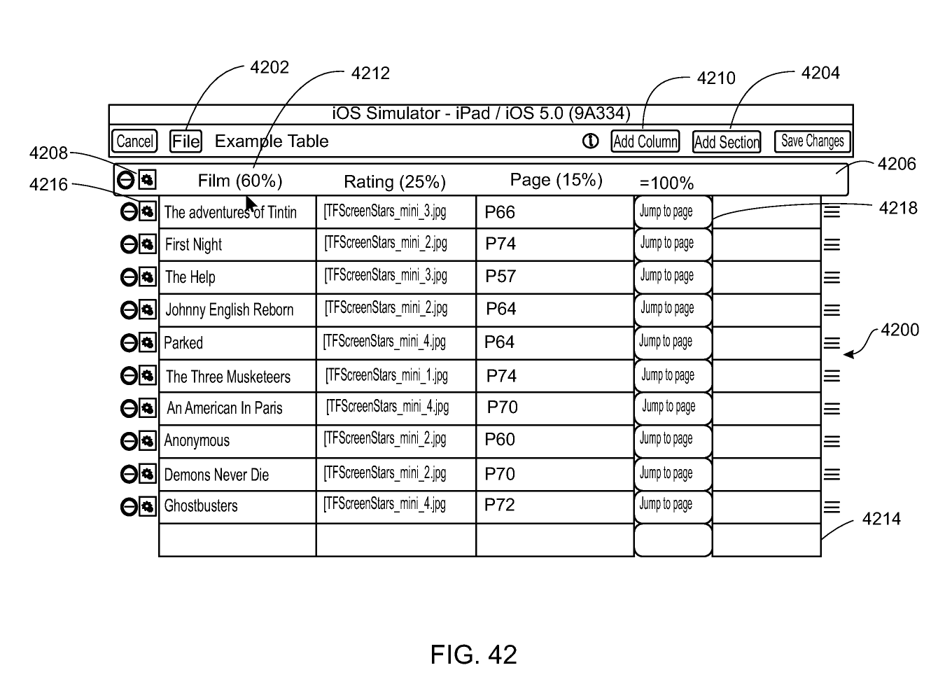

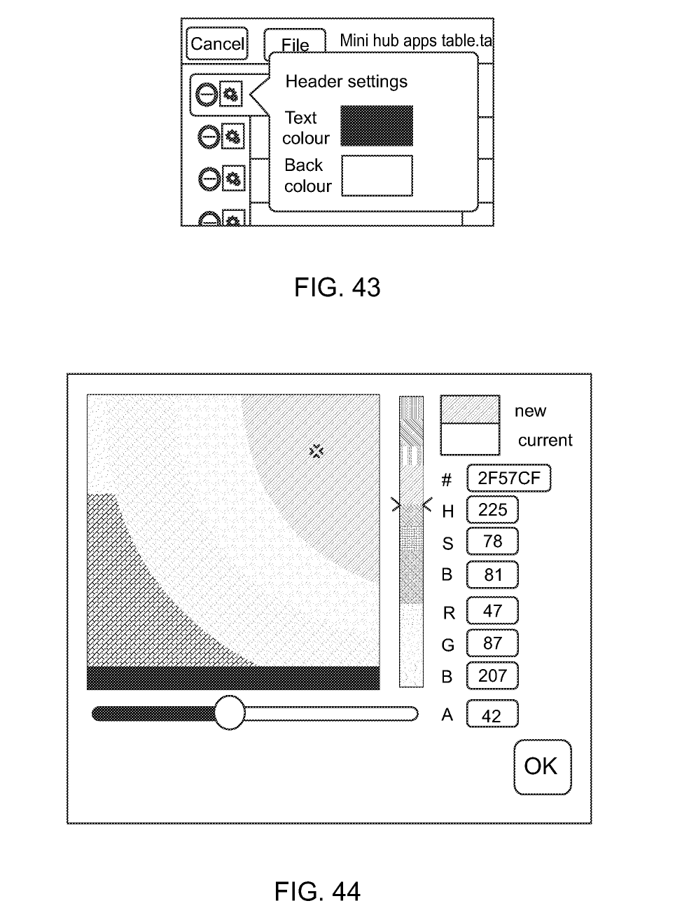

FIG. 42 illustrates an exemplary table layer configuration panel 4200. A content creator can either create a table from a file and/or from scratch. To create a table from a file the content creator can select the file button 4202. This will import that table information into the table editor, where the content creator can further edit the table, if desired. When creating a table from scratch the content creator can add sections, columns, and rows. A content creator can add a section using button 4204. Each section can have a header, such as header 4206. Furthermore, each header can have an associated set of properties. To configure the header properties a content creator can tap on the header properties button 4208. FIG. 43 illustrates an exemplary header properties configuration panel. A content creator can set the text and background colors. To set a text or background color the digital content creation platform 900 can include a color picker, such as illustrated in FIG. 44. Additional header configuration properties are also possible.

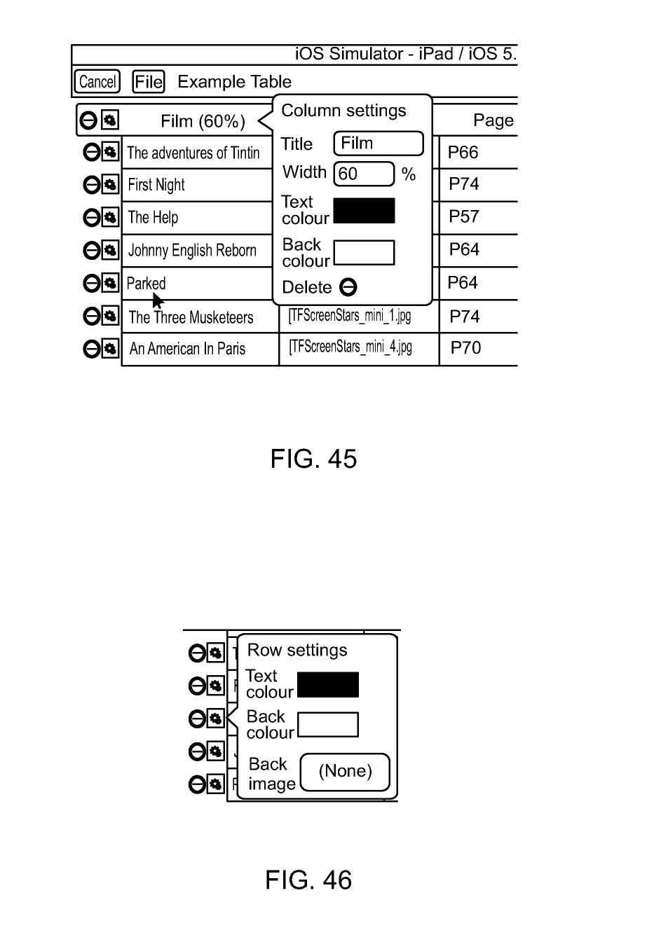

Referring back to FIG. 42, a content creator can also add a column, such as by using button 4210. A column can be end user sortable at run-time. The sort options available can vary with the configuration of the digital content creation platform 900, the client device, and/or the type and or formatting of data in the table cells. As with a header each column can have an associated set of properties. To configure a column's properties a content creator can double tap on the column, such as column 4212. FIG. 45 illustrates an exemplary column properties configuration panel. A content creator can specify the title of the column, the width, text color, and/or background color. Additional properties are also possible.

Referring back to FIG. 42, a content creator can add a new row by simply adding data to an empty row at the bottom of the table. The table creator can be configured to automatically add a new row at the bottom when all rows have been used, such as row 4214. A row can also have an associated set of properties. To configure a row's properties a content creator can tap on the row properties button 4216. FIG. 46 illustrates an exemplary row properties configuration panel. A content creator can specify the text color, a background color, and/or a background image. Additional properties are also possible. Additionally, a content creator can set a behavior for a row, such by using the behavior button 4218 in FIG. 42. The behavior button 4218 can be used to specify what will happen if the end user taps on the row. For example, if an end user taps on a row with a jump to page behavior the end user can be taken to the specified page.

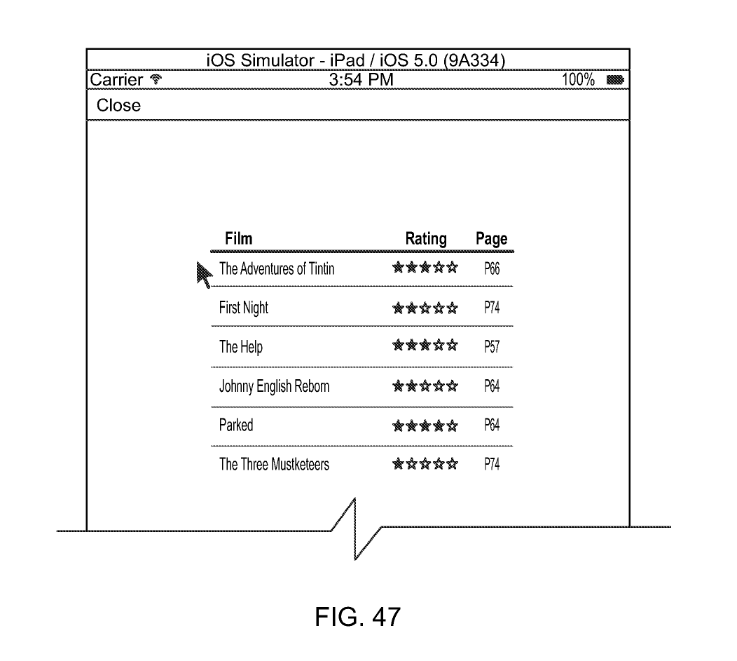

FIG. 47 illustrates an exemplary page rendition with an active table. As illustrated the table can be made to be automatically scrollable if the table content exceeds the space allocated for the table. Additionally, an end user can sort the data using any one of the columns, such as Film, Rating, and/or Page.

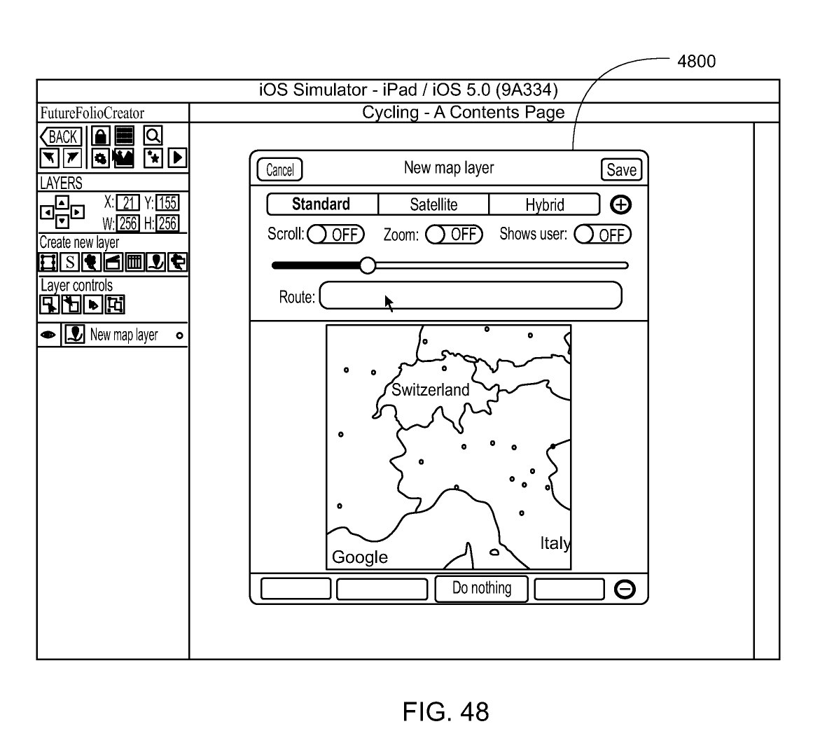

A map layer can be used to add a map content item to a page rendition. FIG. 48 illustrates an exemplary map layer configuration panel 4800. In some configurations, a map layer can be automatically populated with a map image from a publically available mapping service. Furthermore, the map image can be positioned at a default location. In some cases, the default location can be based on the content creator's current location. To obtain the desired location on the map, a content creator can move the map around or input an address. Additionally, the content creator can zoom in and zoom out to get the level of detail desired. Once the map is positioned at the correct location, the content creator can customize the map using a variety of settings and features.

A customization can be the format of the map display. For example, the map can be displayed in a standard, satellite, and/or hybrid display format. A content creator can also set whether the map is zoomable and/or scrollable. Furthermore, the content creator can enable a show user feature. The show user feature can cause the map to show the end user's current position at run-time.

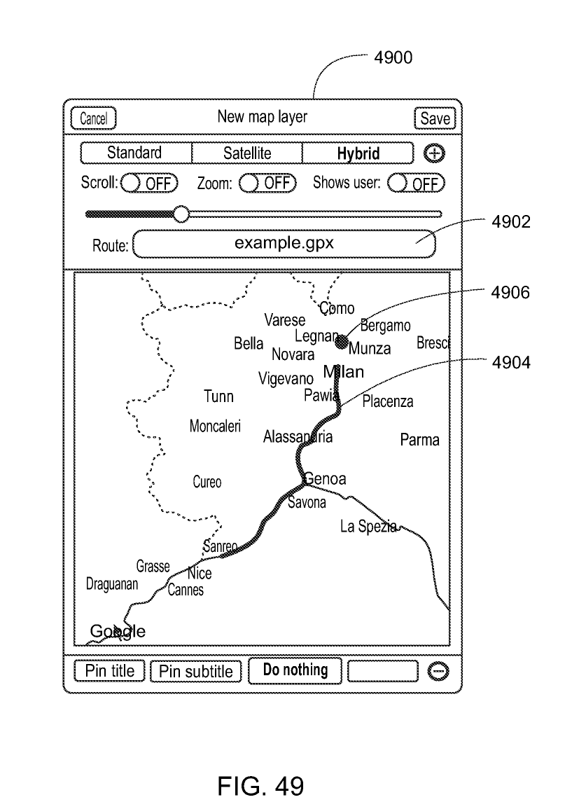

A further customization is that a content creator can add a route to the map. For example, FIG. 49 illustrates a map layer configuration panel 4900 in which a content creator has added a route. To add a route the content creator can specify a route file, such as GPX file, using route setting 4902. The specified route can be reflected on the map, such as route 4904.

The content creator can also place one or more pins on the map, such as pin 4906. A pin can be used to highlight a particular point of interest. A pin can have a custom title and/or subtitle. Furthermore, a pin can have an associated behavior. For example, if an end user taps the pin a text box with information can appear.

In some cases, one or more map layer features can require an Internet connection at run-time. That is, for an end user to experience the full functionality, the end user's device may require an Internet connection.

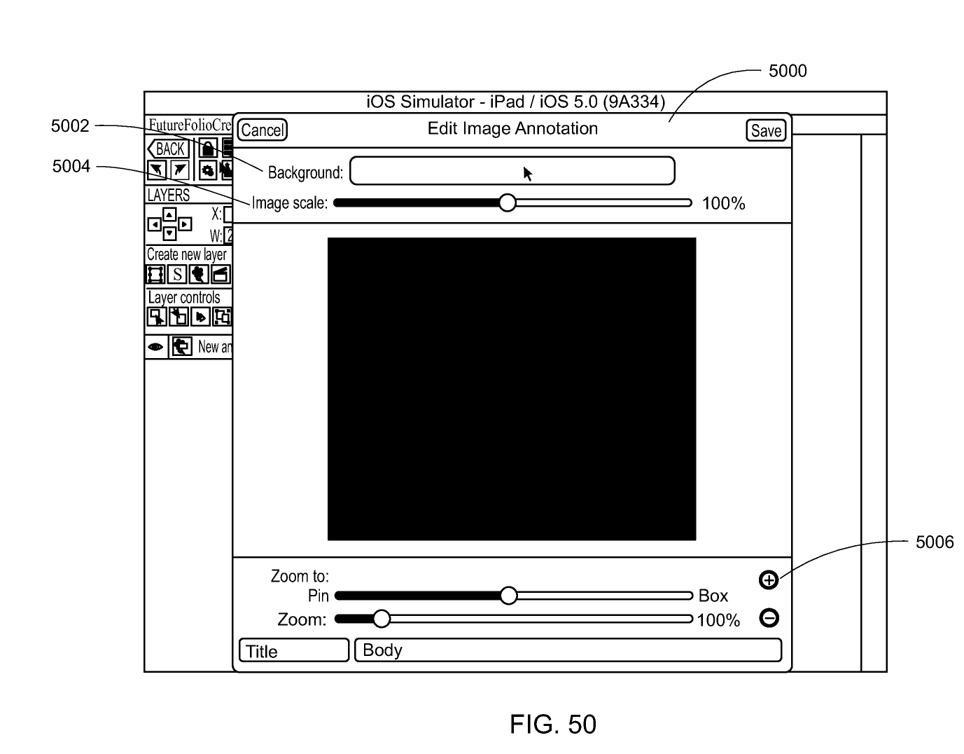

An annotation layer can be used to display an image with one or more associated information boxes. Each information box can be pinned to a different point in the image. FIG. 50 illustrates an exemplary annotation layer configuration panel 5000. A content creator can set a background image using background setting 5002. The content creator can adjust the scale of the background image using the image scale slider 5004.

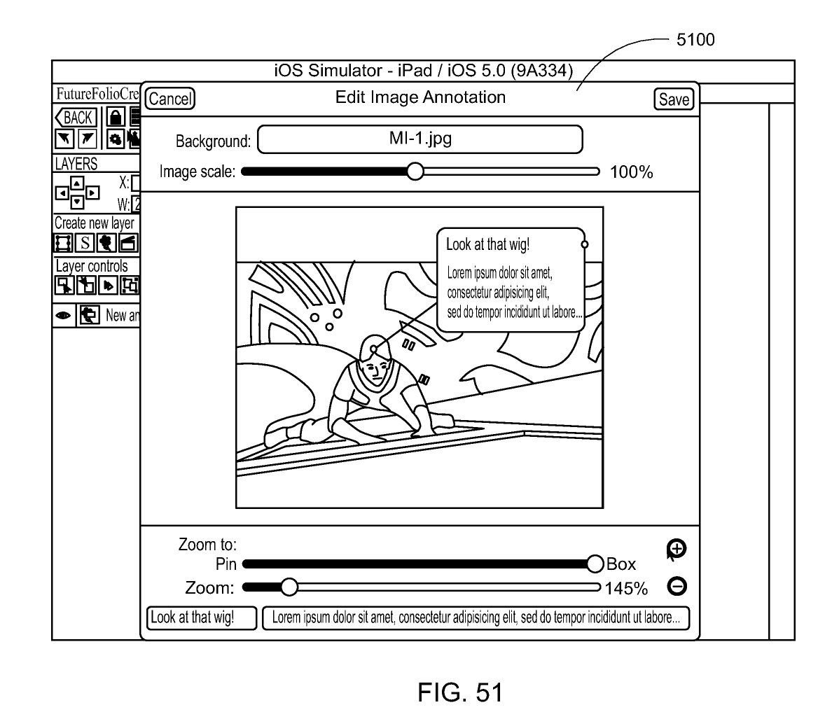

After setting a background image, the content creator can add one or more pins, such as by clicking the add pin button 5006. Each pin can have an associated information box. For example, FIG. 51 illustrates an annotation layer configuration panel 5100 in which the content creator has set the background image and added a pin. The text in an information box can consist of two parts: a title and a body. When the information box is in an unexpanded form, the title can be shown. When the information box is in an expanded form, the title and body can be shown. Additionally, an information box can have an associated behavior, such as a zoom. When an end user taps on the information box, the information box can expand and perform the associated behavior. For example, the associated behavior can cause the image to zoom to a particular zoom level and/or shift to focus on a particular location in the background image.

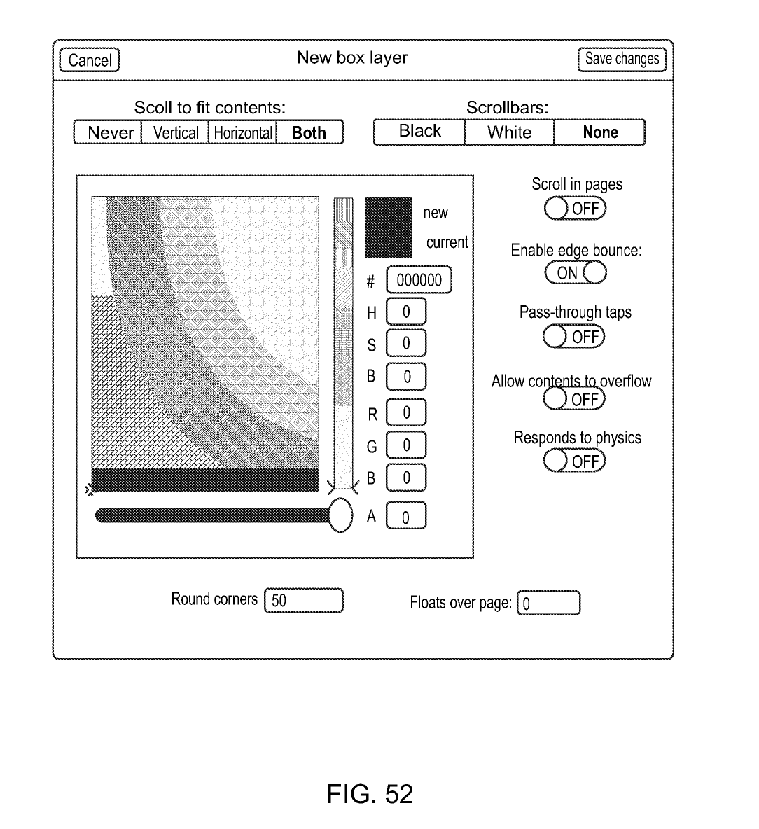

A box layer can be used to group one or more other layers. For example, in some cases, a page layout may contain multiple layers that logically belong together. By grouping the layers using a box layer, the group of layers can be manipulated as a whole. For example, all of the layers in the box layer can be hidden and then revealed simultaneously. A box layer can have configuration settings that are separate from the configuration settings of the layers contained in the box. For example, box color, scrollbar color, page scroll, edge bounce, overflow contents, round corners, behavior, appearance, etc. FIG. 52 illustrates an exemplary box layer configuration panel.

In some cases, a child layer can be larger than the box layer. In this case, the child layer can be cut off at the box layer's edges. To enable an end user to view the remainder of the child layer, the box layer can support vertical and/or horizontal scrolling.

A common behavior of the layers is that when a layer is placed over another layer, the under layer will not receive end user interaction, such as a tap. In the case of a box layer, this may not be the desired behavior. Therefore, a box layer can be configured to allow end user interaction to pass through the box layer to the child layers. In this case, the box layer will ignore the end user interaction, so that the end user can interact directly with the content in the child layer.

### 2.2.1.4 Interactivity

In addition to the interactivity and behaviors discussed above, the digital content creation platform 900 can support a variety of other interactivity and behavior features. The digital content creation platform 900 can include an interactivity adder module 916 to facilitate adding interactivity and behavior features, including those discussed above. One way to create the interactivity of a digital publication is through the linking of the various digital publication elements. Digital publication element linking can enable an end user to jump from one location in a digital publication to another, without having to flip through intermediate content. For example, a digital publication can include an active cover in which an end user can tap on various headlines or captions to be taken to the corresponding content. In another example, a digital publication can include a scrubber bar navigation in which thumbnails of the pages are listed. An end user can then scroll through the list and tap on a thumbnail to be taken to the page.

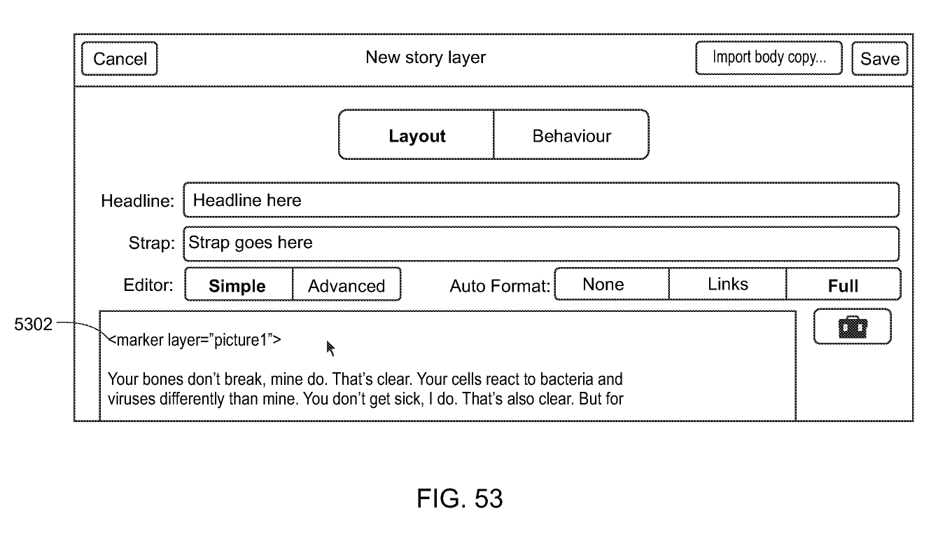

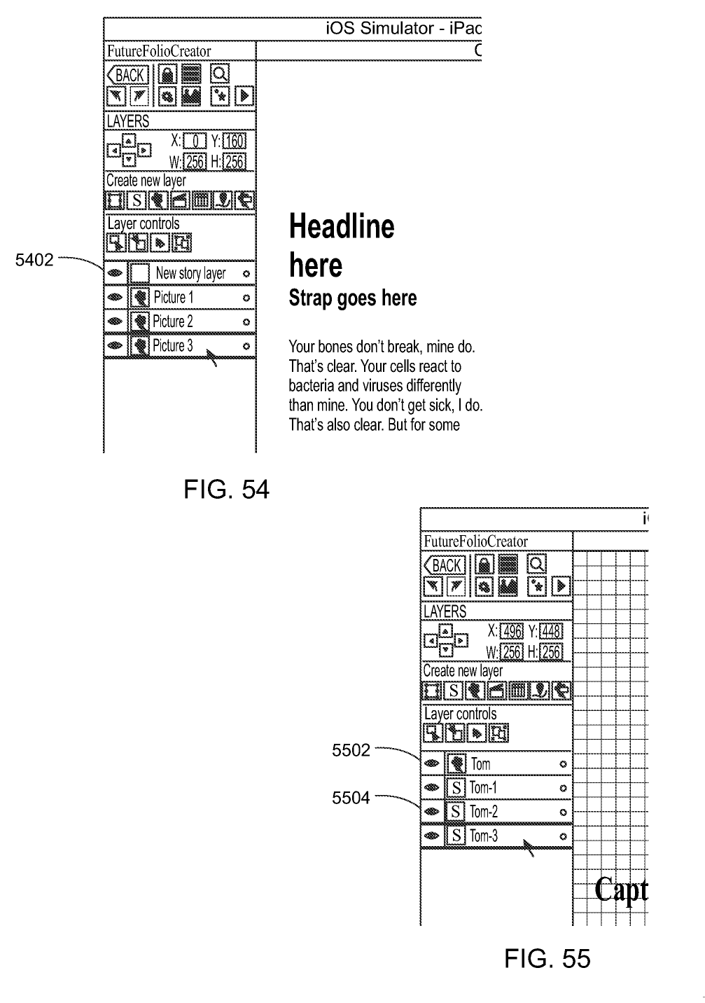

Digital publication linking can also be used to reveal content as an end user interacts with other content. For example, as an end user scrolls through a story, different images can be displayed. For example, FIG. 53 illustrates an exemplary technique for linking text and images. In the text a content creator can place markers, such as marker 5302. The marker specifies a layer, in this case “picture1.” This layer corresponds to the layer that the content creator would like to reveal as the end user scrolls through the text. For example, FIG. 54 illustrates that the content creator has created a layer 5402 named “picture1.” By using the layer name in the marker, the layer and text are linked. When the text is displayed to the end user, the end user will not see the marker. However, as the end user scrolls through the text the content of the specified layer will be displayed. In some cases, the revealed content can replace previous content. Revealed content can also appear in a new location. In some cases, when revealed content appears in a new location, old content can remain. Furthermore, the revealed content can remain stationary while the text scrolls.

Similar techniques can be used to link other layer types. For example, story layers can be linked to individual images in a slideshow through layer naming. FIG. 55 illustrates an exemplary linking of story layers to slideshow images through layer naming. The slideshow layer can include multiple images. For each image a content creator can create a story layer and name the story layers based on the slideshow layer and the slideshow image number that the story layer should be linked to. For example, when slideshow image two in the image layer 5502 is displayed, story layer 5504 can be displayed.

In addition to the behaviors discussed above, the digital content creation platform 900 can include functionality to enable a variety of other basic behaviors within a digital publication. For example, when watching a video, the video can be streamed to a set-top box, such as through AirPlay by Apple Inc. of Cupertino, Calif. In another example, all or a portion of the digital publication can be configured so that it can be printed. In some cases, this can occur via wireless printing functionality, such as AirPrint by Apple Inc.

The digital content creation platform 900 can also include functionality to enable a variety of other advanced behaviors. Advanced behaviors can include advanced animations, such as animations that do not begin or do not advance until another action occurs. For example, the animation does not begin until the end user has scrolled through at least a predefined portion of some text. In another example, an animation may not advance until an end user taps the image. Then the animation can continue to the end or until another predefined stop point is reached. Such an advanced animation feature can be useful for instructional content that involves steps and time should be allotted for the end user to complete each step. Another advanced behavior can be a tilt to reveal behavior. Such a behavior can be useful when the client device includes an accelerometer. In this case, when the device is tilted, values from the accelerometer can be used to move a layer proportionate to depth to give an illusion of three dimensions. That is, the layers can be moved so that the end user can see behind other objects as if the objects were actually moving in three-dimensional space.

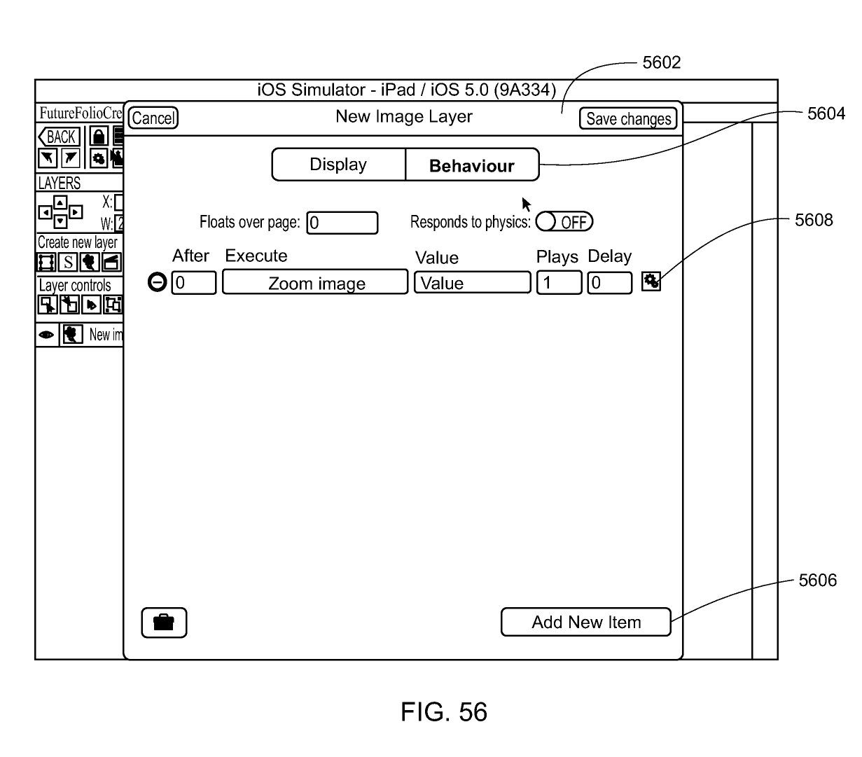

Additional behaviors are also possible, such as zoom image, show single layer, show single box layer, toggle layer visibility, hide layer, hide parent layer, transition: flip horizontal, transition: flip vertical, jump to page, jump to section, jump to slideshow page, load a URL internally, load a URL externally, advance animation, run animation script, play a sound, play a movie, send an email, print a file, set a variable, create particles, stop all particle systems, enable physics, create physics force, toggle bar, and/or close issue. In some cases, a behavior can be a special effect, such as the display and/or movement of bubbles, steam, fire, balls, rain, snow, etc.; weather modeling; image transformations; etc. In some cases, the additional behaviors can be associated with a layer through the behavior tab of a layer configuration panel. For example, FIG. 56 illustrates an exemplary behavior tab 5604 in an image layer configuration panel 5602. In the behaviors tab 5604, one or more behaviors can be added using the add new item button 5606. For each behavior, a variety of other configuration values can be set including after, value, plays, and delay. The after setting can be used to specify a delay, e.g. number of seconds, before the behavior occurs. The plays setting can be used to specify the number of times the behavior is executed. The delay setting can be used to specify the delay, e.g. seconds, between repetitions of the behavior. In some cases, the value setting can be a file, such as an image or particle file. Further configuration settings can also be set in a behavior configuration panel accessed through button 5608.

The various interactivity and behavior features can be enabled in a digital publication through one or more computer implemented functions. In some cases, a function can be part of the digital content creation platform 900 that is then added to the digital publication during the compilation process. Alternatively, a function can be an API function specific to a target device, such as an API function in an operating system. In this case, a behavior can be expressed in the digital publication by making a call to one or more API functions. Therefore, in some cases, an interactivity feature and/or behavior can correspond to one or more functions. When an interactivity feature and/or behavior is added to a digital publication, a call to one or more corresponding functions can be added to the digital publication to carryout the functionality at runtime.

### 2.2.1.6 Templates

Another digital publication layout feature that the digital content creation platform 900 can support can be templates. A template can be a specific arrangement of digital publication elements and interactivity features. A template can be defined for any level of granularity. For example, the digital content creation platform 900 can be configured to support full digital publication templates that include sections, pages, layers, interactivity features, and/or behaviors. A template can also be defined for a section and/or page. In some cases, a most commonly used template can be a page rendition template.

The digital content creation platform 900 can include a template module 918 to facilitate digital publication design features based on templates. The template module 918 can be configured to support at least three template-based features: create a new page rendition from a template, create a new template from a page rendition, and convert a current page rendition layout to a template. A template-based feature can be the creation of a digital publication and/or a digital publication element from a template. For example, instead of creating a page from scratch, a content creator can choose to create a page from a template.

A template can be an abstraction of a content element that specifies one or more properties about a content element, such as a digital publication or a page rendition. For example, the properties can include one or more layers, the layout and relationship between the layers, interactivity features, page orientation, page size, font features, etc., but without the inclusion of actual digital assets. However, in some cases, a template can include placeholder digital assets so as to provide design clues to a content creator. In some cases, a template can be made up of one or more other templates. For example, a digital publication template can include one or more page templates. In another example, a page template can include one or more page rendition templates. In some cases, a template can be a simplified digital publication element and/or an instruction file, such as an XML file, or other markup language file, that can be interpreted by the digital content creation platform 900.

A template can be created in a variety of ways. For example, a content creator can directly create a template. That is, a content creator can lay out a page rendition, or other digital content element, by specifying different properties. Then instead of adding specific content, such as images and text, the content creator can save the digital content element as a template. Alternatively, a content creator can create a complete digital content element by specifying all of the desired properties and content, such as images and text, and the template module 918 can generate a template from the digital content element.

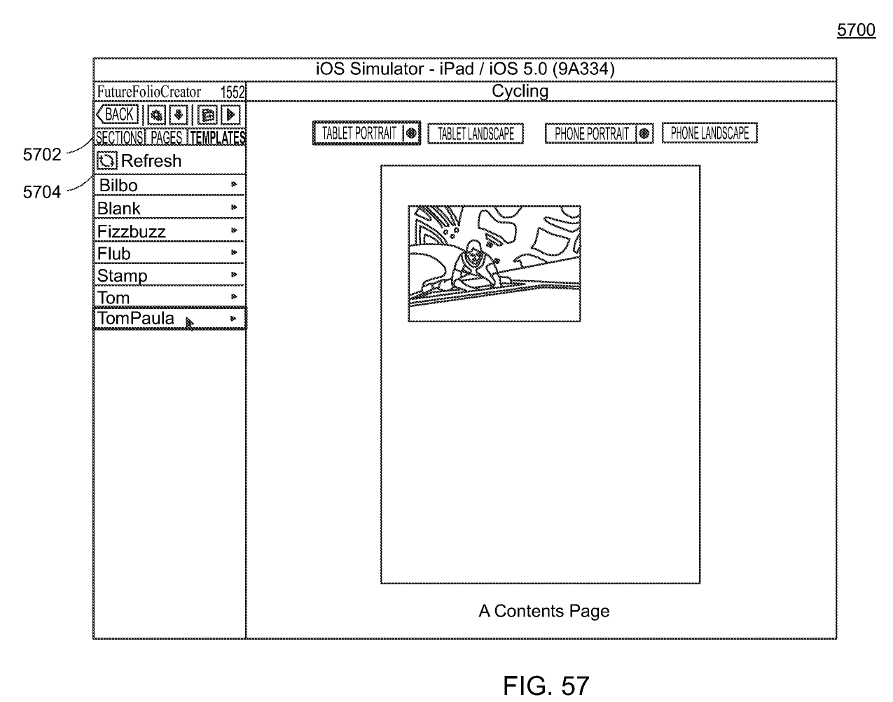

FIG. 57 illustrates an exemplary user interface 5700 for creating a page from a template. To create a new page, a content creator can select the template table 5702. After selecting the template table 5702, a list of available templates 5704 can be displayed. In some cases, a content creator can select a template to view properties of the template, such as layer layout, interactivity features, page orientation, page size, etc. The template module 918 can support a variety of techniques for creating the new page from the available templates. A technique can be to double tap a desired template, which can cause the automatic creation of the new page with the layer layout and interactivity of the template. Another technique can be to select a template and click a new button. The digital content creation platform 900 can support addition techniques for creating a new page from a template, such as a keyboard command when the digital content creation platform 900 is running in a simulator. After creating a new page from a template, a content creator can customize the page by adding multimedia content to the layers.

In some cases, a template can be locked. A locked template can prevent a content creator from making changes to the layout and/or interactivity features. However, a content creator can still add content to a layer in a locked page. To further prevent alterations to a locked template and/or page created from a locked template, the lock can be password protected and/or associated with user permissions. For example, if a content creator would like to make layout changes to a locked page, the content creator would have to enter the password set for the lock. This can prevent unauthorized and/or inadvertent layout and/or interactivity changes.

In some cases, the digital content creation platform 900 can include default templates, such as templates for newsletters, magazines, newspapers, presentations, marketing or sales tools, order forms, training programs, instructional materials, portfolios, scrapbooks, photo albums, etc. However, the digital content creation platform 900 can be configured to support the creation of new templates. A new template can be created from a digital publication and/or digital publication element that a content creator has already designed. For example, a content creator can lay out the layers of a page and add the interactivity elements. Once the content creator is satisfied with the layout and features, the content creator can create a template that can be reused later to create new issues of the digital publication. The use of template can decrease the time and cost associated with digital publication distribution.

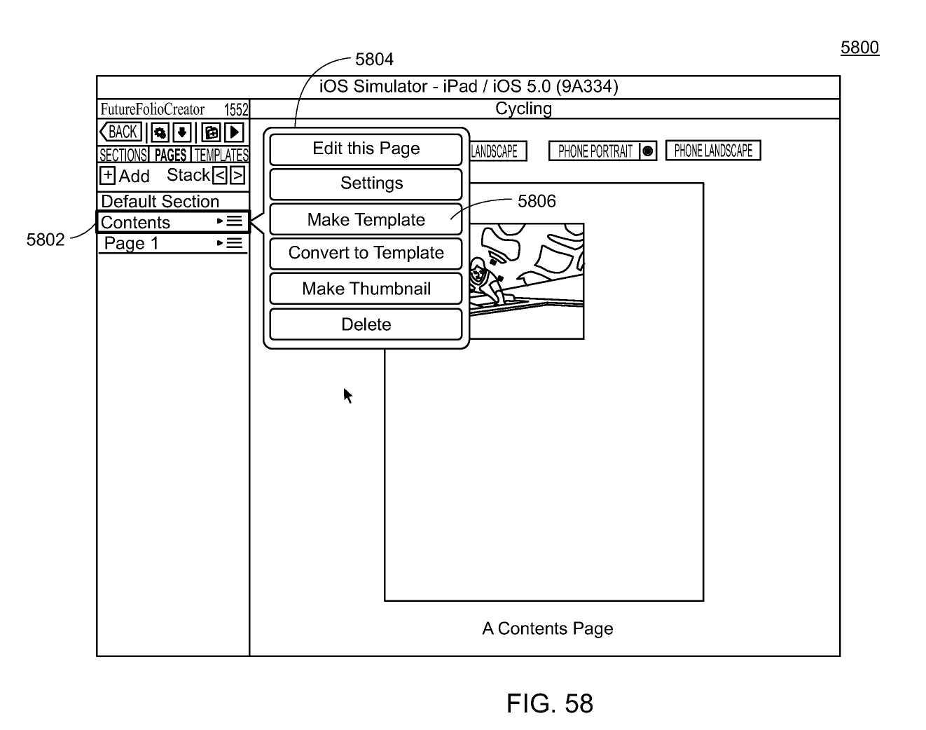

For example, FIG. 58 illustrates an exemplary digital content creation platform UI 5800 for creating a template from a page. To create a template, a content creator can double tap on the page the content creator wants to use for the template, such as page 5802. Upon double tapping, the template module 918 can cause a window with various menu options to be presented, such as 5804. The content creator can select the “Make Template” option 5806. The new template can be added to the list of available templates in the digital content creation platform 900. In some cases, the name of the new template can be assigned based on the name of the digital publication element from which the template was created. The digital content creation platform 900 can support additional techniques for creating a new template, such as selecting the page and then selecting a new template button or a keyboard command when the digital content creation platform 900 is running in a simulator.

The digital content creation platform 900 can also support a convert-to-template feature. The convert-to-template feature can enable a content creator to take a digital publication element, such as a page, and convert the layout of the digital publication element to the layout of a previously created template. That is, the content in the digital publication element can remain the same, but the layout and interactivity features can be replaced with those of the selected template.

The convert-to-template feature can be particularly useful when creating a digital publication with multiple orientations and/or page sizes. For example, a content creator can create two templates, one for tablet-portrait and one for tablet-landscape, for a particular digital publication. To create a new issue of the digital publication, the content creator can add content using the tablet portrait template. To create the tablet-landscape version of the issue, the content creator can use the convert-to-template feature. An advantage of using the convert-to-template feature when a digital publication includes multiple orientations and/or page sizes can be that the content creator only has to add the content to one rendition and then the other renditions can automatically be created using the templates.

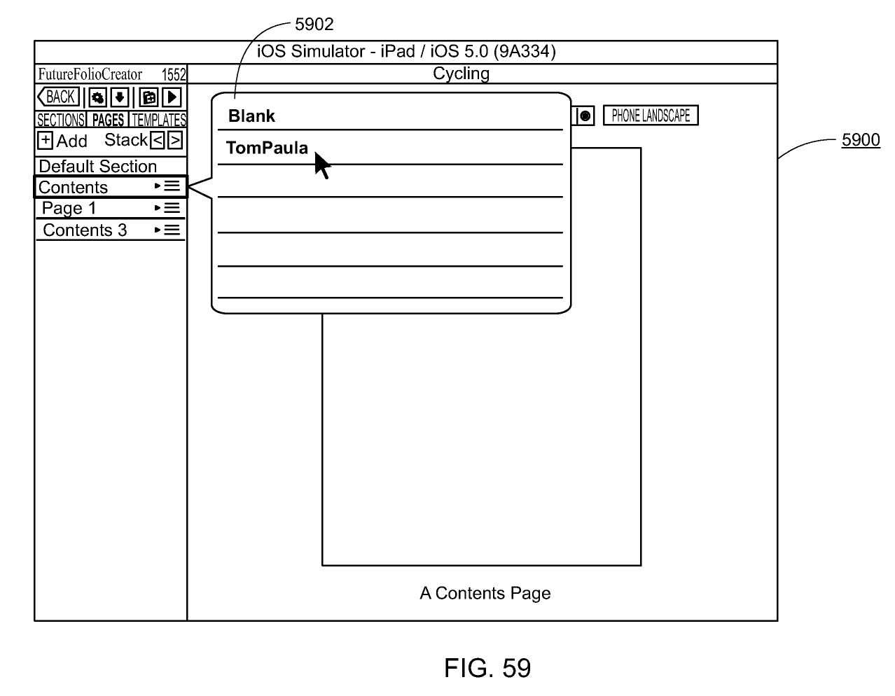

The template module 918 can support a variety of techniques for converting a digital publication element to a previously created template layout. A technique for activating the convert-to-template feature can be to double tap on a page the content creator wants to convert, such as page 5802. Upon double tapping, the template module 918 can cause a window with various menu options to be presented, such as 5804. The content creator can select the “Convert to Template” option 5808. After selecting the “Convert to Template” option, the content creator can be presented with a list of templates. For example, FIG. 59 illustrates an exemplary digital content creation platform UI 5900 with a window 5902 listing the templates from with the content creator can select.

In some cases, the list of templates can be filtered based on templates that would be compatible with the current content. Techniques for filtering the templates can include number of layers, layer types, layer names, etc. For example, if a page that contains three layers is selected for conversion, all templates that have fewer than three layers can be excluded from the list of available templates. In another example, if a page that contains only image layers is selected for conversion, all templates that do not include image layers can be excluded from the list of available templates. In yet another example, if a page that contains a layer named “Cover Image” is selected for conversion, all templates that do not include a layer named “Cover Image” can be excluded from the list of available templates.

After selecting a template, the template module 918 can attempt to convert the digital publication element to the new layout with the new interactivity and/or behavior features. In some cases, the template module 918 may not be able to complete the conversion or the conversion may be a best fit, such as when the layer types do not match or there are fewer layers in the new template than in the original layout. A best fit or forced conversion can force a the new layout by adding or removing elements. If the conversion is not successful or was a forced conversion, the digital content creation platform 900 can display a message to the content creator indicating that the conversion failed or was forced. Furthermore, in some cases, the message can indicate a reason that the conversion failed or was forced. In some configurations, the digital content creation platform 900 can also display a message when the conversion succeeded.

Furthermore, in some cases, when a content creator attempts to convert the digital publication element to a new layout, the digital content creation platform 900 can notify the content creator of the occurrence of a predefined event, such as an undesirable transformation. For example, if the content creator changes the page size from a tablet size to a phone size and the page contains content not supported on a phone or that performs sub-optimally on a phone, then the digital content creator platform 900 can generate a notification to alert the content creator of the detected problem. In some cases, the digital content creator platform 900 can include default predefined events, such as platform-specific unsupported features. However, the digital content creation platform 900 can also be configured so that a content creator can define an event such that if the event occurs, the content creator should be notified, such as the use of a feature that the content creator believes performs sub-optimally on a particular device type.

### 2.2.2 Preview Mode

An important feature provided by the preview mode can be the ability to run the digital publication as if it was executing on the target client device. As described above, because in some embodiments the digital content creation platform 900 is run on a development device that is the same type as the target client device or in a client device simulator, the digital publication can operate in preview mode as if it would if it was actually installed on the client device. Therefore, in preview mode a content creator can interact with the digital publication to experience the full interactive feature set. For example, a content creator can swipe and scroll through pages, text, and/or images. In another example, a content creator can tap on links, text, and/or images to review additional content. In yet another example, a content creator can play an embedded video. In a further example, a content creator can change the orientation of the digital publication to view portrait and/or landscape layouts. In still a further example, a content creator can experience the various behaviors, such as slideshow, animation, 360 images, scratch, zoom, wipe, and/or particle. All of the features described in the previous sections can be experienced and tested in preview mode.

### 2.2.3 Compilation Mode

The compilation mode includes a variety of features to enable a content creator to package a digital publication for distribution to end users. At any point during the design of a digital publication, a content creator can elect to compile the digital publication. However, an advantage of the digital content creation platform 900 is that because the content creator is able to fully experience the digital publication in the preview mode, the compilation step does not need to be performed until the content creator is ready to distribute the digital publication. Therefore, in some cases, the compilation step may only occur once or a very limited number of times for a digital publication.

The output of the compilation step can vary with the configuration of the digital content creation platform 900 and/or the digital publication. In some cases, the digital content creation platform 900 can be used to create simple digital publications, such as flat page-turners. Since these digital publications include little end user interaction other than scrolling and/or turning a page, the compiler module 930 can be configured to produce a basic output file, such as a PDF or similar document type.

The digital content creation platform 900 can also be used to create highly interactive digital publications. In this case, the compiler module 930 can produce a digital publication package. The digital publication package can be a single file, such as ZIP file or other archive file. The digital publication package can include the multimedia assets included in the digital publication, such as images, videos, computer executable code, etc. The digital publication package can also include a file that provides instructions to the client device and/or digital publication reader application for rendering the digital publication on a client device 702. In some embodiments, the instruction file can be an XML file, or other markup language file, that can be interpreted by a digital publication reader application. For example, the XML file can specify the relationships between the various digital publication elements. The XML file can also specify computer executable functions, such as API functions or functions included in a digital publication package, that should be called to enable the interactive features of the digital publication. That is, the various interactive features and behaviors can correspond to one or more functions. Calls to the one or more functions can then be specified in the instruction file. Furthermore, the XML file can include the text for the digital publication. Alternatively, the text can be included in the digital publication package in one or more simple text files. As described above, by including the live text instead of images of the text, the digital publication can include a variety of additional features, such as search, translation, definition look-up, copy and paste, sharing, user accessibility, linking to internal and external content, etc. In some embodiments, the instruction file can be computer executable code that can be executed by a client device 702. Overall, a digital publication package can include all of the assets required to recreate the digital publication issue on an end user's client device.

When a content creator is ready to compile a version of a digital publication, the content creator can activate the compilation or build mode. For example, the content creator can select the build button on the UI. In some embodiments, activating the compilation mode can cause one or more compilation settings to be displayed to the content creator. In some cases, a compilation setting can be the quality of the image asset to be included in the digital publication. For example, the quality setting can be a relative setting, such as a percentage. In some cases, a compilation setting can be the target client device types. For example, if the digital publication design includes layouts for multiple client device types, the content creator can specify or select a subset of the client devices. In some cases, a compilation setting can be the level of interactivity in the resulting digital publication. For example, the interactivity setting can allow the content creator to select flat or fully interactive, or even various settings in between that would result in different behaviors being disabled in the compiled digital publication. Additional compilation settings or configuration options are also possible.

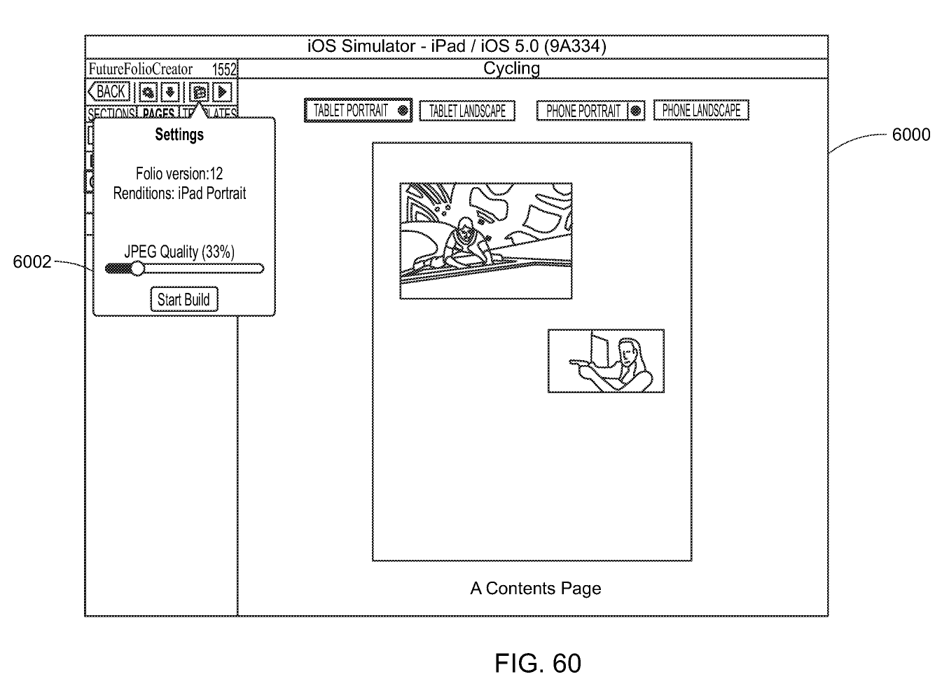

FIG. 60 illustrates an exemplary UI 6000 in which the compilation mode has been activated and a settings window 6002 is displayed. In this example, the settings window displays a slider 6004 for specifying the image quality. The content creator can select a quality level and build the digital publication. When the digital publication package is produced, all of the image assets included in the digital publication can be scaled according to the specified quality level. Therefore, a content creator can use full quality assets when designing the digital publication and the assets can be scaled to a desired size when producing the file product. The image quality compilation setting has the advantage that it decreases the burden on the content creator because the content creator does not have to manually scale each image. In some cases, a content creator can directly specify a quality level, such as “low,” “medium,” or “high,” or a numerical value. Alternatively, a content creator can specify a target end user device or a property of an end user device, such as ultra high-resolution display, e.g., a retina display, and the image quality can be automatically set. For example, when the content creator specifies retina display, the image quality can be automatically set to a high quality level.

The compiler module 930 can be configured to produce the digital publication package from the original multimedia assets, but without altering the assets. For example, if the content creator specifies 50% image quality, the digital publication package can include a copy of each image asset at 50% of the original quality. In this case, the image assets included in the digital publications can be produced using the original assets but are not the original assets. This can enable a content creator to produce multiple builds with different settings and select the digital publication package with the optimal qualities, such as size.

In some embodiments, a digital publication package can be produced for installation on multiple client device types. In some cases, the client device types can have varying capabilities and/or features. Therefore, the digital publication package can include instructions and/or assets that are specific to the different client device types included in the build. For example, a client device may have a higher resolution display and thus the digital publication package can include separate assets for that device type. Alternatively, the digital publication package can include instructions on how to modify an asset so that it is suitable for display on a particular client device type. By including the asset once and modifying it at run time, it may be possible to decrease the size of the digital publication package.

A compiled digital publication can also include a version identifier. In some cases, the version identifier can indicate the version of the digital content creation platform 900 that was used to create the digital publication. The version identifier can also indicate a version of a digital publication reader application. For example, the version identifier can indicate a minimum digital publication reader application version that can be used to run the digital publication. In some cases, a client device and/or a digital publication reader application can use the version identifier to determine compatibility. Furthermore, the version identifier can be made visible to an end user so that the end user can manually determine compatibility.

In some digital publications, an interactive feature, such as an animation, special effect, or other behavior, is manually produced during the design process by layering multiple items of multimedia content. For example, to create an animation in which a star moves across the screen, multiple images of the star can be placed in various places in the layout such that the images are revealed at different times. This can give the effect of movement. However, such a technique can also require the inclusion of multiple image files. The digital content creation platform 900 can instead include the image once and provide instructions on how to modify the image at run time in order to create the interactive feature. This can result in a decrease in size of the digital publication package.

### 4. Exemplary System

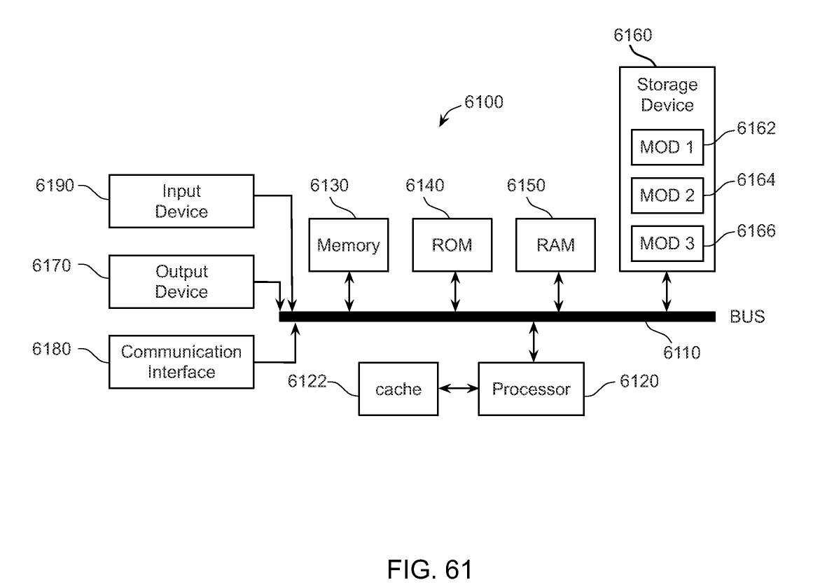

With reference to FIG. 61, an exemplary system 6100 includes a general-purpose computing device 6100, including a processing unit (CPU or processor) 6120 and a system bus 6110 that couples various system components including the system memory 6130 such as read-only memory (ROM) 6140 and random access memory (RAM) 6150 to the processor 6120. The system 100 can include a cache 6122 connected directly with, in close proximity to, or integrated as part of the processor 6120. The system 6100 copies data from the memory 6130 and/or the storage device 6160 to the cache for quick access by the processor 6120. In this way, the cache provides a performance boost that avoids processor 6120 delays while waiting for data. These and other modules can control or be configured to control the processor 6120 to perform various actions. Other system memory 6130 may be available for use as well. The memory 6130 can include multiple different types of memory with different performance characteristics. It can be appreciated that the disclosure may operate on a computing device 6100 with more than one processor 6120 or on a group or cluster of computing devices networked together to provide greater processing capability. The processor 6120 can include any general purpose processor and a hardware module or software module, such as module 1 6162, module 2 6164, and module 3 6166 stored in storage device 6160, configured to control the processor 6120 as well as a special-purpose processor where software instructions are incorporated into the actual processor design. The processor 6120 may essentially be a completely self-contained computing system, containing multiple cores or processors, a bus, memory controller, cache, etc. A multi-core processor may be symmetric or asymmetric.

The system bus 6110 may be any of several types of bus structures including a memory bus or memory controller, a peripheral bus, and a local bus using any of a variety of bus architectures. A basic input/output (BIOS) stored in ROM 6140 or the like, may provide the basic routine that helps to transfer information between elements within the computing device 6100, such as during start-up. The computing device 6100 further includes storage devices 6160 such as a hard disk drive, a magnetic disk drive, an optical disk drive, tape drive or the like. The storage device 6160 can include software modules 6162, 6164, 6166 for controlling the processor 6120. Other hardware or software modules are contemplated. The storage device 6160 is connected to the system bus 6110 by a drive interface. The drives and the associated computer readable storage media provide nonvolatile storage of computer readable instructions, data structures, program modules and other data for the computing device 6100. In one aspect, a hardware module that performs a particular function includes the software component stored in a non-transitory computer-readable medium in connection with the necessary hardware components, such as the processor 6120, bus 6110, output device 6170, and so forth, to carry out the function. The basic components are known to those of skill in the art and appropriate variations are contemplated depending on the type of device, such as whether the device 6100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 6150, read-only memory (ROM) 6140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 6100, an input device 6190 represents any number of input mechanisms, such as a microphone for speech, a touch-sensitive screen for gesture or graphical input, keyboard, mouse, motion input, speech and so forth. An output device 6170 can also be one or more of a number of output mechanisms known to those of skill in the art. In some instances, multimodal systems enable a user to provide multiple types of input to communicate with the computing device 6100. The communications interface 6180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 6120. The functions these blocks represent may be provided through the use of either shared or dedicated hardware, including, but not limited to, hardware capable of executing software and hardware, such as a processor 6120, that is purpose-built to operate as an equivalent to software executing on a general purpose processor. For example the functions of one or more processors presented in FIG. 61 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 6140 for storing software performing the operations discussed below, and random access memory (RAM) 6150 for storing results. Very-large-scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 61 can practice all or part of the recited methods, can be a part of the recited systems, and/or can operate according to instructions in the recited non-transitory computer-readable storage media. Such logical operations can be implemented as modules configured to control the processor 6120 to perform particular functions according to the programming of the module. For example, FIG. 61 illustrates three modules Mod1 6162, Mod2 6164 and Mod3 6166 which are modules configured to control the processor 6120. These modules may be stored on the storage device 6160 and loaded into RAM 6150 or memory 6130 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A system for creating an interactive digital publication in a mobile device framework, the system comprising:
a processor;
an element creation module configured to control the processor to create one or more layers on a first rendition of a first digital page in the interactive digital publication, wherein a layer is configured to import and present a digital asset on the digital page;
an interactivity adder module configured to control the processor to associate an action with the layer, wherein the action is at least one of an interactivity or a behavior; and
a layout management module configured to control the processor to analyze a first layer created by the element creation module and to perform a predetermined action based on the analysis.

2. The system of claim 1, wherein the analyzing occurs in response to a selection of a digital asset for import into a first layer created by the element creation module and further wherein the analyzing comprises:
determining that an attribute associated with the digital asset selected for import and other unselected assets conform to a naming scheme.

3. The system of claim 2, wherein the predetermined action comprises additionally importing at least one of the other unselected assets into the first layer.

4. The system of claim 3, wherein the predetermined action further comprises associating a common behavior to the first layer, the behavior defining a mechanism for displaying the selected asset and the imported at least one other unselected asset.

5. The system of claim 1, wherein the predetermined action comprises instructing the interactivity adder module to link the first layer with a second layer of the one or more layers.

6. The system of claim 5, wherein the instructing occurs in response to determining that a first attribute associated with the first layer and a second attribute associated with the second layer share a common naming scheme.

7. The system of claim 1, wherein the predetermined action comprises instructing the interactivity adder module to link a first asset in the first layer with a second layer, and a second asset in the first layer with a third layer, the linking causing a corresponding display of the first asset in the first layer and the second layer, and a corresponding display of the second asset in the first layer and the third layer.

8. The system of claim 7, wherein the instructing occurs in response to determining that there are multiple assets in the first layer, and that the first, second, and third layers share a common naming scheme.

9. The system of claim 1, wherein the predetermined action comprises instructing the interactivity adder module to link a first attribute in the first layer with a second layer, and a second attribute in the first layer with a third layer, the linking causing a display of the second layer corresponding to an activation of the first attribute in the first layer, and the display of the third layer corresponding to an activation of the second attribute in the first layer.

10. The system of claim 9, wherein the instructing occurs in response to determining that there are multiple attributes within the first layer, and that the multiple attributes share a common naming scheme with the second and third layers.

11. The system of claim 1, wherein the predetermined action comprises instructing the interactivity adder module to associate an information box with an attribute of the first layer, the association causing a display of the information box corresponding to an activation of the attribute in the first layer.

12. The system of claim 11, wherein the predetermined action further comprises instructing the interactivity adder module to associate a behavior with the attribute of the first layer, the association causing the application of the behavior to the first layer corresponding to an activation of the attribute in the first layer.

13. The system of claim 1, wherein the layout management module is further configured to control the processor to analyze a first digital page and to perform a predetermined action based on the analysis.

14. The system of claim 13, wherein the predetermined action comprises stacking the first digital page on top of a second digital page, the stacking causing the display of the first and second digital pages to appear as a single continuous digital page.

15. The system of claim 1, further comprising:
a template module configured to control the processor to convert the first rendition of the first digital page to a second rendition of the first digital page, wherein converting comprises arranging a plurality of digital assets from the first rendition of the first digital page on the second rendition of the first digital page based on one or more templates associated with the second rendition of the first digital page.

16. The system of claim 1, further comprising:
a template module configured to control the processor to create a template from the first rendition of the first digital page, wherein creating a template comprises generating an abstraction of the first rendition of the first digital page, the abstraction including properties of the first rendition of the first digital page.

17. The system of claim 15, wherein the converting replaces the first rendition of the first digital page with the second rendition of the first digital page.

18. The system of claim 15, wherein the converting causes the second rendition of the first digital page to be added to the digital publication as an additional rendition of the first digital page.

19. The system of claim 1, further comprising:
a compilation module configured to control the processor to generate a digital publication package, the digital publication package including an instruction file and one or more digital assets for the interactive digital publication, wherein the instruction file specifies one or more functions to enable the display of one or more actions, and further wherein the one or more functions correspond to one or more interactive features in the interactive digital publication.

20. The system of claim 19, wherein each digital asset of the one or more digital assets is a scaled copy of an original digital asset used to design the interactive digital publication, wherein a scaled copy is produced from an original digital asset based on a specified quality setting during the generation of the digital package.

21. The system of claim 19, wherein the digital publication package is generated to display the interactive digital publication on a plurality of mobile devices.

22. The system of claim 21, wherein the instruction file in the digital publication package includes a set of instructions specifying a transformation to a digital asset to modify the digital asset for display on a mobile device type.

23. The system of claim 1, wherein the mobile device framework is a mobile device simulator.

24. The system of claim 1, wherein the mobile device framework is a mobile device.

25. A method for presenting a graphical user interface for navigating an interactive digital publication having a plurality of content sections on a mobile device, the method comprising:
displaying the interactive digital publication in a graphical user interface on the mobile device, the displaying comprising:
presenting a control panel having a plurality of content section buttons, each of the plurality of content section buttons being linked to a different content section in the plurality of content sections in the interactive digital publication, each content section button associated with a different color corresponding to a color associated with the linked content section, a content section button being presented in the associated color when the linked content section is currently displayed, and
presenting a control panel retrieval icon, the control panel retrieval icon being effective to receive a user input, and to cause the mobile device to reveal a hidden control panel, the control panel retrieval icon being presented in a color associated with a content section of the interactive digital publication currently displayed.

26. The method of claim 25 further comprising:
receiving an input selecting a first content section button linked to a first content section in the interactive digital publication, the received input being effective to cause the interactive digital publication to display a first page of the first content section.

27. The method of claim 26 wherein the received input being further effective to cause the control panel retrieval icon to be presented in a color associated with the selected first content section.

28. The method of claim 25, wherein the control panel retrieval icon is further effective to receive a user input and to cause the mobile device to hide a revealed control panel.

29. A method of creating an interactive digital publication, wherein the method comprising the following steps:
(a) a computer processor creating, within a mobile device framework, one or more layers on a first rendition of a first digital page of an interactive digital publication,
(b) importing and presenting a digital asset on the digital page;
(c) the computer processor associating an action with the layer, wherein the action is at least one of an interactivity and a behavior; and
(d) the computer processor analyzing a first layer created by step (a) and performing a predetermined action based on the analysis.

30. A mobile device arranged to display a graphical user interface for navigating an interactive digital publication having a plurality of content sections on the mobile device, the mobile device comprising:
a display module configured to display the interactive digital publication in a graphical user interface on the mobile device, the display module comprising:
a control panel module configured to present
a control panel having a plurality of content section buttons, each of the plurality of content section buttons being linked to a different content section in the plurality of content sections in the interactive digital publication, each content section button associated with a different color corresponding to a color associated with the linked content section, a content section button being presented in the associated color when the linked content section is currently displayed, and
a control panel retrieval icon, the control panel retrieval icon being effective to receive a user input, and to cause the mobile device to reveal a hidden control panel, the control panel retrieval icon being presented in a color associated with a content section of the interactive digital publication currently displayed.
